(19) United States
(12) Patent Application Publication
(10) Pub. No.: US 2026/0235849 A1
(43) Pub. Date: Aug. 13, 2026

(54) OPTICAL SYSTEM AND CAMERA MODULE

(71) Applicant: LG INNOTEK CO., LTD., Seoul (KR)

(72) Inventor: Ju Yong SHIM, Seoul (KR)

(21) Appl. No.: 19/147,956

(22) PCT Filed: Jan. 10, 2024
(86) PCT No.: PCT/KR2024/000510

§ 371 Date: Jul. 14, 2025

(30) Foreign Application Priority Data
Jan. 12, 2023 (KR) 10-2023-0005019
Apr. 19, 2023 (KR) 10-2023-0051653

(51) Int. Cl. G02B 9/64; G02B 13/00

(52) U.S. Cl. CPC G02B 9/64; G02B 13/0045

(57) ABSTRACT

An optical system according to an embodiment of the present invention comprises first to seventh lenses arranged along an optical axis, wherein: the first lens has negative (−) refractive power; the second lens has negative (−) refractive power; the third lens has positive (+) refractive power; the fourth lens has positive (+) refractive power; the fifth lens has negative (−) refractive power; the sixth lens has positive (+) refractive power; the seventh lens has negative (−) refractive power; a stop is arranged between the second lens and the third lens; and among the first to seventh lenses, the third lens has the largest thickness on the optical axis.

### CROSS-REFERENCE TO RELATED APPLICATIONS

This application is the U.S. national stage application of International Patent Application No. PCT/KR2024/000510, filed Jan. 10, 2024, which claims the benefit under 35 U.S.C. § 119 of Korean Application No. 10-2023-0005019, filed Jan. 12, 2023; and 10-2023-0051653, filed Apr. 19, 2023, the disclosures of each of which are incorporated herein by reference in their entirety.

### TECHNICAL FIELDS

The teachings in accordance with exemplary and non-limiting embodiments of the present invention relate generally to an optical system for improved optical performance and a camera module including the same.

### BACKGROUND ARTS OF THE INVENTION

ADAS (Advanced Driving Assistance System) is an advanced driver assistance system designed to assist drivers in driving. It consists of sensing the situation ahead, judging the situation based on the sensed results, and controlling the vehicle's behavior based on the situation judgment. For example, ADAS sensor devices detect vehicles ahead and recognize lanes. Once the target lane, target speed, or forward target is determined, systems such as the vehicle's ESC (Electronic Stability Control), EMS (Engine Management System), and MDPS (Motor-Driven Power Steering) are controlled. Typically, ADAS can be implemented in various forms, including automatic parking systems, low-speed urban driving assistance systems, and blind spot warning systems.

Sensors used in ADAS to detect the front situation include GPS sensors, laser scanners, front radars, and Lidar, with the most representative being cameras that capture images of the front, rear, and sides of the vehicle.

Such cameras can be placed outside or inside a vehicle to detect the vehicle's surroundings. In addition, the cameras can be placed inside the vehicle to detect the driver's and passengers' conditions. For example, the cameras can film the driver from a position adjacent to the driver and detect the driver's health condition, drowsiness, and drunkenness. Furthermore, the camera can film passengers from a position adjacent to them, detect whether they are asleep or their health condition, and provide the driver with information about the passengers.

In particular, the most important element for obtaining an image from a camera is the imaging lens that forms the image. Recently, there has been increasing interest in high-performance features such as high-definition and high-resolution, and research is being conducted on optical systems that include multiple lenses to achieve these features. However, when the camera is exposed to harsh environments, such as high temperatures, low temperatures, moisture, or high humidity, either inside or outside the vehicle, the characteristics of the optical system may change. In such cases, it is difficult to consistently achieve excellent optical characteristics and aberration characteristics.

Therefore, a new optical system and camera capable of addressing the aforementioned issues are required.

### SUMMARY OF THE INVENTION

### Technical Subject

An embodiment is intended to provide an optical system and camera module with improved optical characteristics.

An embodiment is intended to provide an optical system and camera module with excellent optical performance in low-temperature to high-temperature environments.

An embodiment is intended to provide an optical system and camera modules that can inhibit or minimize changes in optical characteristics over a wide temperature range.

### Technical Solution

To solve the above technical subjects, an optical system according to an embodiment of the present invention may comprise first to seventh lenses arranged along an optical axis, wherein: the first lens has negative (−) refractive power; the second lens has negative (−) refractive power; the third lens has positive (+) refractive power; the fourth lens has positive (+) refractive power; the fifth lens has negative (−) refractive power; the sixth lens has positive (+) refractive power; the seventh lens has negative (−) refractive power; an aperture (stop) is disposed between the second lens and the third lens; and among the first to seventh lenses, the third lens has the largest thickness on the optical axis.

Preferably, but not necessarily, at least one of the first lens and the third lens may be made of glass, and at least one of the second lens and the fourth to seventh lenses may be made of plastic.

Preferably, but not necessarily, on the optical axis, the sixth lens may have a convex shape on both surfaces, and on the optical axis, the seventh lens may have a meniscus shape that is convex toward an object side.

Preferably, but not necessarily, among the first to seventh lenses, the absolute value of the focal length of the first lens may be the largest.

Preferably, but not necessarily, a maximum value of distance between two lenses with the largest difference in Abbe number among adjacently disposed lenses from the optical axis to the effective diameter area may be smaller than a maximum value of distance between other two adjacent lenses.

Preferably, but not necessarily, the fourth lens and the fifth lens may have the largest difference in Abbe number among the adjacent lenses.

Preferably, but not necessarily, the following condition may be satisfied.

$$< Condition > 40 < FOV\_H < 60$$

(In the condition, FOV_H refers to the horizontal field of view (Horizontal Degree) of the optical system.)

Preferably, but not necessarily, the following condition may be satisfied.

$$0.31 < CG 1 / \sum CG < 0.5 \qquad < Condition >$$

(In the condition, CG1 is a distance between the first lens and the second lens on the optical axis, and ΣCG is a sum of the gaps between adjacent lenses on the optical axis.)

Preferably, but not necessarily, the following condition may be satisfied.

$$5 < TTL / ImgH < 7 \qquad < Condition >$$

(In the condition, TTL is a distance along the optical axis from a vertex of an object side surface of the first lens to the image surface of the image sensor, and ImgH is ½ of the maximum diagonal length of the image sensor.)

To solve the abovementioned technical subjects, an optical system according to an embodiment of the present invention may comprise first to seventh lenses arranged along an optical axis, wherein: a second lens has a negative (−) refractive power; a third lens has a positive (+) refractive power; a fourth lens has a positive (+) refractive power; a fifth lens has a negative (−) refractive power; a sixth lens has a positive (+) refractive power; and a seventh lens has a negative (−) refractive power; and the effective diameter of the second lens is the smallest among the first to seventh lenses, and the effective diameter of the fourth lens is the largest among the first to seventh lenses.

Preferably, but not necessarily, the distance between the first lens and the second lens may be the greatest among the distances between adjacent lenses on the optical axis.

Preferably, but not necessarily, an aperture may be disposed between the second lens and the third lens, and the optical system may include a first lens group disposed on the object side with respect to the aperture and a second lens group disposed on the sensor side with respect to the aperture, wherein a sign of the composite focal length of the first lens group may be different from a sign of the composite focal length of the second lens group.

Preferably, but not necessarily, at least one of the lenses disposed on the object side and sensor side of the aperture may be made of glass material.

Preferably, but not necessarily, an absolute value of the focal length of the first lens may be the largest among the first to seventh lenses.

Preferably, but not necessarily, the following condition may be satisfied.

$$3 < \sum CT / \sum CG < 4 \qquad < Condition >$$

(In the condition, ΣCT means a sum of the center thicknesses of the first to seventh lenses on the optical axis, and ΣCG means a sum of the gaps between adjacent lenses on the optical axis.)

### Advantageous Effects

The optical system and camera module according to the embodiment may have improved optical characteristics. To be more specific, in the optical system according to the embodiment, the plurality of lenses may have a set thickness, refractive power, and a gap with an adjacent lens. As a result, the optical system and camera module according to the embodiment may have improved MTF characteristics, aberration control characteristics, resolution characteristics, etc., within a set field of view range, and may exhibit good optical performance in the peripheral regions of the field of view.

Furthermore, the optical system and camera module according to the embodiment can have good optical performance in a low-temperature to high-temperature temperature range (−40° C. to 105° C.). To be more specific, the multiple lenses included in the optical system may have predetermined materials, refractive indices, and refractive powers. Accordingly, when the refractive index of each lens changes due to temperature variations, and as a result, the focal length of each lens changes, the plastic lenses and glass lenses can compensate for each other. In other words, the optical system can effectively distribute refractive power across a low-temperature to high-temperature range and inhibit or minimize changes in optical characteristics within that range. Therefore, the optical system and camera module according to the embodiment can maintain improved optical characteristics across a wide temperature range.

Furthermore, the optical system and camera module according to the embodiment can satisfy the set angle of view and achieve excellent optical characteristics through a combination of plastic lenses and glass lenses. As a result, the optical system can provide a slimmer vehicle camera module. Therefore, the optical system and camera module can be provided for various applications and devices, and maintain excellent optical characteristics even under harsh temperature conditions, such as exposure to the exterior of a vehicle or high temperatures inside a vehicle during summer.

### BRIEF DESCRIPTION OF DRAWINGS

FIG. 1 is a side cross-sectional view of an optical system and a camera module including the same according to a first embodiment.

FIG. 2 is a table showing the aspheric coefficients of the lenses in the optical system of FIG. 1.

FIG. 3 is a table showing the thickness of each lens in the optical system of FIG. 1 and a gap between adjacent lenses.

FIG. 4 is a table showing the Sag values of lens surfaces of the first to seventh lenses in the optical system of FIG. 1.

FIG. 5 is a table showing the slope angle values of lens surfaces of the first to seventh lenses in the optical system of FIG. 1.

FIG. 6 is a graph showing the data for the diffraction MTF (Modulation Transfer Function) at room temperature for the optical system of FIG. 1.

FIG. 7 is a graph showing the data for the aberration characteristics at room temperature for the optical system of FIG. 1.

FIG. 8 is a graph showing the diffraction MTF data at low temperatures for the optical system shown in FIG. 1.

FIG. 9 is a graph showing the aberration characteristics data at low temperatures for the optical system shown in FIG. 1.

FIG. 10 is a graph showing the diffraction MTF data of the optical system shown in FIG. 1 at high temperatures.

FIG. 11 is a graph showing the aberration characteristics data of the optical system shown in FIG. 1 at high temperatures.

FIG. 12 is a graph showing the peripheral light intensity ratio of the optical system shown in FIG. 1.

FIG. 13 is a side cross-sectional view of an optical system and a camera module including the same according to a second embodiment.

FIG. 14 is a table showing the aspheric coefficients of the lenses in the optical system of FIG. 13.

FIG. 15 is a table showing the thickness of each lens in the optical system of FIG. 13 and the gap between adjacent lenses.

FIG. 16 is a table showing the Sag values of the lens surfaces of the first to seventh lenses in the optical system of FIG. 13.

FIG. 17 is a table showing slope angles of the lens surfaces of the first to seventh lenses in the optical system of FIG. 13.

FIG. 18 is a graph showing data on the diffraction MTF (Modulation Transfer Function) at room temperature for the optical system shown in FIG. 13.

FIG. 19 is a graph showing data on the aberration characteristics at room temperature for the optical system shown in FIG. 13.

FIG. 20 is a graph showing data on the diffraction MTF at low temperatures for the optical system shown in FIG. 13.

FIG. 21 is a graph showing the aberration characteristics of the optical system shown in FIG. 13 at low temperatures.

FIG. 22 is a graph showing the diffraction MTF of the optical system shown in FIG. 13 at high temperatures.

FIG. 23 is a graph showing the aberration characteristics of the optical system shown in FIG. 13 at high temperatures.

FIG. 24 is a graph showing the peripheral light intensity ratio of the optical system shown in FIG. 13.

FIG. 25 is a cross-sectional view of an optical system and a camera module including the same according to a third embodiment.

FIG. 26 is a table showing the aspheric coefficients of the lenses in the optical system of FIG. 25.

FIG. 27 is a table showing the thickness of each lens and the gap between adjacent lenses in the optical system of FIG. 25.

FIG. 28 is a table showing the Sag values of the lens surfaces of the first to seventh lenses in the optical system of FIG. 25.

FIG. 29 is a table showing slope angles of the lens surfaces of the first to seventh lenses in the optical system of FIG. 25.

FIG. 30 is a graph showing data on the diffraction MTF at room temperature for the optical system of FIG. 25.

FIG. 31 is a graph showing data on the aberration characteristics at room temperature for the optical system of FIG. 25.

FIG. 32 is a graph showing data on the diffraction MTF (Modulation Transfer Function) of the optical system shown in FIG. 25 at low temperatures.

FIG. 33 is a graph showing data on the aberration characteristics of the optical system shown in FIG. 25 at low temperatures.

FIG. 34 is a graph showing the diffraction MTF data of the optical system in FIG. 25 at high temperatures.

FIG. 35 is a graph showing the aberration characteristics data of the optical system in FIG. 25 at high temperatures.

FIG. 36 is a graph showing the peripheral light intensity ratio of the optical system in FIG. 25.

FIG. 37 is a side cross-sectional view of the optical system and a camera module including the same according to a fourth embodiment.

FIG. 38 is a table showing the aspheric coefficients of the lenses in the optical system of FIG. 37.

FIG. 39 is a table showing the thickness of each lens in the optical system of FIG. 37 and the gap between adjacent lenses.

FIG. 40 is a table showing the Sag values of the lens surfaces of the first to seventh lenses in the optical system of FIG. 37.

FIG. 41 is a table showing the slope angles of the lens surfaces of the first to seventh lenses in the optical system of FIG. 37.

FIG. 42 is a graph showing data on the diffraction MTF (Modulation Transfer Function) at room temperature for the optical system shown in FIG. 37.

FIG. 43 is a graph showing data on the aberration characteristics at room temperature for the optical system shown in FIG. 37.

FIG. 44 is a graph showing data on the diffraction MTF at low temperatures for the optical system shown in FIG. 37.

FIG. 45 is a graph showing data on the aberration characteristics of the optical system shown in FIG. 37 at low temperatures.

FIG. 46 is a graph showing data on the diffraction MTF of the optical system shown in FIG. 37 at high temperatures.

FIG. 47 is a graph showing data on the aberration characteristics of the optical system shown in FIG. 37 at high temperatures.

FIG. 48 is a graph showing the peripheral light intensity ratio of the optical system shown in FIG. 37.

FIG. 49 is an example of a vehicle equipped with an optical system according to an embodiment of the invention.

### BEST MODE

Hereinafter, exemplary embodiments of the present invention will be described in detail with reference to the accompanying drawings.

However, the present invention is not limited to the given exemplary embodiments described, but may be implemented in a variety of different forms, and one or more of components among the exemplary embodiments may be optionally combined or substituted between embodiments within the scope of the present invention.

Furthermore, terms (including technical and scientific terms) used in the embodiments of the present invention, unless expressly specifically defined and described, are to be interpreted in the sense in which they would be understood by a person of ordinary skill in the art to which the present invention belongs, and commonly used terms, such as dictionary-defined terms, are to be interpreted in light of their contextual meaning in the relevant art.

Furthermore, the terms used in the embodiments of the invention are intended to describe the embodiments and are not intended to limit the invention.

In this specification, the singular may include the plural unless the context otherwise requires, and references to “at least one (or more) of A and (or) B and C” may include one or more of any combination of A, B, and C that may be assembled.

In addition, the terms first, second, A, B, (a), (b), and the like may be used to describe components of embodiments of the invention. Such terms are intended only to distinguish one component from another, and are not intended to limit the nature or sequence or order of such components by such terms.

Furthermore, when a component is described as “connected,” “coupled,” or “attached” to another component, it can include cases where the component is “connected,” “coupled,” or “attached” to the other component directly, as well as cases where the component is “connected,” “coupled,” or “attached” to another component that is between the component and the other component.

Still furthermore, when described as being formed or disposed “above” or “below” each component, “above” or “below” includes not only when two components are in direct contact with each other, but also when one or more other components are formed or disposed between the two components. Furthermore, when expressed as “above” or “below”, it may include the meaning of upward as well as downward with respect to a single component.

In the description of the invention, ‘object side surface’ may refer to the surface of the lens facing the object side with respect to the optical axis (OA), and ‘sensor side surface’ may refer to the surface of the lens facing the imaging surface (image sensor) with respect to the optical axis. ‘Object side surface’ may be referred to as “object surface,” and “sensor side surface” may be referred to as “image side surface.” A convex surface of a lens may refer to a convex shape on the optical axis or paraxial region, and a concave surface of a lens may refer to a concave shape on the optical axis or paraxial region. The curvature radius, center thickness, and optical axis gap (spacing) between lenses listed in the lens data table may refer to values measured along the optical axis (unit: mm). The vertical direction may refer to the direction perpendicular to the optical axis, and the end of the lens or lens surface may refer to the end of the effective area (region) of the lens through which incident light passes. The size of the effective diameter of the lens surface may have a measurement error of up to ±0.4 mm depending on the measurement method. The term ‘paraxial region (near-axis) region’ refers to a very narrow area near the optical axis, where the distance from the optical axis (OA) to the light rays is almost zero. Hereinafter, the term ‘optical axis’ may refer to a center of each lens or a very narrow area near the optical axis.

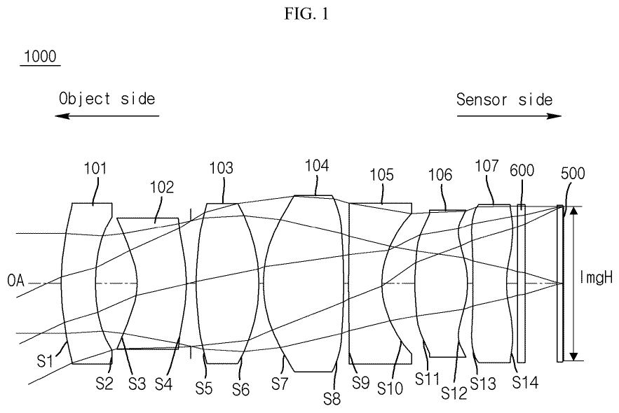

As shown in FIGS. 1, 13, 25, and 37, an optical system (1000, 1100, 1200, 1300) according to the first to fourth embodiments of the present invention may include five or more lenses. The optical systems (1000, 1100, 1200, 1300) and the camera modules incorporating them may be mounted inside or outside a vehicle to monitor the driver or sense external objects or lanes. The material of the lenses may be selected from glass or plastic, and the thermal expansion coefficient of glass is smaller than that of plastic. To suppress changes in the focal length imaging position due to temperature changes, glass lenses are employed. However, glass lenses are more expensive than plastic lenses and pose challenges in meeting cost-reduction requirements. Therefore, the lenses within the optical system (1000, 1100, 1200, 1300) require a hybrid configuration combining glass and plastic lenses. By adopting plastic lenses, the optical system (1000, 1100, 1200, 1300) can achieve lightweight and low-cost design by reducing the thickness of plastic lenses, and plastic lenses can provide good correction for various aberrations such as spherical aberration and chromatic aberration. Additionally, plastic lenses can provide aspherical lenses, thereby minimizing distortion in the peripheral areas.

The optical system (1000, 1100, 1200, 1300) may include n lenses, where the nth lens is the last lens adjacent to the image sensor (500), and the n-lth lens may be the lens most adjacent to the last lens. n is an integer greater than or equal to 6, such as 6 or 8. The ratio of glass lenses to plastic lenses among the n lenses may be within the range of 2:5 to 3:4. At least one lens within the optical system (1000, 1100, 1200, 1300) that is closest to the object may be made of glass. At least one of the two or fewer lenses closest to the object, for example, one lens, may be made of glass material. Since glass lenses have a smaller coefficient of thermal expansion than plastic lenses, glass lenses may be disposed in areas adjacent to the exterior within the lens barrel. At least one lens adjacent to the aperture (STOP) within the optical system (1000, 1100, 1200, 1300) may be made of glass. The lens adjacent to the aperture (STOP) on the sensor side may be made of glass. Lenses disposed adjacent to the aperture (STOP) are lenses with significant influence within the optical system (1000, 1100, 1200, 1300), so lenses made of glass material may be disposed to minimize changes in contraction and expansion due to temperature variations.

Within the optical system (1000, 1100, 1200, 1300), at least one lens closest to the image sensor (500) may be made of plastic material. For example, at least two lenses closest to the image sensor (500) may be made of plastic material, and preferably at least two lenses adjacent to the image sensor (500) may be made of plastic material. That is, since the nth and (n-1)th lenses in the optical system (1000, 1100, 1200, 1300) are arranged as plastic lenses, various aberrations can be corrected for the incident light on the image sensor (500).

Within the optical system (1000, 1100, 1200, 1300), lenses made of plastic material may be disposed consecutively, and lenses made of glass material may be disposed consecutively. Within the optical system (1000, 1100, 1200, 1300), lenses made of plastic material may be disposed between lenses made of glass material. Within the optical system (1000, 1100, 1200, 1300), glass lenses may be disposed between plastic lenses.

Each lens (101-107, 201-207, 301-307, 401-407) may have an object side surface and a sensor side surface. The number of lenses with aspherical sensor side surfaces and aspherical object side surfaces in the optical system may be greater than the number of plastic lenses. The number of lenses with spherical sensor side surfaces and spherical object side surfaces in the optical system may be smaller than the number of lenses with both sides being aspherical. The optical system (1000, 1100, 1200, 1300) includes more aspherical lenses than spherical lenses, enabling correction of various aberrations.

Among the lenses in the optical system (1000, 1100, 1200, 1300), the lens with the highest refractive index may be disposed close to the object. The maximum refractive index may be 1.6 or higher. The lens with the maximum refractive index can increase the color dispersion of incident light and allow the center thickness to be thinner than the edge thickness. Additionally, since the lens with the maximum refractive index is disposed on the object side, it facilitates changes in the curvature radius of subsequent lenses and allows the center thickness to be increased.

As shown in FIGS. 1, 13, 25, and 37, the optical systems (1000, 1100, 1200, 1300) according to the first to fourth embodiments of the present invention may include multiple lens groups (LG1, LG2). In detail, each of the multiple lens groups (LG1, LG2) includes at least one lens. For example, the optical system (1000, 1100, 1200, 1300) may include a first lens group (LG1) and a second lens group (LG2) disposed sequentially along the optical axis (OA) toward the image sensor (500) from the object side. The optical system (1000, 1100, 1200, 1300) may include n lenses, where the nth lens is the last lens, and the (n-1)th lens may be the lens most adjacent to the last lens. n is an integer of 5 or more, such as 5 to 9.

The optical system (1000, 1100, 1200, 1300) may include a first lens group (LG1) comprising a plurality of lenses disposed on the object side with respect to the aperture (STOP) and a second lens group (LG2) comprising a plurality of lenses disposed on the sensor side with respect to the aperture (STOP). The number of lenses in each of the first lens group (LG1) and the second lens group (LG2) may be different. The number of lenses in the second lens group (LG2) may be greater than the number of lenses in the first lens group (LG1).

The first lens group (LG1) may include at least one lens. The first lens group (LG1) may have three or fewer lenses. The first lens group (LG1) may preferably have two lenses. The second lens group (LG2) may include four or more lenses. The second lens group (LG2) may have five lenses.

The composite focal length of the first lens group (LG1) is defined as F_LG1, and the composite focal length of the second lens group (LG2) is defined as F_LG2, and the signs of F_LG1 and F_LG2 may be different. F_LG1 may have a negative (−) value, and F_LG2 may have a positive (+) value. This allows light to be diverged in one of the two lens groups and then converged in the other lens group. The difference between the absolute values of the composite focal length (F_LG1) of the first lens group (LG1) and the absolute values of the composite focal length (F_LG2) of the second lens group (LG2) can satisfy the range of 1 to 3.

The aperture (STOP) may be disposed between the second lens (102, 202, 302, 402) and the third lens (103, 203, 303, 403), the first lens group (LG1) may include the first to second lenses (101-102, 201-202, 301-302, 401-402), the second lens group (LG2) may include the third to seventh lenses (103-107, 203-207, 303-307, 403-407). The composite focal length of the first lens group (LG1) has a negative (−) sign, and at least one of the focal lengths of the first lenses (101, 201, 301, 401) and the second lenses (102, 202, 302, 402) may have the same sign as the focal length of the first lens group (LG1). The Abbe number of the lens in the first lens group (LG1) that has the same sign as the sign of the composite focal length of the first lens group (LG1) may be 40 or higher. The Abbe number of the first lens (101, 201, 301, 401) and the second lens (102, 202, 302, 402) may be 40 or higher, and preferably within the range of 50 to 70. This allows for the removal of aberrations in the light passing through each lens. However, lenses with relatively small refractive power may exceptionally have an Abbe number of 40 or less.

The second lens group (LG2) has a positive (+) sign for the combined focal length, and at least one of the focal lengths of the third lens (103, 203, 303, 403), the fourth lens (104, 204, 304, 404), and the sixth lens (106, 206, 306, 406) may have the same sign as the focal length of the second lens group (LG2). The Abbe number of the lens having the same sign as the sign of the composite focal length of the second lens group (LG2) in the second lens group (LG2) may be 40 or more. At least one of the fifth lenses (105, 205, 305, 405), sixth lenses (106, 206, 306, 406), and eighth lenses (108, 208, 308, 408) may have an Abbe number of 40 or higher. This allows for the removal of aberrations in the light passing through each lens. However, lenses with relatively small refractive power may have an Abbe number of 40 or less as an exception.

Within the optical system (1000, 1100, 1200, 1300), the lens with the maximum effective diameter may be disposed at the center of the object side and the sensor side. As the distance from the object side to the sensor side increases, the effective diameter of the lens may increase and then decrease. As the distance from the object side to the sensor side increases, the effective diameter of the lens may decrease and then increase, and then decrease again. As a result, the light entering the optical system (1000, 1100, 1200, 1300) diverges from the optical axis and then converges back toward the optical axis, enabling the optical system (1000, 1100, 1200, 1300) to form a stable optical path.

The effective diameter is the diameter of the effective area where light enters each lens. The effective diameter is the length in the direction perpendicular to the optical axis (X, Y) and is the average of the effective diameters on the object side and sensor side of each lens. ‘Lens surface diameter’ may refer to the ‘effective diameter of the lens.’ The ‘lens diameter’ may refer to the overall diameter of the lens, including the flange portion of the lens beyond the effective area. Although the flange of the lens is not shown in FIGS. 1, 13, 25, and 37, the flange may be a portion protruding perpendicular to the optical axis from the side of the lens for mounting the lens to a barrel. The flange may not allow effective light to enter. To connect the lens to the barrel, spacers may be additionally disposed between the flanges of different lenses.

Each lens (101-107, 201-207, 301-307, 401-407) may include an effective area and an ineffective area. The effective area may be an area through which light incident on each lens passes. In other words, the effective area may be defined as the effective region or effective path where incident light is refracted to realize optical characteristics. The non-effective region may be disposed around the effective region. The non-effective region may be an area where effective light does not enter from multiple lenses. In other words, the non-effective region may be an area unrelated to optical characteristics. Additionally, the end of the non-effective region may be an area fixed to a lens barrel or similar structure that accommodates the lens.

Within the optical system (1000, 1100, 1200, 1300), the TTL (Total top length) may be more than five times, for example, six times or more and eight times or less, than Imgh. TTL (Total track length) is the distance along the optical axis (OA) from the center of the object side surface of the first lens to the image surface of the image sensor (500). Imgh is half of the maximum diagonal length of the image sensor (500). Within the optical system (1000, 1100, 1200, 1300), the effective focal length (EFL) is 9 mm or more, and the horizontal field of view (FOV_H) is 145 degrees or more and less than 160 degrees, enabling the optical system to be provided as an optical system for vehicle interior monitoring in a vehicle camera module. For example, the optical system and camera module according to the embodiment may be applied to cameras for ADAS (Advanced Driving Assistance System) installed inside or outside a vehicle.

The optical system (1000, 1100, 1200, 1300) may have a TTL/Imgh ratio of 5 or higher and 7 or lower, for example, 5.5 or higher and 6.5 or lower.

By setting the TTL/Imgh value of the optical system (1000, 1100, 1200, 1300) to 5 or higher and 7 or lower, it is possible to provide an optical system for vehicle lenses. As a result, the optical system (1000, 1100, 1200, 1300) can provide an image without exaggeration or distortion of the imaged image.

Within the optical system (1000, 1100, 1200, 1300), the effective diameter of at least one plastic lens may be smaller than the length of the image sensor (500). The effective diameter is a diameter or length of the effective area through which light enters. The length of the image sensor (500) is the maximum length of the diagonal in a direction orthogonal to the optical axis (OA). Within the optical system (1000, 1100, 1200, 1300), the number of lenses with an effective diameter larger than the length of the image sensor (500) is 65% or more, or 75% or more, and the number of lenses with an effective diameter smaller than the length of the image sensor (500) may be less than 30%, or less than 25%.

A lens unit may consist of a combination of glass lenses and plastic lenses. The number of plastic lenses may account for more than 60% of the total number of lenses, and may range from 65% to 85%. As a result, when more plastic lenses are incorporated into the camera module, the weight of the camera module can be reduced. Additionally, plastic material offers advantages such as ease of polishing and processing, high resistance to external impacts, cost competitiveness, and ease of material procurement. Furthermore, plastic lenses can correct various aberrations, thereby inhibiting degradation of optical performance. The embodiment of the invention involves mixing additional plastic lenses within the optical system (1000, 1100, 1200, 1300), thereby reducing the weight of the camera module, providing a more cost-effective manufacturing process, suppressing degradation of optical characteristics due to temperature changes, enabling various types of plastic lenses to replace glass lenses, facilitating the polishing and processing of lens surfaces such as aspherical or free-form surfaces.

The effective diameter of the lens closest to the object side within the lens unit may be larger than the effective diameter of the lens closest to the image sensor (500). This allows control of the brightness of the optical system. The effective diameter may be the average effective diameter of the object side surface and sensor side surface of each lens. By controlling the effective diameter of each lens, the optical system (1000, 1100, 1200, 1300) can control incident light to compensate for resolution degradation and optical characteristic degradation due to temperature changes, improve chromatic aberration control characteristics, and improve the vignetting characteristics of the optical system (1000, 1100, 1200, 1300).

The lens unit may consist of the first lens (101, 201, 301, 401), the second lens (102, 202, 302, 402), the third lens (103, 203, 303, 403), fourth lens (104, 204, 304, 404), fifth lens (105, 205, 305, 405), sixth lens (106, 206, 306, 406), and seventh lens (107, 207, 307, 407).

The lens unit may be disposed in a camera module having an inner barrel on one side or the entire inner surface of the lens barrel. The lens unit may be disposed in a camera module having multiple inner barrels around the periphery of different lenses of the lens barrel. The lens unit may be disposed in a camera module having a first inner barrel in contact with the outer surface of at least one lens of the lens barrel and a second inner barrel in contact with the outer surface of at least one lens of the lens barrel. The lens unit may be disposed in a camera module having multiple inner barrels disposed between the outer side of at least one or two lenses and the lens barrel. The lens unit may be disposed in a camera module having multiple inner barrels made of a material different from that of the lens barrel.

Among the lenses that make up the lens unit, at least some of the glass lenses may be dispose in the lens barrel, and at least some of the plastic lenses may be disposed in an inner barrel disposed within the lens barrel. This allows the optical system (1000, 1100, 1200, 1300) to maintain its resolution despite temperature changes. The lens unit may be disposed in a camera module with a heterogeneous barrel, thereby minimizing the decenter of lenses, such as plastic lenses, that expand due to temperature changes. The lens barrel in which the lens unit is disposed may be equipped with multiple inner barrels within the lens barrel, thereby maintaining the resolution of the optical system due to temperature changes and suppressing deformation of the lenses. Therefore, the effective diameter of at least some of the glass lenses included in the lens unit may be smaller than that of at least some of the plastic lenses. Lenses with an effective diameter larger than the average effective diameter of the plastic lenses within the lens unit may be one or more, such as two or more. When the average effective diameter of the plastic lenses is PLca_Aver and the average effective diameter of the glass lenses is GLca_Aver, the condition PLca_Aver<GLca_Aver may be satisfied. Additionally, the condition 1.8<GLca_Aver/PLca_Aver<2.1 may be satisfied. Furthermore, the relationship between the length of the image sensor (500) and the average effective focal length of the plastic lens (PLca_Aver) may satisfy the condition 1.8<PLca_Aver/Imgh<2.1. Additionally, the relationship between the average effective focal length of the glass lens and the length of the image sensor (500) may satisfy the condition 1.5<GLca_Aver/Imgh<2. The difference between the maximum length of the image sensor (500) and the effective focal length of the plastic lens may be kept small. As a result, by placing plastic lenses with a small effective focal length adjacent to the image sensor (500), the plastic lenses can disperse color from the center to the periphery of the image sensor (500).

The average effective diameter of glass materials may be 8 mm or more, for example, within the range of 9 mm to 11 mm. The average effective diameter of plastic materials may be 8 mm or more, for example, within the range of 9 mm to 11 mm. Lenses with the minimum effective diameter maybe made of plastic, and lenses with the maximum effective diameter may be made of glass. Within the lens unit, the minimum effective diameter may be within the range of 7 mm to 9 mm, and the maximum effective diameter may be within the range of 10 mm to 13 mm. Plastic lenses may be designed with a smaller effective diameter than glass lenses to inhibit contact with the lens barrel, thereby minimizing optical performance changes due to temperature variations. Additionally, the optical system (1000, 1100, 1200, 1300) can control incoming light to improve resolution and chromatic aberration control characteristics, and improve the vignetting characteristics of the optical system (1000, 1100, 1200, 1300). The optical system (1000, 1100, 1200, 1300) or camera module may include an image sensor (500). The image sensor (500) can detect light and convert it into electrical signals. The image sensor (500) can detect light that has sequentially passed through the lens unit. The image sensor (500) may include devices such as a CCD (Charge Coupled Device) or CMOS (Complementary Metal Oxide Semiconductor) that can detect incident light.

The optical system (1000, 1100, 1200, 1300) or camera module may include a filter (600). The filter (600) may be disposed between the last lens and the image sensor (500). The filter (600) may be disposed between the lens closest to the sensor side among the lenses of the lens unit and the image sensor (500). For example, the filter (600) may be disposed between the nth lens and the image sensor (500).

The cover glass may be disposed between the filter (600) and the image sensor (500), protecting the upper part of the image sensor (500) and inhibiting a decrease in the reliability of the image sensor (500). The cover glass may be removable. The cover glass may be a protective glass.

The filter (600) may include an infrared filter or an infrared cut-off filter (IR cut-off). The filter (600) may transmit light within a set wavelength band and filter out light from other wavelength bands. When the filter (600) includes an infrared filter, it can block radiant heat emitted from external light from being transmitted to the image sensor (500). Additionally, the filter (600) can transmit visible light and reflect infrared light.

The optical system (1000, 1100, 1200, 1300) according to the embodiment may include an aperture (Stop). The aperture can control the amount of light entering the optical system (1000, 1100, 1200, 1300). In the lenses disposed between the object and the aperture, there is a tendency for the effective diameter of the lens surfaces to increase as one moves from the object side toward the aperture. In the lens surfaces disposed between the aperture and the sensor, there is a tendency for the effective diameter of the lens surfaces to decrease as one moves from the aperture toward the sensor side. The tendency for the effective diameter of lens surfaces to increase or decrease does not mean that the effective diameter of lens surfaces only increases or decreases. For example, it also includes cases where the effective diameter of lens surfaces increases and then decreases as the distance from the aperture to the sensor increases.

In the optical systems (1000, 1100, 1200, 1300) of the first to fourth embodiments, the sum of the refractive indices of the lenses in the lens unit may be 9 or more, for example, in the range of 10 to 13, and the average refractive index may be in the range of 1.5 to 1.7. The sum of the Abbe numbers of each lens may be 340 or higher, for example, within the range of 350 to 380, and the average Abbe number may be 60 or lower, for example, within the range of 45 to 55. The total center thickness of all lenses may be 18 mm or more, for example, within the range of 19 mm to 21 mm, and the average center thickness may be within the range of 2 mm to 3 mm. The total center gap between lenses along the optical axis (OA) may be 4 mm or more, for example, within the range of 5 mm to 7 mm, and may be less than the total center thickness of the lenses.

Additionally, the average value of the effective diameter of each lens surface (S1-S14) in the lens unit may be 3 mm or more, for example, within the range of 3.5 mm to 4.5 mm. In the optical system according to the first to fourth embodiments of the invention, the F-number may be 1.8 or less, for example, within the range of 1.5 to 1.7.

The vehicle optical system may have a horizontal field of view (FOV_H) in the Y-axis direction exceeding 40 degrees and less than 60 degrees, for example, within the range of 45 degrees to 50 degrees. Additionally, the vertical field of view may be provided at an angle smaller than the horizontal field of view. The vertical field of view (FOV_V) may be greater than 20 degrees and less than 35 degrees, for example, within the range of 25 degrees to 30 degrees. The sensor length in the horizontal direction (Y) may be 8.64 mm±0.5 mm, and the sensor height in the vertical direction (X) may be 5.58 mm±0.5 mm. The horizontal field of view (FOV_H) is the field of view based on the horizontal (Horizontal) length of the image sensor, and the vertical field of view (FOV_V) is the field of view based on the vertical (Vertical) length of the image sensor. As a result, changes in the focus imaging position due to temperature variations can be suppressed, and the camera can be provided as a vehicle-mounted camera with various aberrations effectively corrected.

The optical system applied to vehicle cameras may be typically designed based on the horizontal field of view (FOV) rather than the entire field of view, as it is intended to monitor road conditions. The optical system according to this embodiment is designed with a certain margin around the inscribed circle of the image sensor. Optical performance may be ensured within the range that satisfies the horizontal FOV (FOV_H).

Since the embodiment is an optical system applied to a vehicle camera, even though it is designed using both plastic lenses and glass lenses, the first lens (101, 201, 301, 401) may be provided in a glass material. This is because glass material has the advantages of being scratch-resistant and insensitive to external temperatures compared to plastic material. The first lens (101, 201, 301, 401) may be a glass mold lens made of glass material with an aspherical shape. A glass mold lens may be manufactured by placing an optical glass ingot inside a mold with an aspherical shape and undergoing heating and compression processes.

To effectively inhibit scratches caused by foreign objects when installed inside a vehicle, a glass lens may be used as the first lens (101, 201, 301, 401), and the object side surface of the first lens (101, 201, 301, 401) may have a gentle curved surface to avoid contact with external structures. This minimizes the occurrence of scratches caused by contact with external structures. For driver monitoring, front/rear vehicle imaging, or lane detection and detection of sudden objects around the vehicle during vehicle operation, the field of view may be greater than 40 degrees and less than 60 degrees, such as within the range of 45 to 50 degrees. Such a horizontal field of view may be a pre-set angle for advanced driver assistance systems (ADAS).

The optical system (1000, 1100, 1200, 1300) according to the embodiment may further include a reflective member for changing the light path. The reflective member may be implemented as a prism that reflects incident light toward the lenses in the optical system (1000, 1100, 1200, 1300). Hereinafter, the optical system according to the embodiment will be described in detail.

The optical system according to the first embodiment of the invention will be described.

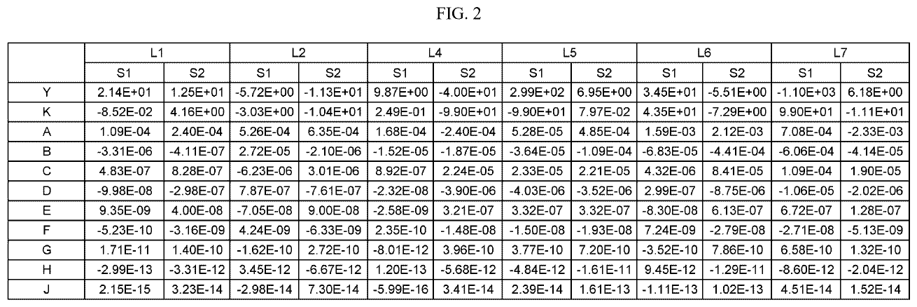

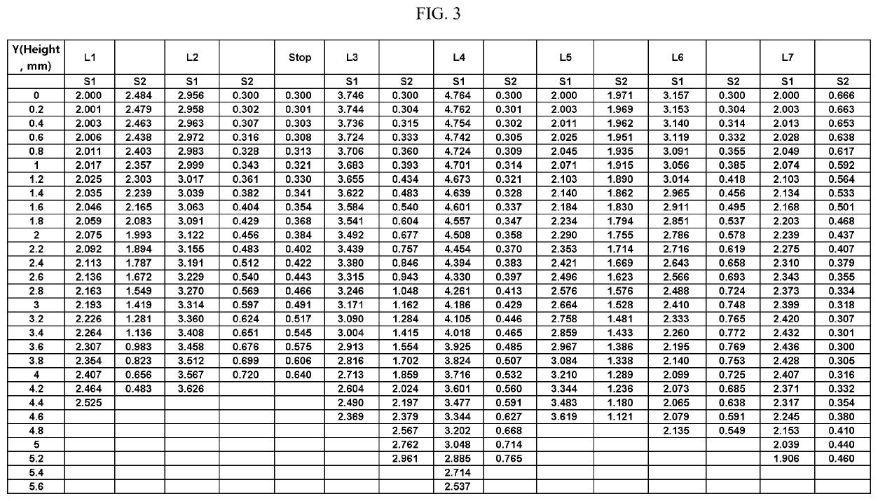

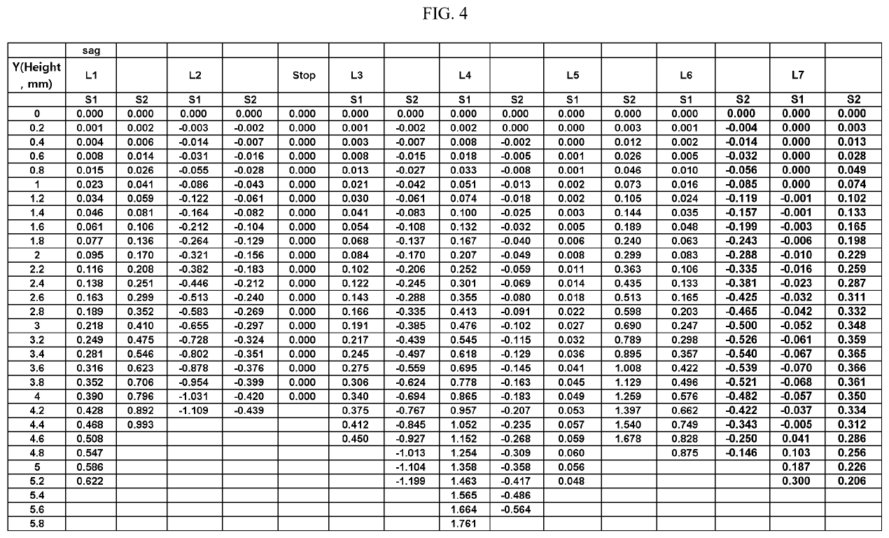

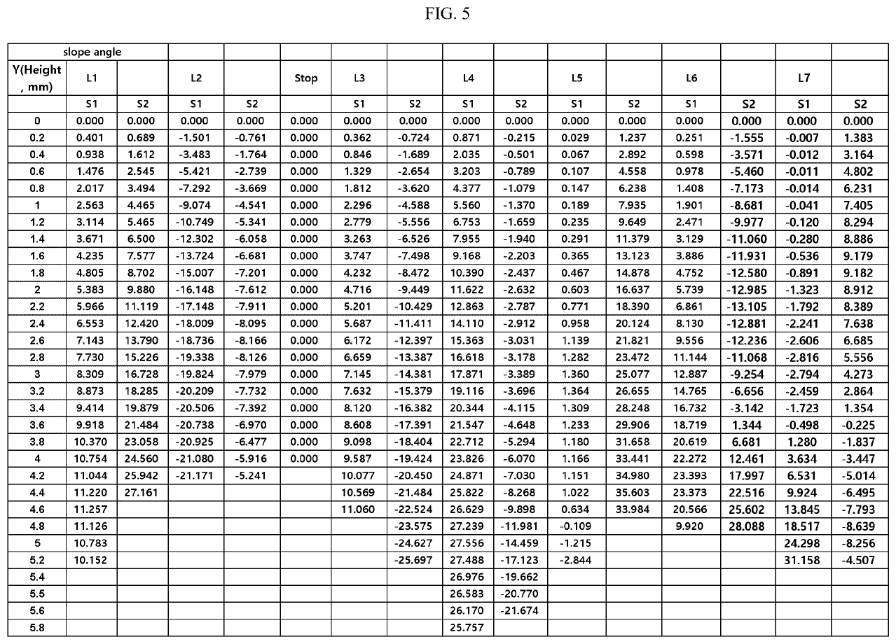

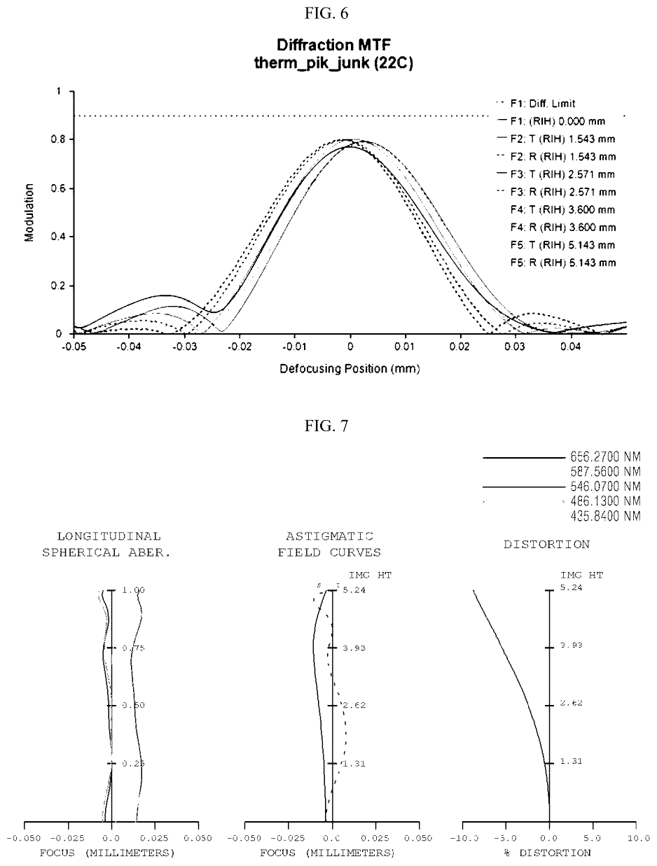

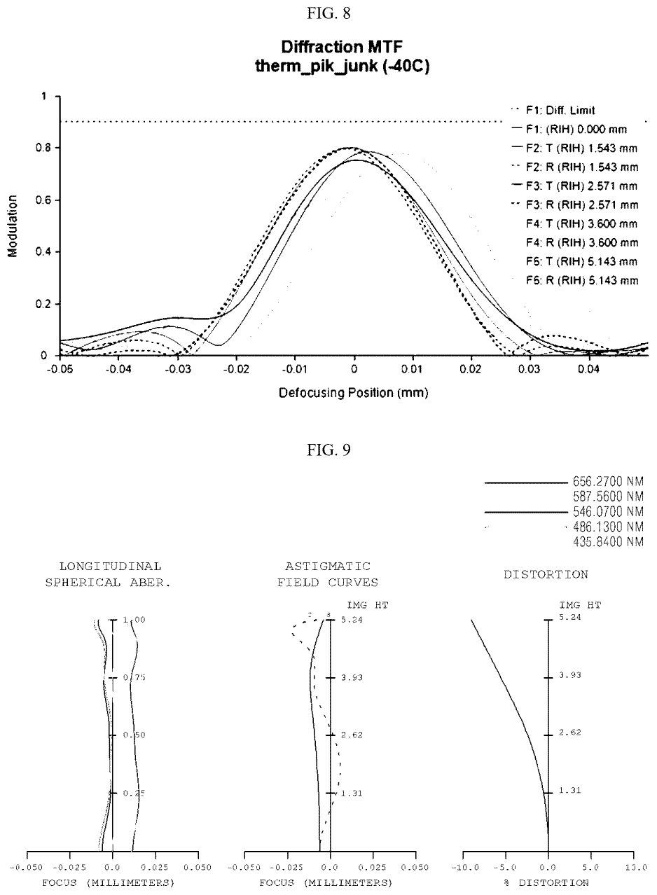

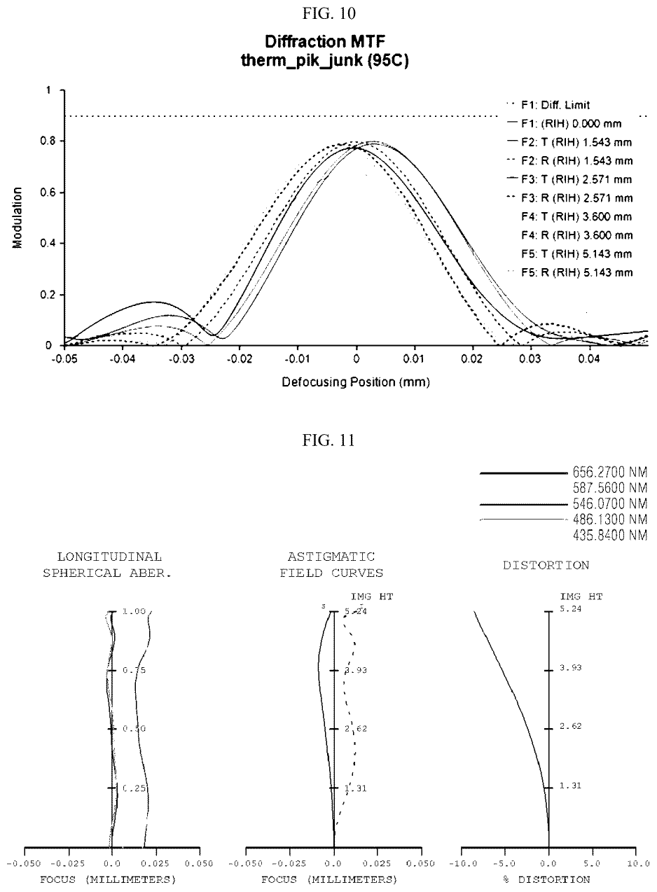

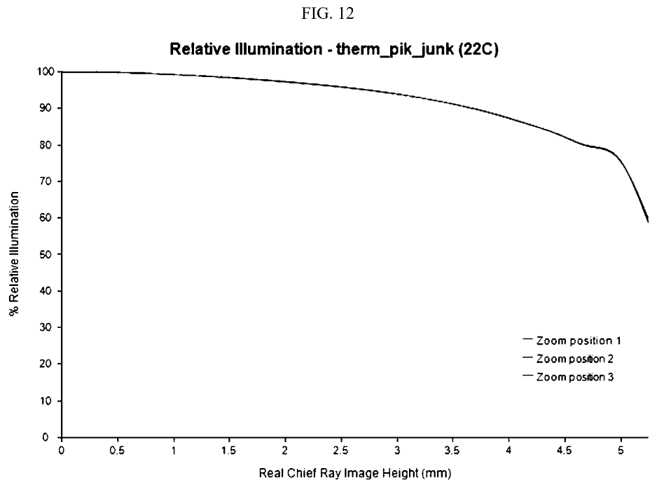

FIG. 1 is a side cross-sectional view of an optical system and a camera module including the same according to a first embodiment, FIG. 2 is a table showing the aspheric coefficients of the lenses in the optical system of FIG. 1, FIG. 3 is a table showing the thickness of each lens in the optical system of FIG. 1 and a gap between adjacent lenses, FIG. 4 is a table showing the Sag values of lens surfaces of the first to seventh lenses in the optical system of FIG. 1, FIG. 5 is a table showing the slope angle values of lens surfaces of the first to seventh lenses in the optical system of FIG. 1, FIG. 6 is a graph showing the data for the diffraction MTF (Modulation Transfer Function) at room temperature for the optical system of FIG. 1, FIG. 7 is a graph showing the data for the aberration characteristics at room temperature for the optical system of FIG. 1, FIG. 8 is a graph showing the diffraction MTF data at low temperatures for the optical system shown in FIG. 1, FIG. 9 is a graph showing the aberration characteristics data at low temperatures for the optical system shown in FIG. 1, FIG. 10 is a graph showing the diffraction MTF data of the optical system shown in FIG. 1 at high temperatures, FIG. 11 is a graph showing the aberration characteristics data of the optical system shown in FIG. 1 at high temperatures, and FIG. 12 is a graph showing the peripheral light intensity ratio of the optical system shown in FIG. 1.

Referring to FIG. 1, the optical system (1000) may include a lens unit, which may include a first lens (101) to a seventh lens (107). The first to seventh lenses (101 to 107) may be disposed sequentially along the optical axis (OA) of the optical system (1000). Light corresponding to the information of the object may pass through the first lens (101) to the seventh lens (107) and the filter (600) and enter the image sensor (500).

The first lens (101) may be disposed closest to the object side. The first lens (101) may be disposed farthest from the sensor side. The first lens (101) may have a negative (−) refractive power relative to the optical axis (OA). The first lens (101) may include a plastic material or a glass material, and may, for example, be made of glass. The first lens (101) made of glass may reduce changes in the center position and curvature radius due to temperature changes caused by the surrounding environment, and may protect the incident side of the optical system (1000).

Based on the optical axis, the object-side first surface (S1) of the first lens (101) is convex, and the sensor-side second surface (S2) may be concave. The first lens (101) may have a convex meniscus shape on the object side. The first lens (101) may have a concave meniscus shape on the sensor side. The first lens (101) may be made of glass material and may have an aspherical surface. At least one or both of the first surface (S1) and the second surface (S2) may be aspherical. The asphericity coefficient of the first and second surfaces (S1, S2) may be provided as S1 and S2 of L3 in FIG. 2. At least one or both of the first surface (S1) and the second surface (S2) may be provided without a critical point from the optical axis (OA) to the end of the effective area.

Due to the refractive characteristics of the first lens (101), the second lens (102) may be spaced further apart from the first lens (101). That is, the center gap between the first and second lenses (101, 102) may be the largest within the lens unit.

The refractive index (n1) of the first lens (101) may satisfy the condition n1>1.6 or n1>1.62. When the refractive index (n1) of the first lens (101) satisfies the above condition, the curvature radius of the first and second lenses (101, 102) can increase, making lens manufacturing easier. If the refractive index (n1) of the first lens (101) is smaller than the condition, the refractive power of the first and second lenses (101, 102) must be increased by forming the lens surface sharply concave or convex, which makes lens manufacturing difficult, increases the defect rate, and may cause a decrease in yield.

The second lens (102) may be disposed second from the object side. The second lens (102) may be disposed sixth from the sensor side. The second lens (102) may be disposed between the first lens (101) and the third lens (103). The second lens (102) may have a negative (−) refractive power on the optical axis (OA). The second lens (102) may include a plastic or glass material. For example, the second lens (102) may be provided in a plastic material.

Based on the optical axis (OA), the object-side third surface (S3) of the second lens (102) may be concave, and the sensor-side fourth surface (S4) may be convex. The second lens (102) may have a convex meniscus shape toward the sensor side. The second lens (102) may have a concave meniscus shape on the object side. The second lens (102) may be made of plastic material and may be aspherical. At least one or both of the third surface (S3) and the fourth surface (S4) may be aspherical. The aspheric coefficients of the third and fourth surfaces (S3, S4) may be provided as S1 and S2 of L2 in FIG. 2. At least one or both of the third surface (S3) and the fourth surface (S4) may be provided without a critical point from the optical axis (OA) to the end of the effective area.

An aperture (Stop) may be disposed around the perimeter of the sensor side fourth surface (S4) of the second lens (102). The aperture (Stop) may be disposed around the perimeter of the object side fifth surface (S5) of the third lens (103). The aperture can reduce the TTL within the field of view and enable the miniaturization of the optical system. As a result, it is possible to inhibit a decrease in the weight-based yield (yield by weight) of the optical system and improve production efficiency. Additionally, the optical system can be miniaturized by reducing the TTL within a horizontal field of view (FOV_H) of 40 to 50 degrees.

The third lens (103) may be disposed third from the object side. The third lens (103) may be disposed fifth from the sensor side. The third lens (103) may be disposed between the second lens (102) and the fourth lens (104). The third lens (103) may have a positive (+) refractive power on the optical axis (OA). The third lens (103) may include a plastic or glass material. For example, the third lens (103) may be provided in a glass material.

Based on the optical axis, the object-side fifth surface (S5) of the third lens (103) may be convex, and the sensor-side sixth surface (S6) may be convex. The third lens (103) may have a shape where both surfaces are convex. The third lens (103) may be made of glass material and may be spherical. At least one or both of the fifth surface (S5) and the sixth surface (S6) may be provided without a critical point from the optical axis (OA) to the end of the effective area.

The fourth lens (104) may be disposed as the fourth lens on the object side. The fourth lens (104) may be disposed as the fourth lens on the sensor side. The fourth lens (104) may be disposed between the third lens (103) and the fifth lens (105). The fourth lens (104) may have a positive (+) or negative (−) refractive power relative to the optical axis (OA). The fourth lens (104) may have a positive (+) refractive power. The fourth lens (104) may include a plastic or glass material. For example, the fourth lens (104) may be provided in a plastic material.

Based on the optical axis, the object-side seventh surface (S7) of the fourth lens (104) may be convex, and the sensor-side eighth surface (S8) may be convex. The fourth lens (104) may have a shape where both surfaces are convex. The fourth lens (104) may be made of plastic material and may be aspherical. At least one or both of the seventh surface (S7) and the eighth surface (S8) may be aspherical. The asphericity coefficients of the seventh and eighth surfaces (S7, S8) may be provided as S1 and S2 of L4 in FIG. 2. At least one or both of the seventh surface (S7) and the eighth surface (S8) may be provided without a critical point from the optical axis (OA) to the end of the effective area.

The fifth lens (105) may be disposed fifth from the object side. The fifth lens (105) may be disposed third from the sensor side. The fifth lens (105) may be disposed between the fourth lens (104) and the sixth lens (106). The fifth lens (105) may have a positive (+) or negative (−) refractive power relative to the optical axis (OA). The fifth lens (105) may have a negative (−) refractive power. The fifth lens (105) may include a plastic or glass material. For example, the fifth lens (105) may be provided in a plastic material.

With respect to the optical axis (OA), the fifth lens (105) may have an object side convex ninth surface (S9) and a sensor side concave tenth surface (S10). The fifth lens (105) may have a convex meniscus shape on the object side. The fifth lens (105) may have a concave meniscus shape on the sensor side. The fifth lens (105) may be made of plastic material and may be aspherical. At least one or both of the ninth surface (S9) and the tenth surface (S10) may be aspherical. The asphericity coefficients of the ninth and tenth surfaces (S9, S10) may be provided as S1 and S2 of L5 in FIG. 2. At least one or both of the ninth surface (S9) and the tenth surface (S10) may be provided without a critical point from the optical axis (OA) to the end of the effective area.

The sixth lens (106) may be disposed as the sixth lens from the object side. The sixth lens (106) may be disposed as the second lens from the sensor side. The sixth lens (106) may be disposed between the fifth lens (105) and the seventh lens (107). The sixth lens (106) may have a positive (+) or negative (−) refractive power along the optical axis (OA). The sixth lens (106) may have a positive (+) refractive power. The sixth lens (106) may include a plastic or glass material. For example, the sixth lens (106) may be provided in a plastic material.

With respect to the optical axis (OA), the sixth lens (106) may have an object side convex 11th surface (S11) and a sensor side convex 12th surface (S12). The sixth lens (106) may have a shape with both surfaces being convex. The sixth lens (106) may be made of plastic material and may be aspherical. At least one or both of the eleventh surface (S11) and twelfth surface (S12) may be aspherical. The asphericity coefficient of the eleventh and twelfth surfaces (S11, S12) may be provided as S1 and S2 of L6 in FIG. 2.

The 11th surface (S11) of the 6th lens (106) may be provided without a critical point from the optical axis (OA) to the end of the effective area. The 12th surface (S12) of the 6th lens (106) may include a critical point from the optical axis (OA) to the end of the effective area. When the 12th surface (S12) has a critical point, it may be located within the range of 75% to 80% of the effective radius (r62) from the optical axis (OA), preferably within the range of 76% to 77%. The critical point of the 12th surface (S12) may be located within a range of 3.3 mm to 4 mm from the optical axis (OA), preferably within a range of 3.5 mm to 3.6 mm.

The seventh lens (107) may be disposed farthest from the object side. The seventh lens (107) may be disposed closest to the image sensor (500). The seventh lens (107) may have a positive (+) or negative (−) refractive power on the optical axis (OA). The seventh lens (107) may have a negative (−) refractive power. The seventh lens (107) may include a plastic or glass material. For example, the seventh lens (107) may be provided in a plastic material.

With respect to the optical axis (OA), the seventh lens (107) may have an object side concave 13th surface (S13) and a sensor side concave 14th surface (S14). The seventh lens (107) may have a concave shape on both surfaces. At least one or both of the 13th surface (S13) and the 14th surface (S14) may be aspherical. The asphericity coefficient of the 13th and 14th surfaces (S13, S14) may be provided as S13 and S14 of L7 in FIG. 2.

The 13th surface (S13) of the 7th lens (107) may include a critical point extending from the optical axis (OA) to the end of the effective area. If the 13th surface (S13) has a critical point, it may be located within the range of 65% to 75% of the effective radius (r71) from the optical axis (OA), preferably within the range of 69% to 72%. The critical point of the 13th surface (S13) may be located within a range of 3.5 mm to 4 mm, preferably 3.6 mm to 3.7 mm, from the optical axis (OA). The 14th surface (S14) of the 7th lens (107) may include a critical point extending from the optical axis (OA) to the end of the effective area. If the 14th surface (S14) has a critical point, it may be located within the range of 65% to 75% of the effective radius (r72) from the optical axis (OA), preferably within the range of 69% to 72%. The critical point of the 14th surface (S14) may be located within a range of 3.5 mm to 4 mm, preferably 3.6 mm to 3.7 mm, from the optical axis (OA).

The seventh lens (107) may be the plastic lens closest to the image sensor (500). Additionally, by arranging two or more plastic lenses adjacent to the image sensor (500), aberrations such as spherical aberration and chromatic aberration can be improved by the lens surfaces with aspherical shapes, and the resolution can be controlled. Furthermore, by arranging a plastic lens adjacent to the image sensor (500), it is possible to be less sensitive to assembly tolerances compared to glass lenses. In other words, being less sensitive to assembly tolerances means that even if the assembly differs slightly from the design during assembly, it may not significantly affect optical performance. Furthermore, by providing the two lenses (106, 107) adjacent to the image sensor (500) in a plastic material, the optical performance can be improved by the aspherical lens surfaces, for example, by improving aberration characteristics and inhibiting resolution degradation.

TABLE 1

| | | | | | | Semi | Focal |
|---|---|---|---|---|---|---|---|
| Lens | Surface | Radius | Thickness | nd | vd | Aperture | length |
| 1 | S1 | 21.415 | 2.000 | 1.6413 | 55.1788 | 5.344 | −51.1508 |
| | S2 | 12.484 | 2.484 | | | 4.466 | |
| 2 | S3 | −5.720 | 2.956 | 1.5371 | 55.7074 | 4.388 | −26.5657 |
| | S4 | −11.270 | 0.300 | | | 4.270 | |
| STOP | — | — | 0.300 | | | 4.200 | |
| 3 | S5 | 23.717 | 3.746 | 1.6223 | 63.8790 | 4.797 | 13.2530 |
| | S6 | −11.878 | 0.300 | | | 5.362 | |
| 4 | S7 | 9.867 | 4.764 | 1.5371 | 55.7074 | 5.897 | 15.2476 |
| | S8 | −40.034 | 0.300 | | | 5.726 | |
| 5 | S9 | 299.296 | 2.000 | 1.6640 | 21.2131 | 5.373 | −10.7433 |
| | S10 | 6.948 | 1.971 | | | 4.744 | |
| 6 | S11 | 34.503 | 3.157 | 1.5371 | 55.7074 | 4.830 | 9.0902 |
| | S12 | −5.505 | 0.300 | | | 4.892 | |
| 7 | S13 | −1096.716 | 2.000 | 1.5371 | 55.7074 | 5.254 | −11.4409 |
| | S14 | 6.183 | 0.666 | | | 5.239 | |
| Filter | | infinity | 0.440 | | | | |
| | | | 1.936 | | | | |
| Cover | | infinity | 0.330 | | | | |
| | | | 0.044 | | | | |
| Image | | infinity | 0.000 | | | | |

Table 1 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the first embodiment of the present invention. Here, the units for curvature radius and thickness or distance may be mm.

TABLE 2

| items | values | items | values |
|---|---|---|---|
| F | 10.8775 | F-number | 1.6400 |
| ET1 | 2.3712 | FOV_H | 46.00 |
| ET2 | 3.6833 | EPD | 6.6326 |
| ET3 | 2.0000 | BFL | 3.4160 |
| ET4 | 2.3491 | TD | 26.5787 |
| ET5 | 3.7244 | ImgH | 5.1450 |
| ET6 | 2.1833 | SD | 18.8390 |
| ET7 | 1.8859 | TTL | 29.9947 |
| ΣIndex | 11.0760 | GLca_Aver | 9.984 |
| ΣAbbe | 363.1005 | PLca_Aver | 10.123 |
| ΣCT | 20.6237 | CT_max | 4.7644 |
| ΣCG | 5.9550 | CT_min | 2.0000 |
| CA_max | 11.794 | CT_Aver | 2.9462 |
| CA_min | 8.400 | F_LG1 | −17.904 |
| CA_Aver | 9.971 | F_LG2 | 8.578 |

Table 2 shows the items corresponding to the mathematical equations described above in the optical system (1000) of the embodiment, including the TTL (Total track length) (mm), BFL (Back focal length), effective focal length (F) (mm), ImgH (mm), effective diameter (CA) (mm), thickness (mm), TTL (mm), optical axis distance TD (mm) from the first surface (S1) to the fourteenth surface (S14), refractive index sum, Abbe number sum, thickness sum (mm), sum of the distances between adjacent lenses, effective diameter characteristics, sum of the refractive indices of glass lenses, sum of the refractive indices of plastic materials, field of view (FOV_H) (degrees), edge thickness (ET), F-number, and other related parameters.

The center thickness of the first to seventh lenses (101 to 107) is indicated as CT1 to CT7, the edge thickness at the end of the effective area of each lens is indicated as ET1 to ET7, the center gap between adjacent lenses is indicated as CG1 to CG6, the edge gaps between the edges of each lens are denoted as EG1 to EG6. BFL (Back focal length) is the optical axis distance from the image sensor (500) to the center of the last lens. TTL is the optical axis distance from the center of the first surface (S1) of the first lens (101) to the image surface of the image sensor (500).

As shown in FIG. 2, the lens surfaces of the first, second, fourth, fifth, sixth, and seventh lenses (101, 102, 104, 105, 106, 107) in the lens unit of the first embodiment may include aspherical surfaces with a 30th-order asphericity coefficient. For example, the first, second, fourth, fifth, sixth, and seventh lenses (101, 102, 104, 105, 106, 107) may include lens surfaces having a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV).

The thickness (T1-T7) of the first to seventh lenses (101-107) and the gap (G1-G6) between adjacent lenses can be set. As shown in FIG. 3, the thickness (T1-T7) of each lens in the Y-axis direction may be represented at intervals of 0.1 mm or 0.2 mm or more, and the gap (G1-G6) between each lens may be represented at intervals of 0.1 mm or 0.2 mm or more.

When comparing the absolute values of the curvature radii of each lens, the curvature radius of the 13th surface (S13) of the 7th lens (107) at the optical axis (OA) is the largest among the lenses, and the curvature radius of the 12th surface (S12) of the 6th lens (106) may be the smallest among the lenses. The difference between the maximum and minimum curvature radii may be more than 50 times, for example, within the range of 50 to 60 times. Among the object-side surfaces and sensor-side surfaces of the first to seventh lenses (101-107), the number of lens surfaces with a curvature radius greater than 40 may be one or more but no more than four. This allows the curvature radii of the lenses constituting the optical system (1000) to be designed to be mostly small, thereby satisfying the field of view, focal length, and overall length of the lenses when they are mounted in a vehicle. Since the effective diameter of a plastic lens is smaller than that of a glass lens, the lens disposed on the object side of a plastic lens may have a stronger refractive power to refract light through the plastic lens. Additionally, to increase the refractive power, the curvature radius of the lens surface may be made smaller. The absolute value of the curvature radius of the first surface (S1) of the first lens (101) may be larger than the absolute value of the curvature radius of the second surface (S2). The absolute value of the curvature radius of the third surface (S3) of the second lens (102) may be smaller than the absolute value of the curvature radius of the fourth surface (S4). The absolute value of the curvature radius of the fifth surface (S5) of the third lens (103) may be larger than the absolute value of the curvature radius of the sixth surface (S6). The absolute value of the curvature radius of the seventh surface (S7) of the fourth lens (104) may be smaller than the absolute value of the curvature radius of the eighth surface (S8). The absolute value of the curvature radius of the ninth surface (S9) of the fifth lens (105) may be larger than the absolute value of the curvature radius of the tenth surface (S10). The absolute value of the curvature radius of the eleventh surface (S11) of the sixth lens (106) may be greater than the absolute value of the curvature radius of the twelfth surface (S12). The absolute value of the curvature radius of the thirteenth surface (S13) of the seventh lens (107) may be greater than the absolute value of the curvature radius of the fourteenth surface (S14).

The ratio of the curvature radii of each lens may satisfy the following conditions.

$$1.5 < L 1 R 1 / L 1 R \vert < 2 \qquad Condition 1$$

$$0.5 < \vert L 2 R 1 / L 2 R 2 \vert < 1 \qquad Condition 2$$

$$1.5 < \vert L 3 R 1 / L 3 R 2 \vert < 2 \qquad Condition 3$$

$$0.1 < \vert L 4 R 1 / L 4 R 2 \vert < 0.5 \qquad Condition 4$$

$$40 < \vert L 5 R 1 / L 5 R 2 \vert < 50 \qquad Condition 5$$

$$5 < \vert L 6 R 1 / L 6 R 2 \vert < 10 \qquad Condition 6$$

$$150 < \vert L 7 R 1 / L 7 R 2 \vert < 200 \qquad Condition 7$$

When describing the center thickness (CT) of the lenses based on the optical axis, the center thickness (CT4) of the fourth lens (104) may be the maximum among the lenses, and the center thickness (CT1, CT5, CT7) of at least one of the first lens (101), fifth lens (105) and seventh lens (107) may be the minimum among the lenses. The difference between the maximum and minimum center thicknesses of the lenses may be within the range of 2 mm or more and 2.5 mm or less.

The center thickness of each lens may satisfy any one of the following conditions.

$$CT 2 , CT 3 , CT 4 , CT 6 > CT 1 = CT 5 = CT 7 \qquad Condition 1$$

$$CT 3 , CT 4 , CT 6 > CT 2 > CT 1 , CT 3 , CT 5 , CT 7 \qquad Condition 2$$

$$CT 4 > CT 3 > CT 1 , CT 2 , CT 5 , CT 6 , CT 7 \qquad Condition 3$$

$$CT 4 > CT 1 , CT 2 , CT 3 , CT 6 , CT 7 \qquad Condition 4$$

$$CT 3 , CT 4 > CT 6 > CT 1 , CT 2 , CT 5 , CT 7 \qquad Condition 5$$

The center gap (CG) between the lenses is explained as follows: the center gap (CG1) between the first lens (101) and the second lens (102) may be the maximum, and at least one of the center gap (CG3) between the third and fourth lenses (103, 104), the center gap (CG4) between the fourth and fifth lenses (104, 105), and the center gap (CG6) between the sixth and seventh lenses (106, 107) may be the smallest. The difference between the maximum center gap and the minimum center gap among the spaced-out lens gaps may be 3 mm or more, for example, within the range of 3 mm to 4 mm.

The center gap between each lens may satisfy the following conditions.

$$CG 1 > CG 2 , CG 3 , CG 4 , CG 5 , CG 6 \qquad Condition 1$$

$$CG 1 , CG 5 > CG 2 > CG 3 , CG 4 , CG 6 \qquad Condition 2$$

$$CG 1 , CG 2 , CG 5 > CG 3 = CG 4 = CG 6 \qquad Condition 3$$

$$CG 1 > CG 5 > CG 2 , CG 3 , CG 4 , CG 6 \qquad Condition 4$$

Regarding the effective diameter, a lens with the maximum effective diameter may be a lens made of glass material. The lens with the maximum effective diameter may be the fourth lens (104). Here, the effective diameter is an average of the effective diameter on the object side surface and the effective diameter on the sensor side surface of each lens. The lens surface with the maximum effective diameter may be the seventh surface (S7) of the fourth lens (104). The lens with the minimum effective diameter may be the second lens (102). The lens surface with the minimum effective diameter may be the fourth surface (S4) of the second lens (102). The effective diameter of a plastic lens may be smaller than that of a glass lens. A plastic lens may be disposed adjacent to the image sensor.

The effective diameter of each lens may satisfy any one of the following conditions.

$$CA\_L3 , CA\_L4 , CA\_L5 , CA\_L7 > CA\_L1 > CA\_L2 , CA\_L6 \qquad Condition 1$$

$$CA\_L1 , CA\_L3 , CA\_L4 , CA\_L5 , CA\_L6 , CA\_L7 > CA\_L2 \qquad Condition 2$$

$$CA\_L4 , CA\_L7 > CA\_L3 > CA\_L1 , CA\_L2 , CA\_L5 , CA\_L6 \qquad Condition 3$$

$$CA\_L4 > CA\_L1 , CA\_L2 , CA\_L3 , CA\_L5 , CA\_L6 , CA\_L7 \qquad Condition 4$$

$$CA\_L3 , CA\_L4 , CA\_L7 > CA\_L5 > CA\_L1 , CA\_L2 , CA\_L6 \qquad Condition 5$$

$$CA\_L1 , CA\_L3 , CA\_L4 , CA\_L5 , CA\_L7 > CA\_L6 > CA\_L2 \qquad Condition 6$$

$$CA\_L4 > CA\_L7 > CA\_L1 , CA\_L2 , CA\_L3 , CA\_L5 , CA\_L6 \qquad Condition 7$$

Regarding the refractive index, the refractive index of the fifth lens (105) may be the highest among the lenses, exceeding 1.6, for example, 1.65. The second lens (102), fourth lens (104), sixth lens (106), and seventh lens (107) may have the lowest refractive index among the lenses, either individually or collectively. For example, the refractive indices of the second lens (102), the sixth lens (106), and the seventh lens (108) may be the lowest among the lenses, less than 1.6, such as less than 1.55. The difference between the maximum refractive index and the minimum refractive index may be 0.2 or more. By providing the lens made of glass material with the highest refractive index closest to the object, and providing the lens adjacent to the glass material lens and the lens adjacent to the image sensor (500) with a lens made of plastic material with the lowest refractive index, the incident efficiency can be increased, and the refractive force between the lenses made of glass material and plastic material can be controlled to guide the light to the image sensor (500).

The refractive index of each lens may satisfy any one of the following conditions.

$$n 5 > n 1 > n 2 , n 3 , n 4 , n 6 , n 7 \qquad Condition 1$$

$$n 1 , n 3 , n 5 > n 2 = n 4 = n 6 = n 7 \qquad Condition 2$$

$$n 1 , n 5 > n 3 > n 2 , n 4 , n 6 , n 7 \qquad Condition 3$$

$$n 5 > n 1 , n 2 , n 3 , n 4 , n 6 , n 7 \qquad Condition 4$$

When comparing the Abbe numbers, the Abbe number of the third lens (103) may be the largest among the lenses and may be 60 or higher. The Abbe number of the fifth lens (105) may be the smallest among the lenses and may be 25 or lower. The difference between the maximum refractive index and the minimum Abbe number may be 40 or higher. By maximizing the Abbe number of the third lens (103) disposed at the center of the optical system (1000) and minimizing the Abbe number of the fifth lens (105) with a low refractive index adjacent to the image sensor (500), the colour dispersion of light passing through lenses made of glass and plastic materials can be controlled, and the color dispersion between lenses made of glass and plastic materials may be increased, enabling the light to be guided to the image sensor (500).

The Abbe number of each lens may satisfy any one of the following conditions.

$$v 2 , v 3 , v 4 , v 6 , v 7 > v 1 > v 5 \qquad Condition 1$$

$$v 3 > v 2 = v 4 = v 6 = v 7 > v 1 , v 5 \qquad Condition 2$$

$$v 3 > v 1 , v 2 , v 4 , v 5 , v 6 , v 7 \qquad Condition 3$$

$$v 1 , v 2 , v 3 , v 4 , v 6 , v 7 > v 5 \qquad Condition 4$$

The focal lengths (F1, F2, F5, F7) of lenses 1, 2, 5, and 7 (101, 102, 105, 107) may have a negative (−) sign. Lenses 1, 2, 5, and 7 (101, 102, 105, 107) may have negative (−) refractive power. The focal lengths (F3, F4, F6) of the third, fourth, and sixth lenses (103, 104, 106) may have a positive (+) sign. The third, fourth, and sixth lenses (103, 104, 106) may have positive (+) refractive power. The sensor side of the first lens (101) and the second lens (102), which have negative refractive power, may be disposed with the third lens (103), which has positive refractive power. Through this, light incident from the object side moves away from the optical axis direction and then converges toward the optical axis direction, thereby forming a stable optical path.

Additionally, the fourth lens (104) and fifth lens (105), which are adjacent to each other, can satisfy the following conditions.

Condition 1: Refractive index of a lens with positive refractive power<Refractive index of a lens with negative refractive power

Condition 2: Dispersion value of a lens with positive refractive power>Dispersion value of a lens with negative refractive power

Here, among the plastic lenses, the fourth lens (104) has positive refractive power, and the fifth lens (105) has negative refractive power. According to conditions 1 and 2, the refractive index of the fourth lens (104) is smaller than that of the fifth lens (105), the dispersion value of the fourth lens (104) is greater than that of the fifth lens (105). Chromatic aberration occurring in plastic lenses can be corrected using plastic lenses. Additionally, when the fourth lens (104) and the fifth lens (105), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using plastic lenses. Optical systems exhibit chromatic aberration, which is corrected using bonded lenses or two lenses disposed consecutively. As temperature changes from low to high, lenses repeatedly contract and expand. Since lenses made of the same material exhibit identical changes in lens characteristics due to temperature changes, correcting chromatic aberration between lenses of the same material is effective even when temperature changes. Therefore, in the first embodiment of the present invention, the fourth lens (104) and the fifth lens (105) can be used to correct chromatic aberration occurring in plastic lenses.

From the optical axis to the effective image area, the maximum distance between the two lenses with the largest Abbe number difference among the two adjacent lenses may be smaller than the maximum distance between other adjacent pairs of lenses. Here, the distance refers to the distance between the two lenses from the optical axis to the effective diameter area. The two lenses with the largest Abbe number difference among the two adjacent lenses may be the fourth lens (104) and the fifth lens (105). The maximum value of the distance from the optical axis to the effective diameter area in a direction perpendicular to the optical axis, between the sensor side surface 8th surface (S8) of the fourth lens (104) and the object side surface 9th surface (S9) of the fifth lens (105), may be smaller than the maximum value of the distance between any two adjacent lenses. This allows the distance between two lenses made of difficult-to-bond plastic materials to be designed to be small, maximizing the Abbe number difference, thereby achieving the effect of reducing chromatic aberration to the same level as that of bonded lenses even when the lenses are not bonded.

When comparing focal lengths as absolute values, the focal length of the first lens (101) may be the longest among the lenses and may be 50 or more and 60 or less. The focal length of the sixth lens (106) may be the shortest among the lenses, and the absolute value of the focal length of the seventh lens (106) may be 5 or more and 10 or less.

Since the first lens (101) has the largest focal length and the weakest refractive power among the lenses, the difference in the Abbe number between the second lens (102) and the third lens (103) disposed on the sensor side of the first lens (101) does not need to be large to achieve the effect of correcting chromatic aberration.

The absolute value of the focal length of each lens may satisfy any one of the following conditions.

$$\vert f 1 \vert > \vert f 2 \vert , \vert f 3 \vert , \vert f 4 \vert , \vert f 5 \vert , \vert f 6 \vert , \vert f 7 \vert \qquad Condition 1$$

$$\vert f 1 \vert > \vert f 2 \vert > \vert f 3 \vert , \vert f 4 \vert , \vert f 5 \vert , \vert f 6 \vert , \vert f 7 \vert \qquad Condition 2$$

$$\vert f 1 \vert , \vert f 2 \vert , \vert f 4 \vert > \vert f 3 \vert > \vert f 5 \vert , \vert f 6 \vert , \vert f 7 \vert \qquad Condition 3$$

$$\vert f 1 \vert , \vert f 2 \vert > \vert f 4 \vert > \vert f 3 \vert , \vert f 5 \vert , \vert f 6 \vert , \vert f 7 \vert \qquad Condition 4$$

$$\vert f 1 \vert , \vert f 2 \vert , \vert f 3 \vert , \vert f 4 \vert , \vert f 7 \vert > \vert f 5 \vert > \vert f 6 \vert \qquad Condition 5$$

$$\vert f 1 \vert , \vert f 2 \vert , \vert f 3 \vert , \vert f 4 \vert , \vert f 5 \vert , \vert f 7 \vert > \vert f 6 \vert \qquad Condition 6$$

$$\vert f 1 \vert , \vert f 2 \vert , \vert f 3 \vert , \vert f 4 \vert > \vert f 7 \vert > \vert f 5 \vert , \vert f 6 \vert \qquad Condition 7$$

The thickness (T1) of the first lens (101) may be within a range of 1.1 times or more, for example, 1.2 times to 1.5 times, of the difference between the maximum thickness and the minimum thickness, with the center thickness (CT1) being the minimum and the edge thickness (ET1) being the maximum. The thickness (T2) of the second lens (102) may range from 1 times to 1.5 times the minimum thickness. The second lens (102) may have a minimum center thickness (CT2) and a maximum edge thickness (ET2). The thickness (T3) of the third lens (103) may be minimum at the center and maximum at the edge, with the maximum thickness being within the range of 1 to 1.5 times the minimum thickness. The thickness (T4) of the fourth lens (104) may be maximum at the center and minimum at the edge, with the maximum thickness being within the range of 2 to 2.5 times the minimum thickness. The thickness (T5) of the fifth lens (105) may be minimum at the center and maximum at the edge, with the maximum thickness ranging from 1.2 to 1.7 times the minimum thickness. The thickness (T6) of the sixth lens (106) may be maximum at the center and minimum at the edge, with the maximum thickness ranging from 1.5 to 2 times the minimum thickness. The thickness (T7) of the seventh lens (107) may be minimum at the center and maximum at the edge, with the maximum thickness being within the range of 1 times to 1.5 times the minimum thickness.

The thickness of each lens may satisfy any one of the following conditions.

$$0.5 < CT 1 / ET 1 < 1 , 1 < ET 1 / CT 1 < 1.5 \qquad Condition 1$$

$$0.5 < CT 2 / ET 2 < 1 , 1 < ET 2 / CT 2 < 1.5 \qquad Condition 2$$

$$0.5 < CT 3 / ET 3 < 1 , 1 < ET 3 / CT 3 < 1.5 \qquad Condition 3$$

$$2 < CT 4 / ET 4 < 2.5 , 0.1 < ET 4 / CT 4 < 0.5 \qquad Condition 4$$

$$0.5 < CT 5 / ET 5 < 1 , 1.2 < ET 5 / CT 5 < 1.7 \qquad Condition 5$$

$$1.2 < CT 6 / ET 6 < 1.7 , 0.5 < ET 6 / CT 6 < 1 \qquad Condition 6$$

$$0.5 < CT 7 / ET 7 < 1 , 1 < ET 7 / CT 7 < 1.5 \qquad Condition 7$$

$$1 < \sum CT / \sum ET < 1.2 , 0 \text{.5} < \sum ET / \sum CT < 1 \qquad Condition 8$$

Among the gaps (G1-G7) between the lenses, the first gap (G1) between the first and second lenses (101, 102) may have a maximum at the center and a minimum at the edge. The second gap (G2) between the second and third lenses (102, 103) may have a minimum at the center and a maximum at the edge. The third gap (G3) between the third and fourth lenses (103, 104) may have the maximum value at the edge and the minimum value at the center. The fourth gap (G4) between the fourth and fifth lenses (104, 105) may have the minimum value at the center and the maximum value at the edge. The fifth gap (G5) between the fifth and sixth lenses (105, 106) may have the center portion at its maximum and the edge portion at its minimum. The sixth gap (G6) between the sixth and seventh lenses (106, 107) may have the center portion at its minimum and the edge portion at its maximum.

FIGS. 6, 8, and 10 are graphs showing the diffraction MTF (modulation transfer function) at room temperature, low temperature, and high temperature in the optical system of FIG. 1, respectively. These graphs represent the modulation (luminance ratio) as a function of spatial frequency.

As shown in FIGS. 6, 8, and 10, in the first embodiment of the invention, the deviation of the MTF between room temperature and low or high temperatures may be less than 10%, i.e., 7% or less. FIGS. 7, 9, and 11 are graphs showing the aberration characteristics at room temperature, low temperature, and high temperature in the optical system of FIG. 1.

The aberration graphs in FIGS. 7, 9, and 11 show the measured values of spherical aberration (Longitudinal Spherical Aberration), astigmatic field curves (Astigmatic Field Curves), and distortion (Distortion) from left to right. In FIGS. 7, 9, and 11, the X-axis represents the focal length (mm) and distortion percentage, while the Y-axis denotes the image height. Additionally, the graph for spherical aberration corresponds to light in the wavelength bands of approximately 435 nm, 486 nm, 546 nm, 587 nm, and 656 nm, while the graphs for astigmatic field curves and distortion correspond to light in the wavelength band of approximately 546 nm. In the aberration diagrams of FIGS. 7, 9, and 11, the closer the curves at room temperature, low temperature, and high temperature are to the Y-axis, the better the aberration correction function is interpreted to be. The optical system (1000) according to the first embodiment shows that the measured values are adjacent to the Y-axis in almost all regions.

In other words, the optical system (1000) according to the first embodiment has improved resolution and can provide good optical performance not only in the center of the field of view (FOV) but also in the peripheral region. Here, low temperature may refer to −20° C. or lower, for example, −20° C. to −40° C., room temperature may refer to 22° C.±5° C. or 18° C. to 27° C., and high temperature may refer to 85° C. or higher, for example, 85° C. to 105° C.

As a result, as shown in FIGS. 7, 9, and 11, it can be seen that the reduction in brightness modulation from low temperature to high temperature is less than 10%, for example, 5% or less, or remains almost unchanged. Table 3 compares changes in optical characteristics such as EFL, BFL, F-number (F #), TTL, and field of view (FOV_D) in the optical system according to the first embodiment. It can be seen that the change rate of optical characteristics at low temperatures relative to room temperature is 5% or less, for example, 3% or less, and the change rate of optical characteristics at low temperatures relative to room temperature is 5% or less, for example, 3% or less.

TABLE 3

| | | | | low | high |
|---|---|---|---|---|---|
| | | | | temper- | temper- |
| | | | | ature/ | ature/ |
| | Room | low | high | Room | Room |
| | temper- | temper- | temper- | temper- | temper- |
| | ature | ature | ature | ature | ature |
| EFL(F) | 10.88 | 10.79 | 10.99 | 99.17% | 101.01% |
| BFL | 3.42 | 3.41 | 3.42 | 99.70% | 100.00% |
| F# | 1.64 | 1.63 | 1.66 | 99.39% | 101.21% |
| TTL | 29.99 | 29.92 | 30.08 | 99.76% | 100.30% |
| FOV_D | 54.69 | 55.19 | 54.10 | 100.91% | 98.92% |

Therefore, as shown in Table 3, it can be seen that the changes in optical characteristics due to temperature changes from low to high temperatures, such as the change rate of the effective focal length (EFL), TTL, BFL, F number, and field of view (FOV_D), are 10% or less, i.e., 5% or less, for example, within the range of 0 to 5%. This design allows for temperature compensation for plastic lenses, even when using one or more plastic lenses, thereby inhibiting a decrease in the reliability of optical characteristics.

The optical system disclosed in the first embodiment can effectively control aberration characteristics such as chromatic aberration and distortion aberration, and achieve good optical performance not only in the central part but also in the peripheral part of the field of view (FOV).

The optical system according to the second embodiment of the invention will now be described.

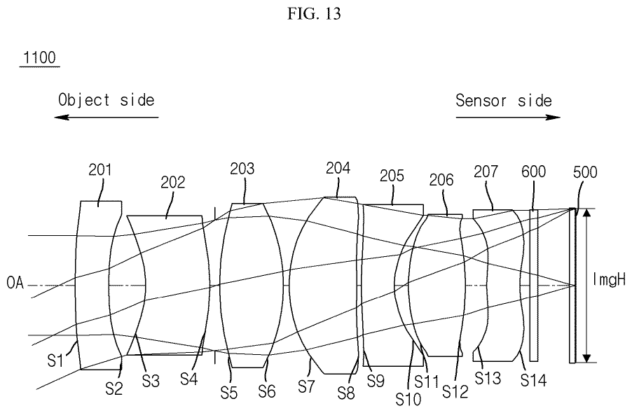

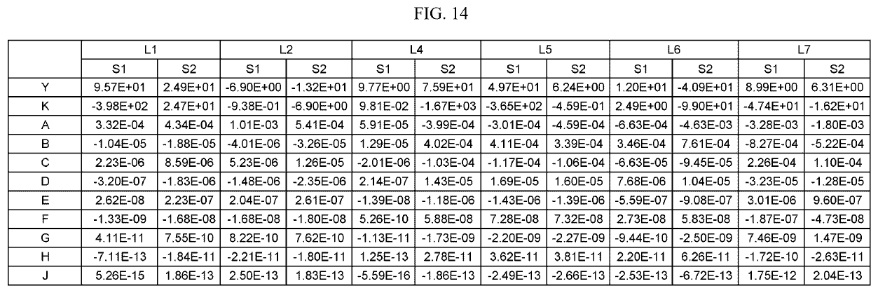

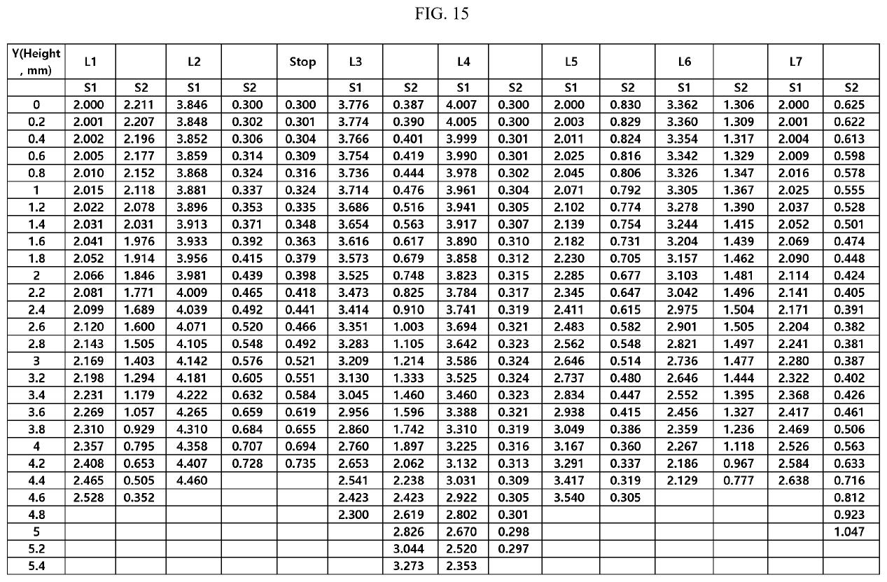

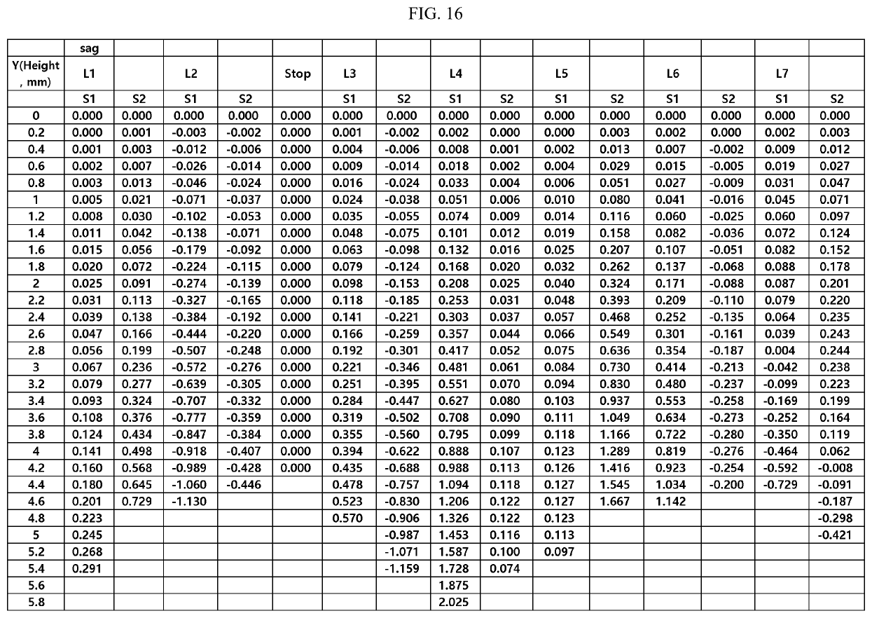

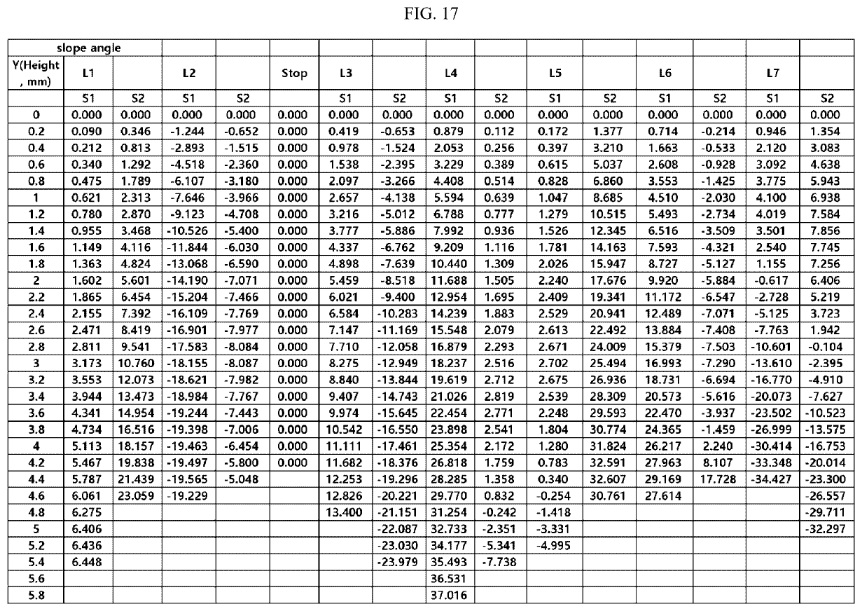

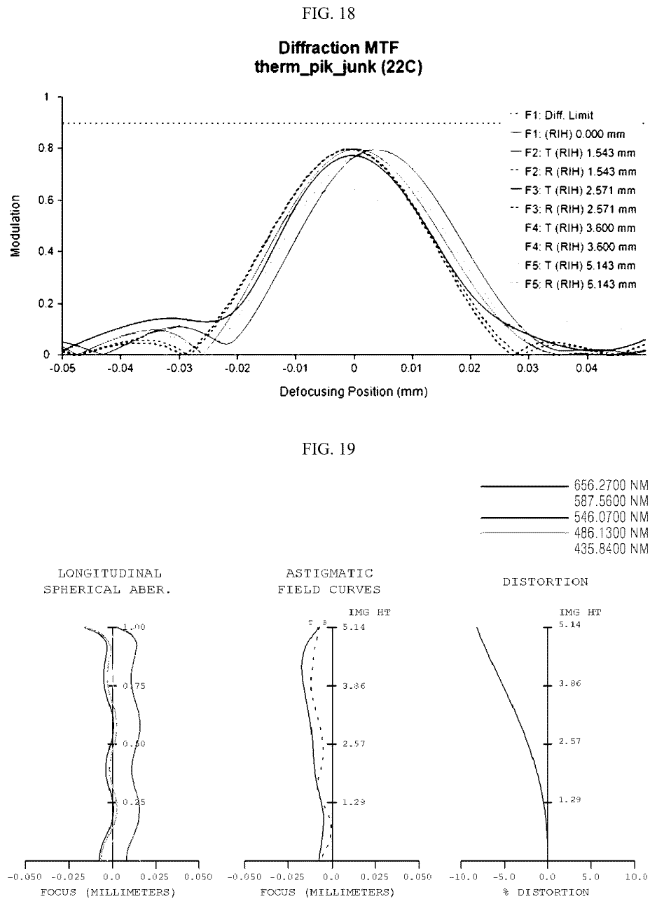

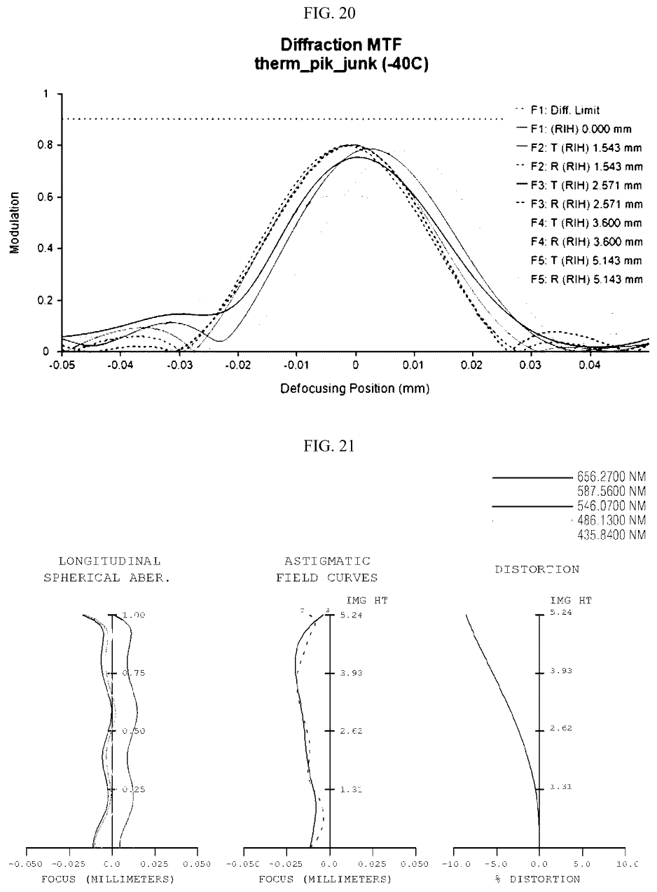

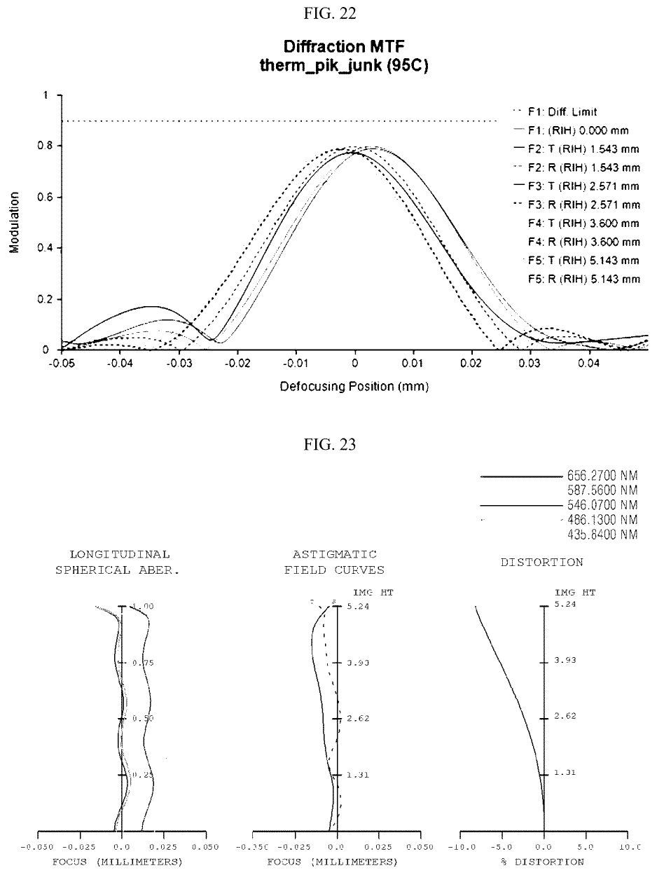

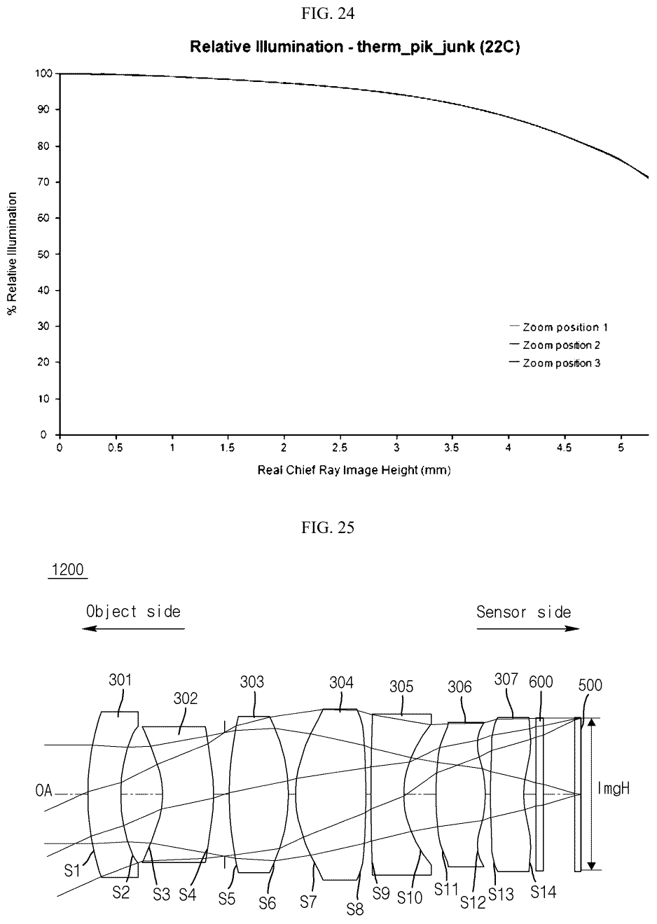

FIG. 13 is a side cross-sectional view of an optical system and a camera module including the same according to a second embodiment, FIG. 14 is a table showing the aspheric coefficients of the lenses in the optical system of FIG. 13, FIG. 15 is a table showing the thickness of each lens in the optical system of FIG. 13 and the gap between adjacent lenses, FIG. 16 is a table showing the Sag values of the lens surfaces of the first to seventh lenses in the optical system of FIG. 13, FIG. 17 is a table showing slope angles of the lens surfaces of the first to seventh lenses in the optical system of FIG. 13, FIG. 18 is a graph showing data on the diffraction MTF (Modulation Transfer Function) at room temperature for the optical system shown in FIG. 13, FIG. 19 is a graph showing data on the aberration characteristics at room temperature for the optical system shown in FIG. 13, FIG. 20 is a graph showing data on the diffraction MTF at low temperatures for the optical system shown in FIG. 13, FIG. 21 is a graph showing the aberration characteristics of the optical system shown in FIG. 13 at low temperatures, FIG. 22 is a graph showing the diffraction MTF of the optical system shown in FIG. 13 at high temperatures, FIG. 23 is a graph showing the aberration characteristics of the optical system shown in FIG. 13 at high temperatures, and FIG. 24 is a graph showing the peripheral light intensity ratio of the optical system shown in FIG. 13.

Referring to FIG. 13, the optical system (1100) may include a lens unit, which may include a first lens (201) to a seventh lens (207). The first to seventh lenses (201 to 207) may be sequentially disposed along the optical axis (OA) of the optical system (1100). Light corresponding to information of an object may pass through the first lens (201) to the seventh lens (207) and the filter (600) and enter the image sensor (500).

The first lens (201) may be disposed closest to the object side. The first lens (201) may be disposed farthest from the sensor side. The first lens (201) may have a negative (−) refractive power relative to the optical axis (OA). The first lens (201) may include a plastic material or a glass material, for example, it may be made of glass. The first lens (201) made of glass may reduce changes in the center position and curvature radius due to temperature changes caused by the surrounding environment, and may protect the incident side surface of the optical system (1100).

Based on the optical axis, the object-side first surface (S1) of the first lens (201) may be convex, and the sensor-side second surface (S2) may be concave. The first lens (201) may have a convex meniscus shape on the object side. The first lens (201) may have a concave meniscus shape on the sensor side. The first lens (201) may be made of glass material and may have an aspherical surface. At least one or both of the first surface (S1) and the second surface (S2) may be aspherical. The aspherical coefficients of the first and second surfaces (S1, S2) may be provided as S1 and S2 of L3 in FIG. 14. At least one or both of the first surface (S1) and the second surface (S2) may be provided without a critical point from the optical axis (OA) to the end of the effective area.

Due to the refractive characteristics of the first lens (201), the second lens (202) may be spaced further apart from the first lens (201). That is, the center gap between the first and second lenses (201, 202) may be the largest within the lens unit.

The refractive index (n1) of the first lens (201) may satisfy the condition n1>1.6 or n1>1.62. When the refractive index (n1) of the first lens (201) satisfies the above condition, the curvature radius of the first and second lenses (201, 202) can increase, making lens manufacturing easier. If the refractive index (n1) of the first lens (201) is smaller than the condition, the refractive power of the first and second lenses (201, 202) must be increased by forming the lens surface sharply concave or convex, which makes lens manufacturing difficult, increases the defect rate, and may cause a decrease in yield.

The second lens (202) may be disposed second from the object side. The second lens (202) may be disposed sixth from the sensor side. The second lens (202) may be disposed between the first lens (201) and the third lens (203). The second lens (202) may have a negative (−) refractive power on the optical axis (OA). The second lens (202) may include a plastic or glass material. For example, the second lens (202) may be provided in a plastic material.

Based on the optical axis (OA), the object-side third surface (S3) of the second lens (202) may be concave, and the sensor-side fourth surface (S4) may be convex. The second lens (202) may have a convex meniscus shape toward the sensor side. The second lens (202) may have a concave meniscus shape on the object side. The second lens (202) may be made of plastic material and may be aspherical. At least one or both of the third surface (S3) and the fourth surface (S4) may be aspherical. The aspheric coefficients of the third and fourth surfaces (S3, S4) may be provided as S1 and S2 of L2 in FIG. 14. At least one or both of the third surface (S3) and the fourth surface (S4) may be provided without a critical point from the optical axis (OA) to the end of the effective area.

An aperture (Stop) may be disposed around the perimeter of the sensor side fourth surface (S4) of the second lens (202). The aperture (Stop) may be disposed around the perimeter of the object side fifth surface (S5) of the third lens (203). The aperture can reduce the TTL within the field of view and enable the miniaturization of the optical system. As a result, it is possible to inhibit a decrease in the weight-based yield (yield by weight) of the optical system and improve production efficiency. Additionally, the optical system can be miniaturized by reducing the TTL within a horizontal field of view (FOV_H) of 40 to 50 degrees.

The third lens (203) may be disposed as the third lens on the object side. The third lens (203) may be disposed as the fifth lens from the sensor side. The third lens (203) may be disposed between the second lens (202) and the fourth lens (204). The third lens (203) may have a positive (+) refractive power along the optical axis (OA).

The third lens (203) may include a plastic or glass material. For example, the third lens (203) may be provided in a glass material. With respect to the optical axis (OA), the object-side fifth surface (S5) of the third lens (203) may be convex, and the sensor-side sixth surface (S6) may be convex.

The third lens (203) may have a shape where both surfaces are convex. The third lens (203) may be made of glass material and may be spherical. At least one or both of the fifth surface (S5) and the sixth surface (S6) may be provided without a critical point from the optical axis (OA) to the end of the effective area.

The fourth lens (204) may be disposed fourth from the object side. The fourth lens (204) may be disposed fourth from the sensor side. The fourth lens (204) may be disposed between the third lens (203) and the fifth lens (205). The fourth lens (204) may have a positive (+) or negative (−) refractive power on the optical axis (OA). The fourth lens (204) may have a positive (+) refractive power. The fourth lens (204) may include a plastic or glass material. For example, the fourth lens (204) may be provided in a plastic material.

Based on the optical axis, the object-side seventh surface (S7) of the fourth lens (204) may be convex, and the sensor-side eighth surface (S8) may be concave. The fourth lens (204) may have a convex meniscus shape on the object side. The fourth lens (204) may have a concave meniscus shape on the sensor side. The fourth lens (204) may be made of plastic material and may be aspherical. At least one or both of the seventh surface (S7) and the eighth surface (S8) may be aspherical. The asphericity coefficients of the seventh and eighth surfaces (S7, S8) may be provided as S1 and S2 of L4 in FIG. 14. At least one or both of the seventh surface (S7) and the eighth surface (S8) may be provided without a critical point from the optical axis (OA) to the end of the effective area.

The fifth lens (205) may be disposed as the fifth lens from the object side. The fifth lens (205) may be disposed as the third lens from the sensor side. The fifth lens (205) may be disposed between the fourth lens (204) and the sixth lens (206). The fifth lens (205) may have a positive (+) or negative (−) refractive power along the optical axis (OA). The fifth lens (205) may have a negative (−) refractive power. The fifth lens (205) may include a plastic or glass material. For example, the fifth lens (205) may be provided in a plastic material.

With respect to the optical axis (OA), the fifth lens (205) may have an object side convex ninth surface (S9) and a sensor side concave tenth surface (S10). The fifth lens (205) may have a convex meniscus shape on the object side. The fifth lens (205) may have a concave meniscus shape on the sensor side. The fifth lens (205) may be made of plastic material and may be aspherical. At least one or both of the ninth surface (S9) and the tenth surface (S10) may be aspherical. The asphericity coefficients of the ninth and tenth surfaces (S9, S10) may be provided as S1 and S2 of L5 in FIG. 14. At least one or both of the ninth surface (S9) and the tenth surface (S10) may be provided without a critical point from the optical axis (OA) to the end of the effective area.

The sixth lens (206) may be disposed as the sixth lens from the object side. The sixth lens (206) may be disposed as the second lens from the sensor side. The sixth lens (206) may be disposed between the fifth lens (205) and the seventh lens (207). The sixth lens (206) may have a positive (+) or negative (−) refractive power relative to the optical axis (OA). The sixth lens (206) may have a positive (+) refractive power. The sixth lens (206) may include a plastic or glass material. For example, the sixth lens (206) may be provided in a plastic material.

With respect to the optical axis (OA), the sixth lens (206) may have an object side convex 11th surface (S11) and a sensor side convex 12th surface (S12). The sixth lens (206) may have a shape with both surfaces being convex. The sixth lens (206) may be made of plastic material and may be aspherical. At least one or both of the eleventh surface (S11) and twelfth surface (S12) may be aspherical. The asphericity coefficient of the eleventh and twelfth surfaces (S11, S12) may be provided as S1 and S2 of L6 in FIG. 14.

The 11th surface (S11) of the 6th lens (106) may be provided without a critical point from the optical axis (OA) to the end of the effective area. The 12th surface (S12) of the 6th lens (106) may include a critical point from the optical axis (OA) to the end of the effective area. When the 12th surface (S12) has a critical point, it may be located within the range of 85% to 90% of the effective radius (r62) from the optical axis (OA), preferably within the range of 86% to 89%. The critical point of the 12th surface (S12) may be located within a range of 3.5 mm to 4 mm from the optical axis (OA), preferably within a range of 3.8 mm to 3.9 mm.

The seventh lens (207) may be disposed farthest from the object side. The seventh lens (207) may be disposed closest to the image sensor (500). The seventh lens (207) may have a positive (+) or negative (−) refractive power relative to the optical axis (OA). The seventh lens (207) may have a negative (−) refractive power. The seventh lens (207) may include a plastic or glass material. For example, the seventh lens (207) may be provided in a plastic material.

Based on the optical axis (OA), the seventh lens (207) may have a convex object side 13th surface (S13) and a sensor side concave 14th surface (S14). The seventh lens (207) may have a convex meniscus shape on the object side. The seventh lens (207) may have a concave meniscus shape on the sensor side. At least one or both of the 13th surface (S13) and the 14th surface (S14) may be aspherical. The asphericity coefficient of the 13th and 14th surfaces (S13, S14) may be provided by the S13 and S14 of L7 in FIG. 14.

The 13th surface (S13) of the 7th lens (207) may include a critical point extending from the optical axis (OA) to the end of the effective area. If the 13th surface (S13) has a critical point, it may be located within the range of 40% to 50% of the effective radius (r71) from the optical axis (OA), preferably within the range of 44% to 47%. The critical point of the 13th surface (S13) may be located within a range of 1.8 mm to 2.2 mm from the optical axis (OA), preferably within a range of 1.9 mm to 2 mm. The 14th surface (S14) of the 7th lens (207) may include a critical point extending from the optical axis (OA) to the end of the effective area. If the 14th surface (S14) has a critical point, it may be located within the range of 50% to 60% of the effective radius (r72) from the optical axis (OA), preferably within the range of 54% to 56%. The critical point of the 14th surface (S14) may be located within a range of 2.5 mm to 3 mm from the optical axis (OA), preferably within a range of 2.7 mm to 2.8 mm.

The seventh lens (207) may be the plastic lens closest to the image sensor (500). Furthermore, by arranging two or more plastic lenses adjacent to the image sensor (500), it is possible to improve aberrations such as spherical aberration and chromatic aberration caused by the lens surface having an aspherical shape, and to control the resolution. Furthermore, by arranging a plastic lens as the lens adjacent to the image sensor (500), it is possible to be less sensitive to assembly tolerances compared to glass lenses. In other words, being less sensitive to assembly tolerances means that even if the assembly differs slightly from the design during assembly, it may not significantly affect optical performance. Furthermore, by providing the two lenses (206, 207) adjacent to the image sensor (500) in a plastic material, the optical performance can be improved by the aspherical lens surfaces, for example, by improving aberration characteristics and inhibiting resolution degradation.

TABLE 4

| | | | | | | Semi | Focal |
|---|---|---|---|---|---|---|---|
| Lens | Surface | Radius | Thickness | nd | vd | Aperture | length |
| 1 | S1 | 95.704 | 2.000 | 1.6413 | 55.1788 | 5.583 | −52.9632 |
| | S2 | 24.865 | 2.211 | | | 4.713 | |
| 2 | S3 | −6.903 | 3.846 | 1.5371 | 55.7074 | 4.634 | −34.4158 |
| | S4 | −13.162 | 0.300 | | | 4.429 | |
| STOP | — | — | 0.300 | | | 4.317 | |
| 3 | S5 | 20.497 | 3.776 | 1.6223 | 63.8790 | 4.975 | 13.4607 |
| | S6 | −13.164 | 0.387 | | | 5.451 | |
| 4 | S7 | 9.775 | 4.007 | 1.5371 | 55.7074 | 5.864 | 20.4567 |
| | S8 | 75.895 | 0.300 | | | 5.498 | |
| 5 | S9 | 49.725 | 2.000 | 1.6640 | 21.2131 | 5.376 | −10.9438 |
| | S10 | 6.238 | 0.830 | | | 4.688 | |
| 6 | S11 | 12.027 | 3.362 | 1.5371 | 55.7074 | 4.696 | 17.6987 |
| | S12 | −40.922 | 1.306 | | | 4.457 | |
| 7 | S13 | 8.989 | 2.000 | 1.5371 | 55.7074 | 4.490 | −53.3287 |
| | S14 | 6.310 | 0.625 | | | 5.050 | |
| Filter | | infinity | 0.440 | | | | |
| | | | 1.936 | | | | |
| Cover | | infinity | 0.330 | | | | |
| | | | 0.044 | | | | |
| Image | | infinity | 0.000 | | | | |

Table 4 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the second embodiment of the present invention. Here, the units for curvature radius and thickness or distance may be mm.

TABLE 5

| items | values | items | values |
|---|---|---|---|
| F | 10.8634 | F-number | 1.6400 |
| ET1 | 2.4636 | FOV_H | 46.00 |
| ET2 | 4.5362 | EPD | 6.6241 |
| ET3 | 2.0000 | BFL | 3.3752 |
| ET4 | 2.0000 | TD | 26.6249 |
| ET5 | 3.6250 | ImgH | 5.1450 |
| ET6 | 2.0000 | SD | 18.2679 |
| ET7 | 2.3358 | TTL | 30.0000 |
| ΣIndex | 11.0760 | GLca_Aver | 10.361 |
| ΣAbbe | 363.1005 | PLca_Aver | 9.836 |
| ΣCT | 20.9912 | CT_max | 4.0066 |
| ΣCG | 5.6336 | CT_min | 2.0000 |
| CA_max | 11.727 | CT_Aver | 2.9987 |
| CA_min | 8.634 | F_LG1 | −21.283 |
| CA_Aver | 9.896 | F_LG2 | 8.866 |

Table 5 shows the values of the items in the mathematical equations described above for the optical system (1100) of the embodiment. The optical system (1100) may include the total track length (TTL) (mm), back focal length (BFL), effective focal length (F) (mm), image height (ImgH) (mm), effective diameter (CA) (mm), thickness (mm), TTL (mm), the optical axis distance from the first surface (S1) to the twelfth surface (S12) (TD (mm)), the sum of refractive indices, the sum of Abbe numbers, the sum of thicknesses (mm), the sum of distances between adjacent lenses, the effective diameter characteristics, the sum of refractive indices of glass lenses, the sum of refractive indices of plastic materials, the field of view (FOV_H) (degrees), edge thickness (ET), F-number, etc.

The center thickness of the first to seventh lenses (201 to 207) is indicated as CT1 to CT7, the edge thickness at the end of the effective area of each lens is indicated as ET1 to ET7, and the center gap between adjacent lenses is indicated as CG1 to CG6. and the edge gap between the edges of each lens is denoted as EG1 to EG6. BFL (Back focal length) is the optical axis distance from the image sensor (500) to the center of the last lens. TTL is the optical axis distance from the center of the first surface (S1) of the first lens (201) to the image surface of the image sensor (500).

As shown in FIG. 14, the lens surfaces of the first, second, fourth, fifth, sixth, and seventh lenses (201, 202, 204, 205, 206, 207) in the lens unit of the second embodiment may include aspherical surfaces with a 30th-order asphericity coefficient. For example, the first, second, fourth, fifth, sixth, and seventh lenses (201, 202, 204, 205, 206, 207) may include lens surfaces having a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV).

The thickness (T1-T7) of the first to seventh lenses (201-207) and the gap (G1-G6) between adjacent lenses may be set. As shown in FIG. 3, the thickness (T1-T7) of each lens in the Y-axis direction may be displayed at gaps of 0.1 mm or 0.2 mm or more, and the gap (G1-G6) between each lens may be displayed at gaps of 0.1 mm or 0.2 mm or more. When comparing the absolute values of the curvature radii of each lens, the curvature radius of the first surface (S1) of the first lens (201) on the optical axis (OA) may be the largest among the lenses, and the curvature radius of the tenth surface (S10) of the fifth lens (205) may be the smallest among the lenses. The difference between the maximum and minimum curvature radii may be three times or more, for example, within the range of three to five times. Among the object-side and sensor-side surfaces of the first to seventh lenses (201-207), the number of lens surfaces with a curvature radius greater than 40 may be one or more but no more than four. This allows the curvature radii of the lenses constituting the optical system (1100) to be designed to be mostly small, thereby satisfying the field of view, focal length, and overall length of the lenses when they are mounted in a vehicle. Since the effective diameter of a plastic lens is smaller than that of a glass lens, the lens disposed on the object side of a plastic lens may have a stronger refractive power to refract light through the plastic lens. Additionally, to increase the refractive power, the curvature radius of the lens surface may be smaller. The absolute value of the curvature radius of the first surface (S1) of the first lens (201) may be larger than the absolute value of the curvature radius of the second surface (S2). The absolute value of the curvature radius of the third surface (S3) of the second lens (202) may be smaller than the absolute value of the curvature radius of the fourth surface (S4). The absolute value of the curvature radius of the fifth surface (S5) of the third lens (203) may be greater than the absolute value of the curvature radius of the sixth surface (S6). The absolute value of the curvature radius of the seventh surface (S7) of the fourth lens (204) may be smaller than the absolute value of the curvature radius of the eighth surface (S8). The absolute value of the curvature radius of the ninth surface (S9) of the fifth lens (205) may be greater than the absolute value of the curvature radius of the tenth surface (S10). The absolute value of the curvature radius of the eleventh surface (S11) of the sixth lens (206) may be less than the absolute value of the curvature radius of the twelfth surface (S12). The absolute value of the curvature radius of the 13th surface (S13) of the 7th lens (207) may be greater than the absolute value of the curvature radius of the 14th surface (S14).

The ratio of the curvature radii of each lens may satisfy the following condition.

$$3 < L 1 R 1 / L 1 R \vert < 4 \qquad Condition 1$$

$$0.5 < \vert L 2 R 1 / L 2 R 2 \vert < 1 \qquad Condition 2$$

$$1.5 < \vert L 3 R 1 / L 3 R 2 \vert < 2 \qquad Condition 3$$

$$0.1 < \vert L 4 R 1 / L 4 R 2 \vert < 0.5 \qquad Condition 4$$

$$5 < \vert L 5 R 1 / L 5 R 2 \vert < 10 \qquad Condition 5$$

$$0.1 < \vert L 6 R 1 / L 6 R 2 \vert < 0.5 \qquad Condition 6$$

$$1 < \vert L 7 R 1 / L 7 R 2 \vert < 1.5 \qquad Condition 7$$

When describing the center thickness (CT) of the lenses based on the optical axis, the center thickness (CT4) of the fourth lens (204) may be the maximum among the lenses, and the center thickness (CT1, CT5, CT7) of at least one of the first lens (201), fifth lens (205) and seventh lens (207) may be the minimum among the lenses. The difference between the maximum and minimum center thicknesses of the lenses may be within the range of 2 mm or more and 2.5 mm or less.

The center thickness of each lens may satisfy any one of the following conditions.

$$CT 2 , CT 3 , CT 4 , CT 6 > CT 1 = CT 5 = CT 7 \qquad Condition 1$$

$$CT 4 > CT 2 > CT 1 , CT 3 , CT 5 , CT 6 , CT 7 \qquad Condition 2$$

$$CT 2 , CT 4 > CT 3 > CT 1 , CT 5 , CT 6 , CT 7 \qquad Condition 3$$

$$CT 4 > CT 1 , CT 2 , CT 3 , CT 6 , CT 7 \qquad Condition 4$$

$$CT 2 , CT 3 , CT 4 > CT 6 > CT 1 , CT 5 , CT 7 \qquad Condition 5$$

The center gap (CG) between the lenses is explained as follows: the center gap (CG1) between the first lens (201) and the second lens (202) may be the maximum, and the center gap (CG4) between the fourth and fifth lenses (204, 205) may be the minimum. The difference between the maximum and minimum center gaps among the spaced-out lenses may be 3 mm or more, for example, within the range of 3 mm to 4 mm.

The center gap between each lens may satisfy the following conditions.

$$CG 1 > CG 2 , CG 3 , CG 4 , CG 5 , CG 6 \qquad Condition 1$$

$$CG 1 , CG 5 , CG 6 > CG 2 > CG 3 , CG 4 \qquad Condition 2$$

$$CG 1 , CG 2 , CG 5 , CG 6 > CG 3 > CG 4 \qquad Condition 3$$

$$CG 1 , CG 2 , CG 3 , CG 5 , CG 6 > CG 4 \qquad Condition 4$$

$$CG 1 , CG 6 > CG 5 > CG 2 , CG 3 , CG 4 \qquad Condition 5$$

$$CG 1 > CG 6 > CG 2 , CG 3 , CG 4 , CG 5 \qquad Condition 6$$

Regarding the effective diameter, a lens with the maximum effective diameter may be a lens made of glass material. The lens with the maximum effective diameter may be the fourth lens (204). Here, the effective diameter is an average of the effective diameter on the object side surface and the effective diameter on the sensor side surface of each lens. The lens surface with the maximum effective diameter may be the seventh surface (S7) of the fourth lens (204). The lens with the minimum effective diameter may be the second lens (202). The lens surface with the minimum effective diameter may be the fourth surface (S4) of the second lens (202). The effective diameter of a plastic lens may be smaller than that of a glass lens. A plastic lens may be disposed adjacent to the image sensor.

The effective diameter of each lens may satisfy any one of the following conditions.

$$CA\_L3 , CA\_L4 > CA\_L1 > CA\_L2 , CA\_L5 > CA\_L6 , CA\_L7 \qquad Condition 1$$

$$CA\_L1 , CA\_L3 , CA\_L4 , CA\_L5 , CA\_L6 , CA\_L7 > CA\_L2 \qquad Condition 2$$

$$CA\_L4 > CA\_L3 > CA\_L1 , CA\_L2 , CA\_L5 , CA\_L6 , CA\_L7 \qquad Condition 3$$

$$CA\_L4 > CA\_L1 , CA\_L2 , CA\_L3 , CA\_L5 , CA\_L6 , CA\_L7 \qquad Condition 4$$

$$CA\_L1 , CA\_L3 , CA\_L4 > CA\_L5 > CA\_L2 , CA\_L6 , CA\_L7 \qquad Condition 5$$

$$CA\_L1 , CA\_L3 , CA\_L4 , CA\_L5 , CA\_L7 > CA\_L6 > CA\_L2 \qquad Condition 6$$

$$CA\_L1 , CA\_L3 , CA\_L4 , CA\_L5 > CA\_L7 > CA\_L2 , CA\_L6 \qquad Condition 7$$

Regarding the refractive index, the refractive index of the fifth lens (205) may be the highest among the lenses, exceeding 1.6, for example, exceeding 1.65. The second lens (202), the fourth lens (204), the sixth lens (206), and the seventh lens (207) may have the lowest refractive index among the lenses, either individually or collectively. For example, the refractive indices of the second lens (202), the sixth lens (206), and the seventh lens (108) may be the lowest among the lenses, less than 1.6, such as less than 1.55. The difference between the maximum refractive index and the minimum refractive index may be 0.2 or more. By providing the lens made of glass material with the highest refractive index closest to the object, and providing the lens adjacent to the glass material lens and the lens adjacent to the image sensor (500) with a lens made of plastic material with a low refractive index, the incident efficiency can be increased, and the refractive force between the lenses made of glass material and plastic material can be controlled to guide the light to the image sensor (500).

The refractive index of each lens may satisfy any one of the following conditions.

$$n 5 > n 1 > n 2 , n 3 , n 4 , n 6 , n 7 \qquad Condition 1$$

$$n 1 , n 3 , n 5 > n 2 = n 4 = n 6 = n 7 \qquad Condition 2$$

$$n 1 , n 5 > n 3 > n 2 , n 4 , n 6 , n 7 \qquad Condition 3$$

$$n 5 > n 1 , n 2 , n 3 , n 4 , n 6 , n 7 \qquad Condition 4$$

When comparing the Abbe numbers, the Abbe number of the third lens (203) may be the largest among the lenses and may be 60 or higher. The Abbe number of the fifth lens (205) may be the smallest among the lenses and may be 25 or lower. The difference between the maximum refractive index and the minimum Abbe number may be 40 or higher. By maximizing the Abbe number of the third lens (203) disposed at the central part of the optical system (1100) and minimizing the Abbe number of the fifth lens (205) with a low refractive index adjacent to the image sensor (500), the color dispersion of light passing through lenses made of glass and plastic materials can be controlled, and the color dispersion between lenses made of glass and plastic materials can be increased, enabling the light to be guided to the image sensor (500).

The Abbe number of each lens may satisfy any one of the following conditions.

$$v 2 , v 3 , v 4 , v 6 , v 7 > v 1 > v 5 \qquad Condition 1$$

$$v 3 > v 2 = v 4 = v 6 = v 7 > v 1 , v 5 \qquad Condition 2$$

$$v 3 > v 1 , v 2 , v 4 , v 5 , v 6 , v 7 \qquad Condition 3$$

$$v 1 , v 2 , v 3 , v 4 , v 6 , v 7 > v 5 \qquad Condition 4$$

The focal lengths (F1, F2, F5, F7) of the first, second, fifth, and seventh lenses (201, 202, 205, 207) may have a negative (−) sign. The first, second, fifth, and seventh lenses (201, 202, 205, 207) may have negative (−) refractive power. The focal lengths (F3, F4, F6) of the third, fourth, and sixth lenses (203, 204, 206) may have a positive (+) sign. The third, fourth, and sixth lenses (203, 204, 206) may have positive (+) refractive power. The sensor side of the first lens (201) and the second lens (202), which have negative (+) refractive power, may be disposed with the third lens (203), which has positive (+) refractive power. Through this, light incident from the object side may move away from the optical axis direction and then converge toward the optical axis direction, thereby forming a stable optical path.

Additionally, the fourth lens (204) and fifth lens (205), which are adjacent to each other, may satisfy the following conditions.

Condition 1: Refractive index of a lens with positive refractive power<Refractive index of a lens with negative refractive power

Condition 2: Dispersion value of a lens with positive refractive power>Dispersion value of a lens with negative refractive power

Here, among the plastic lenses, the fourth lens (204) has positive refractive power, and the fifth lens (205) has negative refractive power. According to conditions 1 and 2, the refractive index of the fourth lens (204) may be smaller than that of the fifth lens (205), the dispersion value of the fourth lens (204) may be greater than that of the fifth lens (205). Chromatic aberration occurring in plastic lenses can be corrected using plastic lenses. Additionally, when the fourth lens (204) and the fifth lens (205), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using the plastic lenses.

Optical systems exhibit chromatic aberration, which is corrected using bonded lenses or two lenses disposed consecutively. As temperature changes from low to high, lenses repeatedly contract and expand. Lenses made of the same material exhibit identical changes in lens characteristics due to temperature changes, so correcting chromatic aberration between lenses of the same material is effective even when temperature changes. Therefore, in the second embodiment of the present invention, chromatic aberration occurring in plastic lenses can be corrected using the fourth lens (204) and the fifth lens (205).

From the optical axis to the effective aperture area, the maximum distance between the two adjacent lenses with the largest Abbe number difference may be smaller than the maximum distance between other adjacent lenses. Here, the distance refers to the distance between the two lenses from the optical axis to the effective diameter area. The two lenses with the largest Abbe number difference among the two adjacent lenses may be the fourth lens (204) and the fifth lens (205). The maximum value of the distance from the optical axis to the effective diameter area in a direction perpendicular to the optical axis, between the sensor side surface 8th surface (S8) of the fourth lens (204) and the object side surface 9th surface (S9) of the fifth lens (205), may be smaller than the maximum value of the distance between any two adjacent lenses. This allows for a smaller distance between two lenses made of difficult-to-bond plastic materials, maximizing the Abbe number difference, and achieving the effect of same chromatic aberration reduction as bonded lenses even when the lenses are not bonded.

When comparing focal lengths as absolute values, the focal length of the seventh lens (207) may be the longest among the lenses and may be between 50 and 60. The focal length of the fifth lens (205) may be the shortest among the lenses, and the absolute value of the focal length of the seventh lens (205) may be between 8 and 12.

The absolute value of each lens's focal length may satisfy any one of the following conditions.

$$\vert f 7 \vert > \vert f 1 \vert > \vert f 2 \vert , \vert f 3 \vert , \vert f 4 \vert , \vert f 5 \vert , \vert f 6 \vert \qquad Condition 1$$

$$\vert f 1 \vert , \vert f 7 \vert > \vert f 2 \vert > \vert f 3 \vert , \vert f 4 \vert , \vert f 5 \vert , \vert f 6 \vert \qquad Condition 2$$

$$\vert f 1 \vert , \vert f 2 \vert , \vert f 4 \vert , \vert f 6 \vert , \vert f 7 \vert > \vert f 3 \vert > \vert f 5 \vert \qquad Condition 3$$

$$\vert f 1 \vert , \vert f 2 \vert , \vert f 7 \vert > \vert f 4 \vert > \vert f 3 \vert , \vert f 5 \vert , \vert f 6 \vert \qquad Condition 4$$

$$\vert f 1 \vert , \vert f 2 \vert , \vert f 3 \vert , \vert f 4 \vert , \vert f 6 \vert , \vert f 7 \vert > \vert f 5 \vert \qquad Condition 5$$

$$\vert f 1 \vert , \vert f 2 \vert , \vert f 4 \vert , \vert f 7 \vert > \vert f 6 \vert > \vert f 3 \vert , \vert f 5 \vert \qquad Condition 6$$

$$\vert f 7 \vert > \vert f 1 \vert , \vert f 2 \vert , \vert f 3 \vert , \vert f 4 \vert , \vert f 5 \vert , \vert f 6 \vert \qquad Condition 7$$

The thickness (T1) of the first lens (201) may be within a range of 1.1 times or more, for example, 1.2 times to 1.5 times, of the difference between the maximum thickness and the minimum thickness, with the center thickness (CT1) being the minimum and the edge thickness (ET1) being the maximum. The thickness (T2) of the second lens (202) may range from 1 times to 1.5 times the minimum thickness. The second lens (202) may have the maximum center thickness (CT2) and the minimum edge thickness (ET2). The thickness (T3) of the third lens (203) may be minimum at the center and maximum at the edge, with the maximum thickness being within the range of 1 to 1.5 times the minimum thickness. The thickness (T4) of the fourth lens (204) may be maximum at the center and minimum at the edge, with the maximum thickness being within the range of 2 to 2.5 times the minimum thickness. The thickness (T5) of the fifth lens (205) may be minimum at the center and maximum at the edge, with the maximum thickness ranging from 1.2 to 1.7 times the minimum thickness. The thickness (T6) of the sixth lens (206) may be maximum at the center and minimum at the edge, with the maximum thickness ranging from 1.5 to 2 times the minimum thickness. The thickness (T7) of the seventh lens (207) may be minimum at the center and maximum at the edge, with the maximum thickness being within the range of 1 times to 1.5 times the minimum thickness.

The thickness of each lens may satisfy any one of the following conditions.

$$0.5 < CT 1 / ET 1 < 1 , 1.5 < ET 1 / CT 1 < 2 \qquad Condition 1$$

$$1 < CT 2 / ET 2 < 1.5 , 0.5 < ET 2 / CT 2 < 1 \qquad Condition 2$$

$$0.5 < CT 3 / ET 3 < 1 , 1 < ET 3 / CT 3 < 1.5 \qquad Condition 3$$

$$2 < CT 4 / ET 4 < 2.5 , 0.1 < ET 4 / CT 4 < 0.5 \qquad Condition 4$$

$$0.5 < CT 5 / ET 5 < 1 , 1.2 < ET 5 / CT 5 < 1.7 \qquad Condition 5$$

$$1.2 < CT 6 / ET 6 < 1.7 , 0.5 < ET 6 / CT 6 < 1 \qquad Condition 6$$

$$0.5 < CT 7 / ET 7 < 1 , 1 < ET 7 / CT 7 < 1.5 \qquad Condition 7$$

$$1 < \sum CT / \sum ET < 1.2 , 0.5 < \sum ET / \sum CT < 1 \qquad Condition 8$$

Among the gaps (G1-G7) between the lenses, the first gap (G1) between the first and second lenses (201, 202) may have a maximum at the center and a minimum at the edge. The second gap (G2) between the second and third lenses (202, 203) may have a minimum at the center and a maximum at the edge. The third gap (G3) between the third and fourth lenses (203, 204) may have the maximum value at the edge and the minimum value at the center. The fourth gap (G4) between the fourth and fifth lenses (204, 205) may have the minimum value at the center and the maximum value at the edge. The fifth gap (G5) between the fifth and sixth lenses (205, 206) may have the center portion at its maximum and the edge portion at its minimum. The sixth gap (G6) between the sixth and seventh lenses (206, 207) may have the center portion at its minimum and the edge portion at its maximum.

FIGS. 18, 20, and 22 are graphs showing the diffraction MTF (modulation transfer function) at room temperature, low temperature, and high temperature in the optical system of FIG. 13, which are graphs showing the modulation as a function of spatial frequency. As shown in FIGS. 18, 20, and 22, in the second embodiment of the invention, the deviation of the MTF between low temperature and high temperature relative to room temperature may be less than 10%, i.e., 7% or less.

FIGS. 19, 21, and 23 are graphs showing the aberration characteristics at room temperature, low temperature, and high temperature in the optical system of FIG. 13. The aberration graphs in FIGS. 19, 21, and 23 show the measured values of spherical aberration (Longitudinal Spherical Aberration), astigmatic field curves (Astigmatic Field Curves), and distortion (Distortion) from left to right. In FIGS. 19, 21, and 23, the X-axis represents the focal length (mm) and distortion (%), while the Y-axis denotes the image height (height). Additionally, the graph for spherical aberration corresponds to light in the wavelength bands of approximately 435 nm, 486 nm, 546 nm, 587 nm, and 656 nm, while the graphs for astigmatic field curves and distortion correspond to light in the wavelength band of approximately 546 nm. In the aberration diagrams of FIGS. 19, 21, and 23, the closer the curves at room temperature, low temperature, and high temperature are to the Y-axis, the better the aberration correction function is interpreted to be. The optical system (1100) according to the second embodiment shows that the measured values are adjacent to the Y-axis in almost all regions. Thus, the optical system (1100) according to the second embodiment has improved resolution and can achieve good optical performance not only in the central part of the field of view (FOV) but also in the peripheral regions. Here, low temperature may refer to temperatures of −20 degrees Celsius or lower, such as −20 to −40 degrees Celsius, room temperature may refer to a range of 22 degrees Celsius±5 degrees Celsius or 18 to 27 degrees Celsius, and high temperature may refer to temperatures of 85 degrees Celsius or higher, such as 85 to 205 degrees Celsius. As a result, as shown in FIGS. 19, 21, and 23, it can be seen that the reduction in brightness modulation from low temperature to high temperature is less than 10%, for example, 5% or less, or remains almost unchanged.

Table 6 compares the changes in optical characteristics such as EFL, BFL, F-number (F #), TTL, and field of view (FOV_D) in the optical system according to the first embodiment at room temperature, low temperature, and high temperature. It can be seen that the change rate of optical characteristics at low temperature is 5% or less, for example, 3% or less, compared to room temperature. It can be observed that the change rate of optical characteristics at low temperatures relative to room temperature is 5% or less, for example, 3% or less.

TABLE 6

| | | | | low | high |
|---|---|---|---|---|---|
| | | | | temper- | temper- |
| | | | | ature/ | ature/ |
| | Room | low | high | Room | Room |
| | temper- | temper- | temper- | temper- | temper- |
| | ature | ature | ature | ature | ature |
| EFL(F) | 10.86 | 10.78 | 10.95 | 99.26% | 100.82% |
| BFL | 3.38 | 3.37 | 3.38 | 99.70% | 100.00% |
| F# | 1.64 | 1.63 | 1.65 | 99.39% | 100.60% |
| TTL | 30.00 | 29.92 | 30.08 | 99.73% | 100.26% |
| FOV_D | 54.53 | 54.97 | 54.09 | 100.80% | 99.19% |

Therefore, as shown in Table 6, it can be seen that the changes in optical characteristics due to temperature changes from low to high temperatures, such as the rate of change in effective focal length (EFL), TTL, BFL, F number, and field of view (FOV_D), are 10% or less, i.e., 5% or less, for example, within the range of 0 to 5%. This design allows for temperature compensation of the plastic lens, even when using one or more plastic lenses, thereby inhibiting a decrease in the reliability of optical characteristics.

The optical system disclosed in the first embodiment can effectively control aberration characteristics such as chromatic aberration and distortion aberration, and achieve good optical performance not only in the central part but also in the peripheral part of the field of view (FOV).

The optical system according to the third embodiment of the invention will now be described.

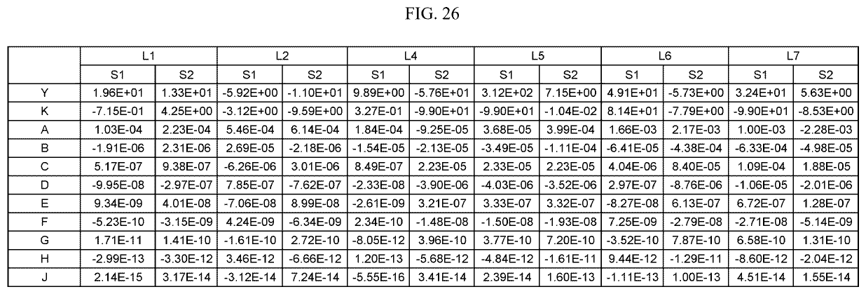

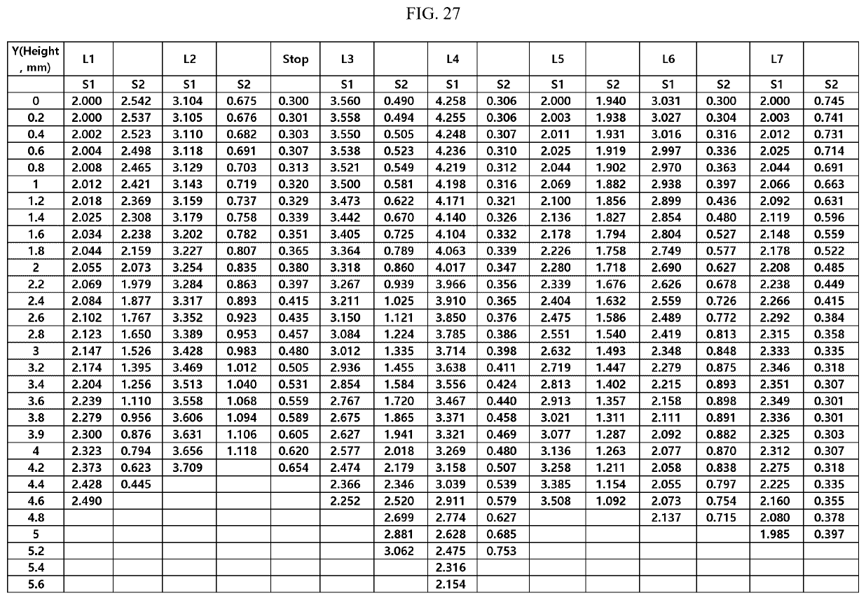

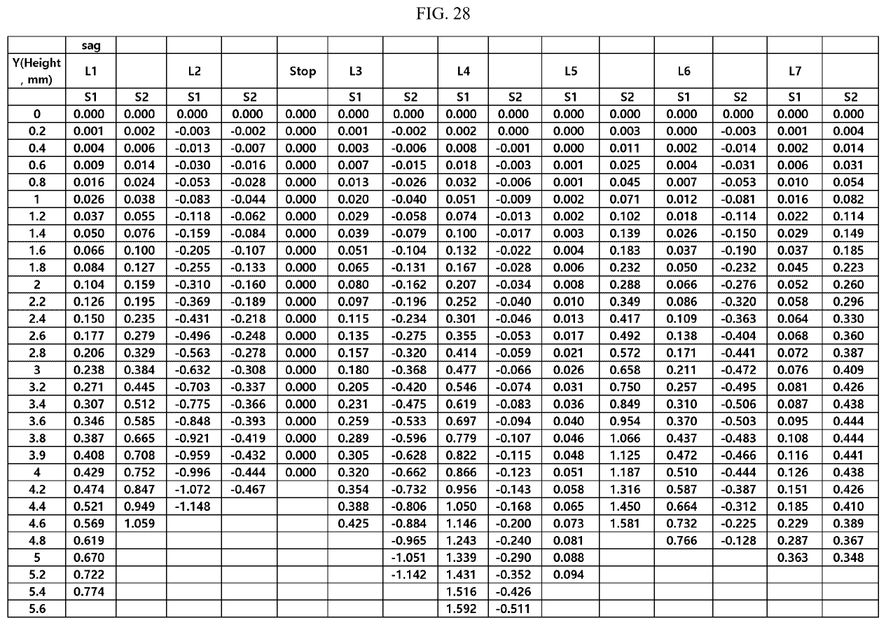

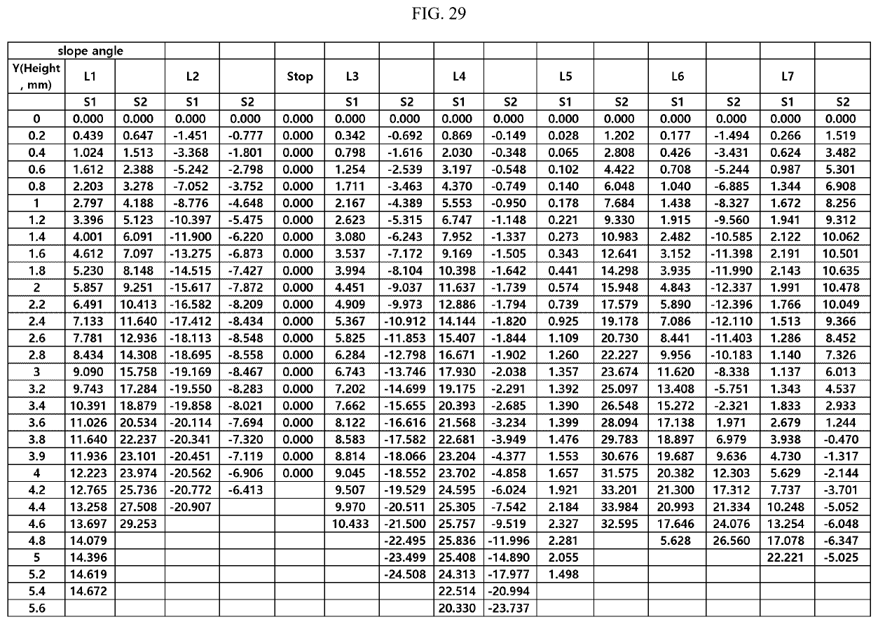

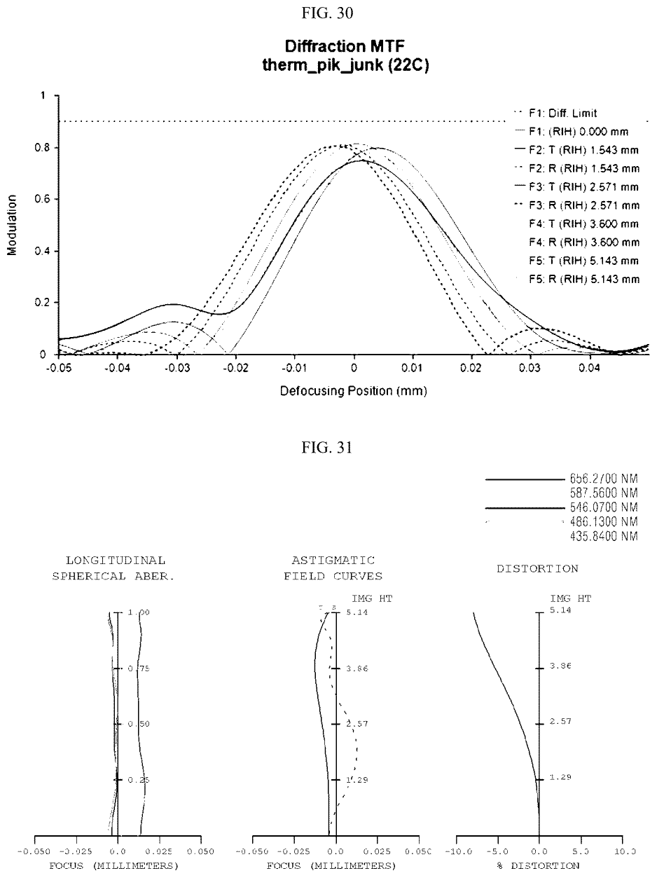

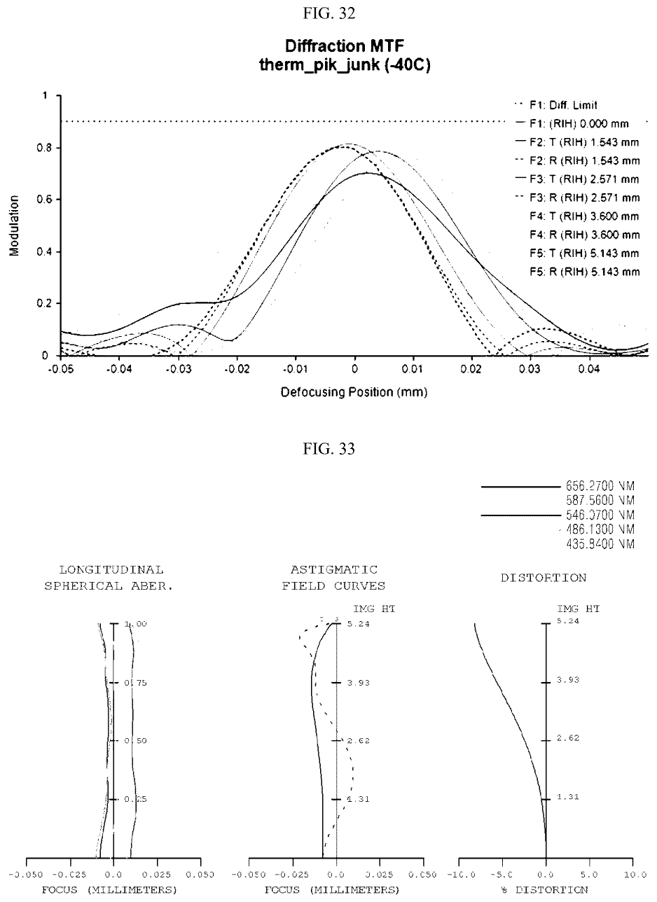

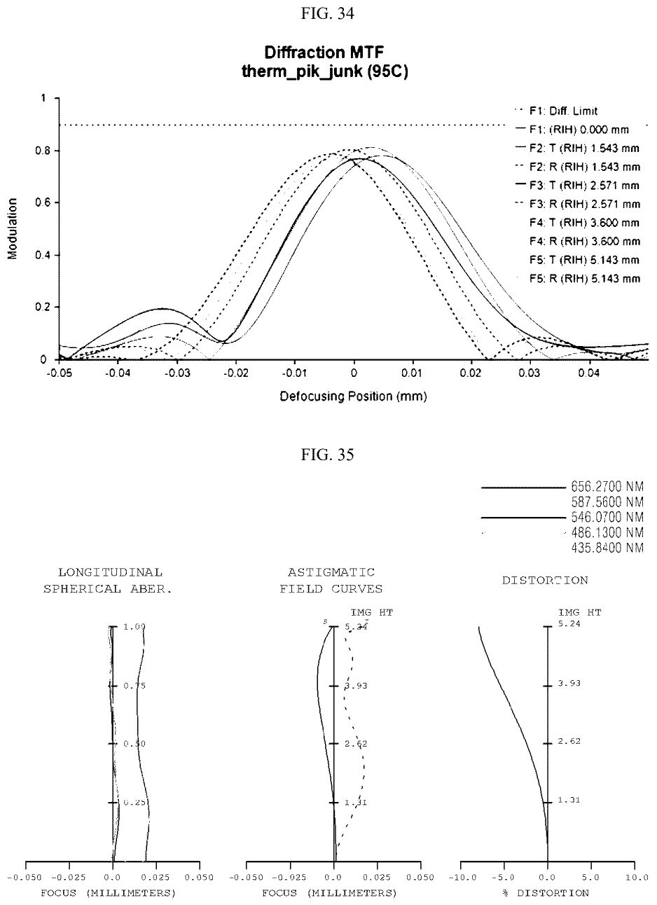

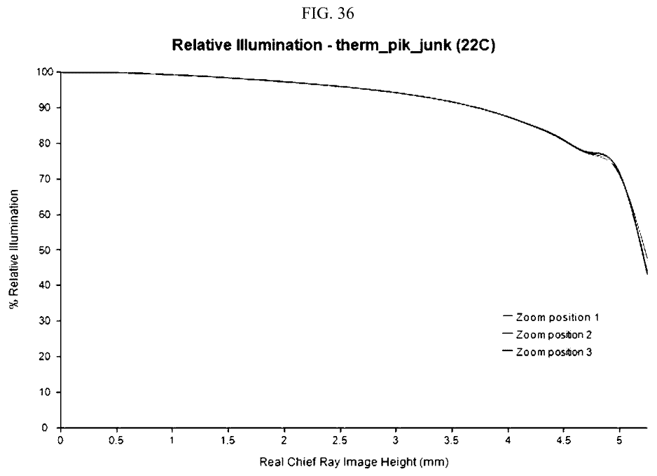

FIG. 25 is a cross-sectional view of an optical system and a camera module including the same according to a third embodiment, FIG. 26 is a table showing the aspheric coefficients of the lenses in the optical system of FIG. 25, FIG. 27 is a table showing the thickness of each lens and the gap between adjacent lenses in the optical system of FIG. 25, FIG. 28 is a table showing the Sag values of the lens surfaces of the first to seventh lenses in the optical system of FIG. 25, FIG. 29 is a table showing slope angles of the lens surfaces of the first to seventh lenses in the optical system of FIG. 25, FIG. 30 is a graph showing data on the diffraction MTF at room temperature for the optical system of FIG. 25, FIG. 31 is a graph showing data on the aberration characteristics at room temperature for the optical system of FIG. 25, FIG. 32 is a graph showing data on the diffraction MTF (Modulation Transfer Function) of the optical system shown in FIG. 25 at low temperatures, FIG. 33 is a graph showing data on the aberration characteristics of the optical system shown in FIG. 25 at low temperatures, FIG. 34 is a graph showing the diffraction MTF data of the optical system in FIG. 25 at high temperatures, FIG. 35 is a graph showing the aberration characteristics data of the optical system in FIG. 25 at high temperatures, and FIG. 36 is a graph showing the peripheral light intensity ratio of the optical system in FIG. 25.

Referring to FIG. 25, the optical system (1200) may include a lens unit, which may include a first lens (301) to a seventh lens (307). The first to seventh lenses (301 to 307) may be sequentially disposed along the optical axis (OA) of the optical system (1200). Light corresponding to the information of the object may pass through the first lens (301) to the seventh lens (307) and the filter (600) and enter the image sensor (500).

The first lens (301) may be disposed closest to the object side. The first lens (301) may be disposed farthest from the sensor side. The first lens (301) may have a negative (−) refractive power relative to the optical axis (OA). The first lens (301) may include a plastic material or a glass material, and may, for example, be made of glass. The first lens (301) made of glass may reduce changes in the center position and curvature radius due to temperature changes caused by the surrounding environment, and may protect the incident side surface of the optical system (1200).

Based on the optical axis, the object-side first surface (S1) of the first lens (301) may be convex, and the sensor-side second surface (S2) may be concave. The first lens (301) may have a convex meniscus shape on the object side. The first lens (301) may have a concave meniscus shape on the sensor side. The first lens (301) may be made of glass material and may have an aspherical surface. At least one or both of the first surface (S1) and the second surface (S2) may be aspherical. The asphericity coefficient of the first and second surfaces (S1, S2) may be provided as S1 and S2 of L3 in FIG. 26. At least one or both of the first surface (S1) and the second surface (S2) may be provided without a critical point from the optical axis (OA) to the end of the effective area.

Due to the refractive characteristics of the first lens (301), the second lens (302) may be spaced further apart from the first lens (301). That is, the center gap between the first and second lenses (301, 302) may be the largest within the lens unit.

The refractive index (n1) of the first lens (301) may satisfy the condition n1>1.6 or n1>1.62. When the refractive index (n1) of the first lens (301) satisfies the above condition, the curvature radius of the first and second lenses (301, 302) can increase, making lens manufacturing easier. If the refractive index (n1) of the first lens (301) is smaller than the condition, the refractive power of the first and second lenses (301, 302) must be increased by forming the lens surface sharply concave or convex. In this case, lens manufacturing becomes difficult, and the lens defect rate may increase, leading to a decrease in yield.

The second lens (302) may be disposed second from the object side. The second lens (302) may be disposed sixth from the sensor side. The second lens (302) may be disposed between the first lens (301) and the third lens (303). The second lens (302) may have a negative (−) refractive power along the optical axis (OA). The second lens (302) may include a plastic or glass material. For example, the second lens (302) may be provided in a plastic material.

Based on the optical axis (OA), the object-side third surface (S3) of the second lens (302) may be concave, and the sensor-side fourth surface (S4) may be convex. The second lens (302) may have a convex meniscus shape toward the sensor side. The second lens (302) may have a concave meniscus shape on the object side. The second lens (302) may be made of plastic material and may be aspherical. At least one or both of the third surface (S3) and the fourth surface (S4) may be aspherical. The asphericity coefficients of the third and fourth surfaces (S3, S4) may be provided as S1 and S2 of L2 in FIG. 26. At least one or both of the third surface (S3) and the fourth surface (S4) may be provided without a critical point from the optical axis (OA) to the end of the effective area.

The aperture (Stop) may be disposed around the perimeter of the sensor-side fourth surface (S4) of the second lens (302). The aperture (Stop) may be disposed around the perimeter of the object-side fifth surface (S5) of the third lens (303). The aperture can reduce the TTL within the field of view and enable the miniaturization of the optical system. As a result, it is possible to inhibit a decrease in the weight-based yield (yield by weight) of the optical system and improve production efficiency. Additionally, the optical system can be miniaturized by reducing the TTL within a horizontal field of view (FOV_H) of 40 to 50 degrees.

The third lens (303) may be disposed as the third lens on the object side. The third lens (303) may be disposed as the fifth lens from the sensor side. The third lens (303) may be disposed between the second lens (302) and the fourth lens (304). The third lens (303) may have a positive (+) refractive power along the optical axis (OA). The third lens (303) may include a plastic or glass material. For example, the third lens (303) may be provided in a glass material.

Based on the optical axis, the object-side fifth surface (S5) of the third lens (303) may be convex, and the sensor-side sixth surface (S6) may be convex. The third lens (303) may have a shape where both surfaces are convex. The third lens (303) may be made of glass material and may be spherical. At least one or both of the fifth surface (S5) and the sixth surface (S6) may be provided without a critical point from the optical axis (OA) to the end of the effective area.

The fourth lens (304) may be disposed fourth from the object side. The fourth lens (304) may be disposed fourth from the sensor side. The fourth lens (304) may be disposed between the third lens (303) and the fifth lens (305). The fourth lens (304) may have a positive (+) or negative (−) refractive power on the optical axis (OA). The fourth lens (304) may have a positive (+) refractive power. The fourth lens (304) may include a plastic or glass material. For example, the fourth lens (304) may be provided in a plastic material.

Based on the optical axis, the object-side seventh surface (S7) of the fourth lens (304) may be convex, and the sensor-side eighth surface (S8) may be convex. The fourth lens (304) may have a shape where both surfaces are convex. The fourth lens (304) may be made of plastic material and may be aspherical. At least one or both of the seventh surface (S7) and the eighth surface (S8) may be aspherical. The asphericity coefficient of the seventh and eighth surfaces (S7, S8) may be provided as S1 and S2 of L4 in FIG. 26. At least one or both of the seventh surface (S7) and the eighth surface (S8) may be provided without a critical point from the optical axis (OA) to the end of the effective area.

The fifth lens (305) may be disposed as the fifth lens from the object side. The fifth lens (305) may be disposed as the third lens from the sensor side. The fifth lens (305) may be disposed between the fourth lens (304) and the sixth lens (306). The fifth lens (305) may have a positive (+) or negative (−) refractive power along the optical axis (OA). The fifth lens (305) may have a negative (−) refractive power. The fifth lens (305) may include a plastic or glass material. For example, the fifth lens (305) may be provided in a plastic material.

With respect to the optical axis (OA), the fifth lens (305) may have an object side convex ninth surface (S9) and a sensor side concave tenth surface (S10). The fifth lens (305) may have a convex meniscus shape on the object side. The fifth lens (305) may have a concave meniscus shape on the sensor side. The fifth lens (305) may be made of plastic material and may be aspherical. At least one or both of the ninth surface (S9) and the tenth surface (S10) may be aspherical. The asphericity coefficients of the ninth and tenth surfaces (S9, S10) may be provided as S1 and S2 of L5 in FIG. 26. At least one or both of the ninth surface (S9) and the tenth surface (S10) may be provided without a critical point from the optical axis (OA) to the end of the effective area.

The sixth lens (306) may be disposed sixth from the object side. The sixth lens (306) may be disposed second from the sensor side. The sixth lens (306) may be disposed between the fifth lens (305) and the seventh lens (307). The sixth lens (306) may have a positive (+) or negative (−) refractive power relative to the optical axis (OA). The sixth lens (306) may have a positive (+) refractive power. The sixth lens (306) may include a plastic or glass material. For example, the sixth lens (306) may be provided in a plastic material.

With respect to the optical axis (OA), the sixth lens (306) may have an object side convex 11th surface (S11) and a sensor side convex 12th surface (S12). The sixth lens (306) may have a shape with both surfaces being convex. The sixth lens (306) may be made of plastic material and may be aspherical. At least one or both of the eleventh surface (S11) and twelfth surface (S12) may be aspherical. The asphericity coefficient of the eleventh and twelfth surfaces (S11, S12) may be provided as S1 and S2 of L6 in FIG. 26.

The 11th surface (S11) of the 6th lens (106) may be provided without a critical point from the optical axis (OA) to the end of the effective area. The 12th surface (S12) of the 6th lens (106) may include a critical point from the optical axis (OA) to the end of the effective area. When the 12th surface (S12) has a critical point, it may be located within a range of 75% to 80%, preferably 76% to 77%, of the effective radius (r62) from the optical axis (OA). The critical point of the 12th surface (S12) may be located within a range of 3.3 mm to 4 mm from the optical axis (OA), preferably within a range of 3.5 mm to 3.6 mm.

The seventh lens (307) may be disposed farthest from the object side. The seventh lens (307) may be disposed closest to the image sensor (500). The seventh lens (307) may have a positive (+) or negative (−) refractive power relative to the optical axis (OA). The seventh lens (307) may have a negative (−) refractive power. The seventh lens (307) may include a plastic or glass material. For example, the seventh lens (307) may be provided in a plastic material.

With respect to the optical axis (OA), the seventh lens (307) may have an object side convex 13th surface (S13) and a sensor side concave 14th surface (S14). The seventh lens (307) may have a convex meniscus shape on the object side. The seventh lens (307) may have a concave meniscus shape on the sensor side. At least one or both of the 13th surface (S13) and the 14th surface (S14) may be aspherical. The asphericity coefficients of the 13th and 14th surfaces (S13, S14) may be provided as S13 and S14 of L7 in FIG. 26.

The 13th surface (S13) of the 7th lens (307) may be provided without a critical point from the optical axis (OA) to the end of the effective area. The 14th surface (S14) of the 7th lens (307) may include a critical point from the optical axis (OA) to the end of the effective area. If the 14th surface (S14) has a critical point, it may be located within the range of 65% to 75% of the effective radius (r72) from the optical axis (OA), preferably within the range of 69% to 72%. The critical point of the 14th surface (S14) may be located within a range of 3.5 mm to 4 mm from the optical axis (OA), preferably within a range of 3.7 mm to 3.8 mm.

The seventh lens (307) may be the plastic lens closest to the image sensor (500). Furthermore, by arranging two or more plastic lenses adjacent to the image sensor (500), it is possible to improve aberrations such as spherical aberration and chromatic aberration caused by the lens surface having an aspherical shape, and to control the resolution. Furthermore, by arranging a plastic lens as the lens adjacent to the image sensor (500), it is possible to be less sensitive to assembly tolerances compared to glass lenses. In other words, being less sensitive to assembly tolerances means that even if the assembly differs slightly from the design during assembly, it may not significantly affect optical performance. Furthermore, by providing the two lenses (306, 307) adjacent to the image sensor (500) in a plastic material, the optical performance can be improved by the aspherical lens surfaces, for example, by improving aberration characteristics and inhibiting resolution degradation.

TABLE 7

| | | | | | | Semi | Focal |
|---|---|---|---|---|---|---|---|
| Lens | Surface | Radius | Thickness | nd | vd | Aperture | length |
| 1 | S1 | 19.593 | 2.000 | 1.6413 | 55.1788 | 5.545 | −73.6385 |
| | S2 | 13.295 | 2.542 | | | 4.619 | |
| 2 | S3 | −5.916 | 3.104 | 1.5371 | 55.7074 | 4.530 | −30.0942 |
| | S4 | −11.042 | 0.675 | | | 4.324 | |
| STOP | — | — | 0.300 | | | 4.127 | |
| 3 | S5 | 25.126 | 3.560 | 1.6223 | 63.8790 | 4.668 | 13.8568 |
| | S6 | −12.415 | 0.490 | | | 5.206 | |
| 4 | S7 | 9.889 | 4.258 | 1.5371 | 55.7074 | 5.730 | 16.0695 |
| | S8 | −57.619 | 0.306 | | | 5.690 | |
| 5 | S9 | 312.301 | 2.000 | 1.6640 | 21.2131 | 5.396 | −11.0568 |
| | S10 | 7.154 | 1.940 | | | 4.773 | |
| 6 | S11 | 49.084 | 3.031 | 1.5371 | 55.7074 | 4.809 | 9.7407 |
| | S12 | −5.730 | 0.300 | | | 4.836 | |
| 7 | S13 | 32.400 | 2.000 | 1.5371 | 55.7074 | 5.133 | −13.0293 |
| | S14 | 5.631 | 0.745 | | | 5.161 | |
| Filter | | infinity | 0.440 | | | | |
| | | | 1.936 | | | | |
| Cover | | infinity | 0.330 | | | | |
| | | | 0.044 | | | | |
| Image | | infinity | 0.000 | | | | |

Table 7 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the third embodiment of the present invention. Here, the units for curvature radius and thickness or distance may be mm.

TABLE 8

| items | values | items | values |
|---|---|---|---|
| F | 10.8841 | F-number | 1.6400 |
| ET1 | 2.2492 | FOV_H | 46.00 |
| ET2 | 3.8136 | EPD | 6.6367 |
| ET3 | 2.0000 | BFL | 3.4945 |
| ET4 | 2.0760 | TD | 26.5055 |
| ET5 | 3.5774 | ImgH | 5.1450 |
| ET6 | 2.1499 | SD | 18.1848 |
| ET7 | 1.9162 | TTL | 30.0000 |
| ΣIndex | 11.0760 | GLca_Aver | 10.018 |
| ΣAbbe | 363.1005 | PLca_Aver | 10.076 |
| ΣCT | 19.9524 | CT_max | 4.2575 |
| ΣCG | 6.5531 | CT_min | 2.0000 |
| CA_max | 11.460 | CT_Aver | 2.8503 |
| CA_min | 8.253 | F_LG1 | −22.077 |
| CA_Aver | 9.939 | F_LG2 | 9.146 |

Table 8 shows the values for the items in the mathematical equations described above in the optical system (1200) of the third embodiment, including the total track length (TTL) (mm), back focal length (BFL), effective focal length (F) (mm), image height (ImgH) (mm), effective diameter (CA) (mm), thickness (mm), TTL (mm), the optical axis distance TD (mm) from the first surface (S1) to the twelfth surface (S12), the sum of refractive indices, the sum of Abbe numbers, the sum of thicknesses (mm), the sum of distances between adjacent lenses, the effective diameter characteristics, the sum of refractive indices of glass lenses, the sum of refractive indices of plastic materials, the field of view (FOV_H) (degrees), edge thickness (ET), F-number, etc.

The center thickness of the first to seventh lenses (301 to 307) is indicated as CT1 to CT7, the edge thickness at the end of the effective area of each lens is indicated as ET1 to ET7, the center gap between adjacent lenses is indicated as CG1 to CG6, and the edge gap between the edges of each lens is denoted as EG1 to EG6. BFL (Back focal length) is the optical axis distance from the image sensor (500) to the center of the last lens. TTL is the optical axis distance from the center of the first surface (S1) of the first lens (301) to the image surface of the image sensor (500).

As shown in FIG. 26, the lens surfaces of the first, second, fourth, fifth, sixth, and seventh lenses (301, 302, 304, 305, 306, 307) in the lens unit of the third embodiment may include aspherical surfaces with a 30th-order asphericity coefficient. For example, the first, second, fourth, fifth, sixth, and seventh lenses (301, 302, 304, 305, 306, 307) may include lens surfaces having a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV).

The thickness (T1-T7) of the first to seventh lenses (301-307) and the gap (G1-G6) between adjacent lenses may be set. As shown in FIG. 3, the thickness (T1-T7) of each lens in the Y-axis direction may be displayed at intervals of 0.1 mm or 0.2 mm or more, and the gap (G1-G6) between each lens may be displayed at intervals of 0.1 mm or 0.2 mm or more. When comparing the absolute values of the curvature radii of each lens, the curvature radius of the first surface (S1) of the first lens (301) at the optical axis (OA) may be the largest among the lenses, and the curvature radius of the tenth surface (S10) of the fifth lens (305) may be the smallest among the lenses. The difference between the maximum and minimum curvature radii may be three times or more, for example, within the range of three to five times. Among the object-side and sensor-side surfaces of the first to seventh lenses (301-307), the number of lens surfaces with a curvature radius greater than 40 may be one or more but no more than four. This allows the curvature radii of the lenses constituting the optical system (1200) to be designed with mostly small values, thereby satisfying the field of view, focal length, and overall length of the lenses when they are mounted in a vehicle. Since the effective diameter of a plastic lens is smaller than that of a glass lens, the lens disposed on the object side of a plastic lens may have a stronger refractive power to refract light through the plastic lens. Additionally, to increase the refractive power, the curvature radius of the lens surface may be smaller. The absolute value of the curvature radius of the first surface (S1) of the first lens (301) may be larger than the absolute value of the curvature radius of the second surface (S2). The absolute value of the curvature radius of the third surface (S3) of the second lens (302) may be smaller than the absolute value of the curvature radius of the fourth surface (S4). The absolute value of the curvature radius of the fifth surface (S5) of the third lens (303) may be greater than the absolute value of the curvature radius of the sixth surface (S6). The absolute value of the curvature radius of the seventh surface (S7) of the fourth lens (304) may be smaller than the absolute value of the curvature radius of the eighth surface (S8). The absolute value of the curvature radius of the ninth surface (S9) of the fifth lens (305) may be greater than the absolute value of the curvature radius of the tenth surface (S10). The absolute value of the curvature radius of the eleventh surface (S11) of the sixth lens (306) may be greater than the absolute value of the curvature radius of the twelfth surface (S12). The absolute value of the curvature radius of the 13th surface (S13) of the 7th lens (307) may be greater than the absolute value of the curvature radius of the 14th surface (S14).

The ratio of the curvature radii of each lens may satisfy the following conditions.

$$1 < \vert L 1 R 1 / L 1 R \vert < 1.5 \qquad Condition 1$$

$$0.5 < \vert L 2 R 1 / L 2 R 2 \vert < 1.5 \qquad Condition 2$$

$$1.8 < \vert L 3 R 1 / L 3 R 2 \vert < 12.2 \qquad Condition 3$$

$$0.1 < \vert L 4 R 1 / L 4 R 2 \vert < 0.5 \qquad Condition 4$$

$$40 < \vert L 5 R 1 / L 5 R 2 \vert < 50 \qquad Condition 5$$

$$60 < \vert L 6 R 1 / L 6 R 2 \vert < 10 \qquad Condition 6$$

$$2 < \vert L 7 R 1 / L 7 R 2 \vert < 8 \qquad Condition 7$$

When describing the center thickness (CT) of the lenses based on the optical axis, the center thickness (CT4) of the fourth lens (304) may be the maximum among the lenses, and at least one of the center thicknesses (CT1, CT5, CT7) of the first lens (301), the fifth lens (305) and the seventh lens (307) may be the minimum among the lenses. The difference between the maximum and minimum center thicknesses of the lenses may be within the range of 2 mm or more and 2.5 mm or less.

The center thickness of each lens may satisfy any one of the following conditions.

$$CT 2 , CT 3 , CT 4 , CT 6 > CT 1 = CT 5 = CT 7 \qquad Condition 1$$

$$CT 3 , CT 4 > CT 2 > CT 1 , CT 5 , CT 6 , CT 7 \qquad Condition 2$$

$$CT 4 > CT 3 > CT 1 , CT 2 , CT 5 , CT 6 , CT 7 \qquad Condition 3$$

$$CT 4 > CT 1 , CT 2 , CT 3 , CT 6 , CT 7 \qquad Condition 4$$

$$CT 2 , CT 3 , CT 4 > CT 6 > CT 1 , CT 5 , CT 7 \qquad Condition 5$$

The center gap (CG) between the lenses is explained as follows: the center gap (CG1) between the first lens (301) and the second lens (302) may be the maximum, and the center gap (CG6) between the sixth and seventh lenses (306, 307) may be the minimum. The difference between the maximum and minimum center gaps among the spaced lenses may be 3 mm or more, for example, within the range of 3 mm to 4 mm.

The center gap between each lens may satisfy the following conditions.

$$CG 1 > CG 2 , CG 3 , CG 4 , CG 5 , CG 6 \qquad Condition 1$$

$$CG 1 , CG 5 > CG 2 > CG 3 , CG 4 , CG 6 \qquad Condition 2$$

$$CG 1 , CG 2 , CG 5 > CG 3 > CG 4 , CG 6 \qquad Condition 3$$

$$CG 1 , CG 2 , CG 3 , CG 5 > CG 4 > CG 6 \qquad Condition 4$$

$$CG 1 > CG 5 > CG 2 , CG 3 , CG 4 , CG 6 \qquad Condition 5$$

$$CG 1 , CG 2 , CG 3 , CG 4 , CG 5 > CG 6 \qquad Condition 6$$

Regarding the effective diameter, a lens with the maximum effective diameter may be a lens made of glass material. The lens with the maximum effective diameter may be the fourth lens (304). Here, the effective diameter is an average of the effective diameter on the object side and the effective diameter on the sensor side of each lens. The lens surface with the maximum effective diameter may be the seventh surface (S7) of the fourth lens (304). The lens with the minimum effective diameter may be the second lens (302). The lens surface with the minimum effective diameter may be the fourth surface (S4) of the second lens (302). The effective diameter of a plastic lens may be smaller than that of a glass lens. A plastic lens may be disposed adjacent to the image sensor.

The effective diameter of each lens may satisfy any one of the following conditions.

$$CA\_L4 , CA\_L5 , CA\_L7 > CA\_L1 > CA\_L2 , CA\_L3 , CA\_L6 \qquad Condition 1$$

$$CA\_L1 , CA\_L3 , CA\_L4 , CA\_L5 , CA\_L6 , CA\_L7 > CA\_L2 \qquad Condition 2$$

$$CA\_L1 , CA\_L4 , CA\_L5 , CA\_L7 > CA\_L3 > CA\_L2 , CA\_L6 \qquad Condition 3$$

$$CA\_L4 > CA\_L1 , CA\_L2 , CA\_L3 , CA\_L5 , CA\_L6 , CA\_L7 \qquad Condition 4$$

$$CA\_L4 , CA\_L7 > CA\_L5 > CA\_L1 , CA\_L2 , CA\_L3 , CA\_L6 \qquad Condition 5$$

$$CA\_L1 , CA\_L3 , CA\_L4 , CA\_L5 , CA\_L7 > CA\_L6 > CA\_L2 \qquad Condition 6$$

$$CA\_L4 > CA\_L7 > CA\_L1 , CA\_L2 , CA\_L3 , CA\_L5 , CA\_L6 \qquad Condition 7$$

Regarding the refractive index, the refractive index of the fifth lens (305) may be the highest among the lenses, exceeding 1.6, for example, exceeding 1.65. The second lens (302), the fourth lens (304), the sixth lens (306), and the seventh lens (307) may have the lowest refractive index among the lenses, either individually or collectively. For example, the refractive indices of the second lens (302), the sixth lens (306), and the seventh lens (108) may be the lowest among the lenses, less than 1.6, such as less than 1.55. The difference between the maximum refractive index and the minimum refractive index may be 0.2 or more. By providing the lens made of glass material with the highest refractive index closest to the object, and providing the lens adjacent to the glass material lens and the lens adjacent to the image sensor (500) with a lens made of plastic material with the lowest refractive index, the incident efficiency can be increased, and the refractive force between the lenses made of glass material and plastic material can be controlled to guide the light to the image sensor (500).

The refractive index of each lens may satisfy any one of the following conditions.

$$n 5 > n 1 > n 2 , n 3 , n 4 , n 6 , n 7 \qquad Condition 1$$

$$n 1 , n 3 , n 5 > n 2 = n 4 = n 6 = n 7 \qquad Condition 2$$

$$n 1 , n 5 > n 3 > n 2 , n 4 , n 6 , n 7 \qquad Condition 3$$

$$n 5 > n 1 , n 2 , n 3 , n 4 , n 6 , n 7 \qquad Condition 4$$

When comparing the Abbe numbers, the Abbe number of the third lens (303) may be the largest among the lenses and may be 60 or higher. The Abbe number of the fifth lens (305) may be the smallest among the lenses and may be 25 or lower. The difference between the maximum refractive index and the minimum Abbe number may be 40 or higher. By maximizing the Abbe number of the third lens (303) disposed at the center of the optical system (1200) and minimizing the Abbe number of the fifth lens (305) with a low refractive index adjacent to the image sensor (500), the color dispersion of light passing through lenses made of glass and plastic materials can be controlled, and the color dispersion between lenses made of glass and plastic materials can be increased, enabling the light to be guided to the image sensor (500).

The Abbe number of each lens may satisfy any one of the following conditions.

$$v 2 , v 3 , v 4 , v 6 , v 7 > v 1 > v 5 \qquad Condition 1$$

$$v 3 > v 2 = v 4 = v 6 = v 7 > v 1 , v 5 \qquad Condition 2$$

$$v 3 > v 1 , v 2 , v 4 , v 5 , v 6 , v 7 \qquad Condition 3$$

$$v 1 , v 2 , v 3 , v 4 , v 6 , v 7 > v 5 \qquad Condition 4$$

The focal lengths (F1, F2, F5, F7) of the first, second, fifth, and seventh lenses (301, 302, 305, 307) may have a negative (−) sign. The first, second, fifth, and seventh lenses (301, 302, 305, 307) may have a negative (−) refractive power. The focal lengths (F3, F4, F6) of the third, fourth, and sixth lenses (303, 304, 306) may have a positive (+) sign. The third, fourth, and sixth lenses (303, 304, 306) may have positive (+) refractive power. The sensor side of the first lens (301) and the second lens (302), which have negative (−) refractive power, may be disposed with the third lens (303), which has positive (+) refractive power. Through this, light incident from the object side may move away from the optical axis direction and then converge again toward the optical axis direction, thereby forming a stable optical path.

Additionally, the fourth lens (304) and fifth lens (305), which are adjacent lenses, can satisfy the following conditions.

Condition 1: Refractive index of a lens with positive refractive power<Refractive index of a lens with negative refractive power

Condition 2: Dispersion value of a lens with positive refractive power>Dispersion value of a lens with negative refractive power

Here, among the plastic lenses, the fourth lens (304) has positive refractive power, and the fifth lens (305) has negative refractive power. According to conditions 1 and 2, the refractive index of the fourth lens (304) may be smaller than that of the fifth lens (305), the dispersion value of the fourth lens (304) may be greater than that of the fifth lens (305). Chromatic aberration occurring in plastic lenses can be corrected using plastic lenses. Additionally, when the fourth lens (304) and the fifth lens (305), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using plastic lenses.

Optical systems exhibit chromatic aberration, which is corrected using bonded lenses or two lenses disposed consecutively. As temperature changes from low to high, lenses repeatedly contract and expand. Since lenses made of the same material exhibit identical changes in lens characteristics due to temperature variations, correcting chromatic aberration between lenses of the same material is effective even when temperature changes. Therefore, in the third embodiment of the present invention, the fourth lens (304) and the fifth lens (305) may be used to correct chromatic aberration occurring in plastic lenses.

From the optical axis to the effective diameter area, the maximum distance between the two lenses with the largest Abbe number difference among the two adjacent lenses may be smaller than the maximum distance between other adjacent pairs of lenses. Here, the distance may refer to the distance between the two lenses from the optical axis to the effective diameter area. The two lenses with the largest Abbe number difference among the two adjacent lenses may be the fourth lens (304) and the fifth lens (305). The maximum value of the distance from the optical axis to the effective diameter area in a direction perpendicular to the optical axis, between the sensor side surface 8th surface (S8) of the fourth lens (304) and the object side surface 9th surface (S9) of the fifth lens (305), may be smaller than the maximum value of the distance between any two adjacent lenses. This allows for a smaller distance between two lenses made of difficult-to-bond plastic materials, maximizing the Abbe number difference, and achieving the same chromatic aberration reduction as bonded lenses even when unbonded.

When comparing focal lengths as absolute values, the focal length of the first lens (301) may be the largest among the lenses and may be between 70 and 80. The focal length of the sixth lens (306) may be the smallest among the lenses, and the absolute value of the focal length of the sixth lens (306) may be between 8 and 12.

Since the first lens (301) has the largest focal length and the weakest refractive power among the lenses, the difference in the Abbe number between the second lens (302) and the third lens (303) disposed on the sensor side of the first lens (301) does not need to be large to achieve the effect of correcting chromatic aberration.

The absolute value of the focal length of each lens may satisfy any one of the following conditions.

$$\vert f 1 \vert > \vert f 2 \vert , \vert f 3 \vert , \vert f 4 \vert , \vert f 5 \vert , \vert f 6 \vert , \vert f 7 \vert \qquad Condition 1$$

$$\vert f 1 \vert > \vert f 2 \vert > \vert f 3 \vert , \vert f 4 \vert , \vert f 5 \vert , \vert f 6 \vert , \vert f 7 \vert \qquad Condition 2$$

$$\vert f 1 \vert , \vert f 2 \vert , \vert f 4 \vert > \vert f 3 \vert > \vert f 5 \vert , \vert f 6 \vert , \vert f 7 \vert \qquad Condition 3$$

$$\vert f 1 \vert , \vert f 2 \vert > \vert f 4 \vert > \vert f 3 \vert , \vert f 5 \vert , \vert f 6 \vert , \vert f 7 \vert \qquad Condition 4$$

$$\vert f 1 \vert , \vert f 2 \vert , \vert f 3 \vert , \vert f 4 \vert , \vert f 7 \vert > \vert f 5 \vert > \vert f 6 \vert \qquad Condition 5$$

$$\vert f 1 \vert , \vert f 2 \vert , \vert f 3 \vert , \vert f 4 \vert , \vert f 5 \vert , \vert f 7 \vert > \vert f 6 \vert \qquad Condition 6$$

$$\vert f 1 \vert , \vert f 2 \vert , \vert f 3 \vert , \vert f 4 \vert > \vert f 7 \vert > \vert f 5 \vert , \vert f 6 \vert \qquad Condition 7$$

The thickness (T1) of the first lens (301) may be within a range of 1.5 times to 2 times, for example, the difference between the maximum thickness and the minimum thickness may be 1.5 times or more, and the center thickness (CT1) may be the minimum, and the edge thickness (ET1) may be the maximum. The thickness (T2) of the second lens (302) may be within the range of 1 times to 1.5 times the minimum thickness. The second lens (302) may have the minimum thickness at the center (CT2) and the maximum thickness at the edge (ET2). The thickness (T3) of the third lens (303) may be minimum at the center and maximum at the edge, with the maximum thickness being within the range of 1 to 1.5 times the minimum thickness. The thickness (T4) of the fourth lens (304) may be maximum at the center and minimum at the edge, with the maximum thickness being within the range of 2 to 2.5 times the minimum thickness. The thickness (T5) of the fifth lens (305) may be minimum at the center and maximum at the edge, with the maximum thickness being within the range of 1.2 to 1.7 times the minimum thickness. The thickness (T6) of the sixth lens (306) may be maximum at the center and minimum at the edge, with the maximum thickness ranging from 1.2 to 1.7 times the minimum thickness. The thickness (T7) of the seventh lens (307) may be minimum at the center and maximum at the edge, with the maximum thickness ranging from 1 to 1.5 times the minimum thickness.

The thickness of each lens may satisfy any one of the following conditions.

$$0.5 < CT 1 / ET 1 < 1 , 1.5 < ET 1 / CT 1 < 2 \qquad Condition 1$$

$$0.5 < CT 2 / ET 2 < 1 , 1 < ET 2 / CT 2 < 1.5 \qquad Condition 2$$

$$0.5 < CT 3 / ET 3 < 1 , 1 < ET 3 / CT 3 < 1.5 \qquad Condition 3$$

$$2 < CT 4 / ET 4 < 2.5 , 0.1 < ET 4 / CT 4 < 0.5 \qquad Condition 4$$

$$0.5 < CT 5 / ET 5 < 1 , 1.2 < ET 5 / CT 5 < 1.7 \qquad Condition 5$$

$$1.2 < CT 6 / ET 6 < 1.7 , 0.5 < ET 6 / CT 6 < 1 \qquad Condition 6$$

$$0.5 < CT 7 / ET 7 < 1 , 1 < ET 7 / CT 7 < 1.5 \qquad Condition 7$$

$$1 < \sum CT / \sum ET < 1.2 , 0.5 < \sum ET / \sum CT < 1 \qquad Condition 8$$

Among the gaps (G1-G7) between the lenses, the first gap (G1) between the first and second lenses (301, 302) may have a maximum at the center and a minimum at the edge. The second gap (G2) between the second and third lenses (302, 303) may have a minimum at the center and a maximum at the edge. The third gap (G3) between the third and fourth lenses (303, 304) may have the maximum value at the edge and the minimum value at the center. The fourth gap (G4) between the fourth and fifth lenses (304, 305) may have the minimum value at the center and the maximum value at the edge. The fifth gap (G5) between the fifth and sixth lenses (305, 306) may have the center portion at its maximum and the edge portion at its minimum. The sixth gap (G6) between the sixth and seventh lenses (306, 307) may have the center portion at its minimum and the edge portion at its maximum.

FIGS. 30, 32, and 34 are graphs showing the diffraction MTF (modulation transfer function) at room temperature, low temperature, and high temperature in the optical system of FIG. 25, respectively. These graphs represent the modulation (luminance ratio) as a function of spatial frequency.

As shown in FIGS. 30, 32, and 34, in the third embodiment of the invention, the deviation of the MTF between room temperature and low or high temperatures may be less than 10%, i.e., 7% or less. FIGS. 31, 33, and 35 are graphs showing the aberration characteristics at room temperature, low temperature, and high temperature in the optical system of FIG. 25.

The aberration graphs in FIGS. 31, 33, and 35 show the measured values of spherical aberration (Longitudinal Spherical Aberration), astigmatic field curves (Astigmatic Field Curves), and distortion (Distortion) from left to right. In FIGS. 31, 33, and 35, the X-axis may represent the focal length (mm) and distortion (%) and the Y-axis may represent the image height (height). Additionally, the graph for spherical aberration corresponds to light in the wavelength bands of approximately 435 nm, 486 nm, 546 nm, 587 nm, and 656 nm, while the graphs for astigmatic field curves and distortion correspond to light in the wavelength band of approximately 546 nm. In the aberration diagrams of FIGS. 31, 33, and 35, the closer the curves at room temperature, low temperature, and high temperature are to the Y-axis, the better the aberration correction function is interpreted to be. The optical system (1200) according to the third embodiment shows that the measured values are adjacent to the Y-axis in almost all regions. In other words, the optical system (1000) according to the third embodiment has improved resolution and can achieve good optical performance not only in the central part of the field of view (FOV) but also in the peripheral part. Here, low temperature may refer to temperatures of −20° C. or lower, such as −20° C. to −40° C., room temperature may refer to a range of 22° C.±5° C. or 18° C. to 27° C., and high temperature may refer to temperatures of 85° C. or higher, such as 85° C. to 105° C. As a result, as shown in FIGS. 31, 33, and 35, it can be seen that the reduction in brightness modulation from low temperature to high temperature is less than 10%, for example, 5% or less, or remains almost unchanged.

Table 9 compares the changes in optical characteristics such as EFL, BFL, F-number (F #), TTL, and field of view (FOV_H) in the optical system according to the third embodiment at room temperature, low temperature, and high temperature. It can be seen that the change rate of optical characteristics at low temperature is 5% or less, for example, 3% or less, compared to room temperature. It can be observed that the change rate of optical characteristics at low temperatures relative to room temperature is 5% or less, for example, 3% or less.

TABLE 9

| | | | | Low | high |
|---|---|---|---|---|---|
| | | | | temper- | temper- |
| | | | | ature/ | ature/ |
| | Room | low | high | Room | Room |
| | temper- | temper- | temper- | temper- | temper- |
| | ature | ature | ature | ature | ature |
| EFL(F) | 10.88 | 10.79 | 11.00 | 99.17% | 101.10% |
| BFL | 3.49 | 3.49 | 3.50 | 100.00% | 100.28% |
| F# | 1.64 | 1.63 | 1.66 | 99.39% | 101.21% |
| TTL | 30.00 | 29.93 | 30.09 | 99.76% | 100.30% |
| FOV_D | 54.34 | 54.81 | 53.79 | 100.86% | 98.98% |

Therefore, as shown in Table 9, the changes in optical characteristics due to temperature changes from low to high temperatures, such as the change rate of the effective focal length (EFL), TTL, BFL, F number, and field of view (FOV_D), are 10% or less, i.e., 5% or less, for example, within the range of 0 to 5%. This design allows for temperature compensation of the plastic lens, even when using one or more plastic lenses, thereby inhibiting a decrease in the reliability of optical characteristics.

The optical system disclosed in the third embodiment can effectively control aberration characteristics such as chromatic aberration and distortion, and provides good optical performance not only in the central part but also in the peripheral part of the field of view (FOV).

The optical system according to the fourth embodiment of the invention will now be described.

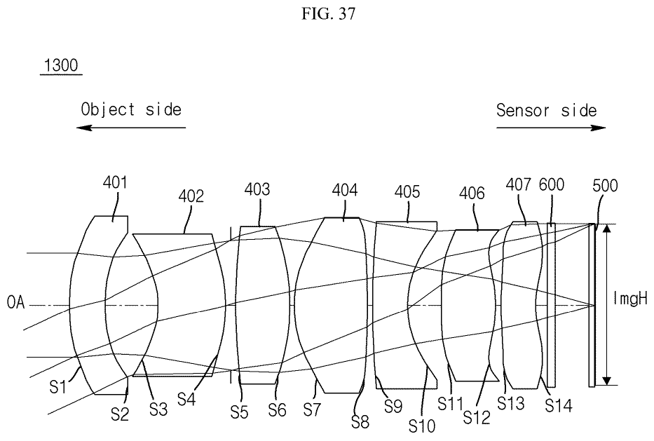

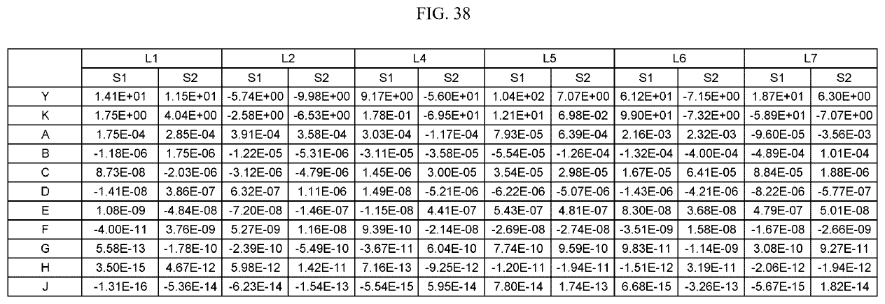

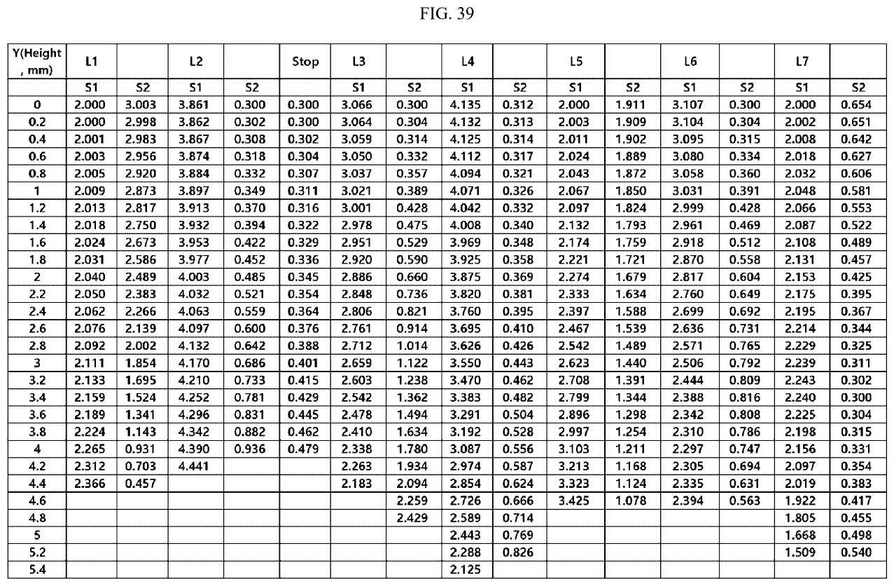

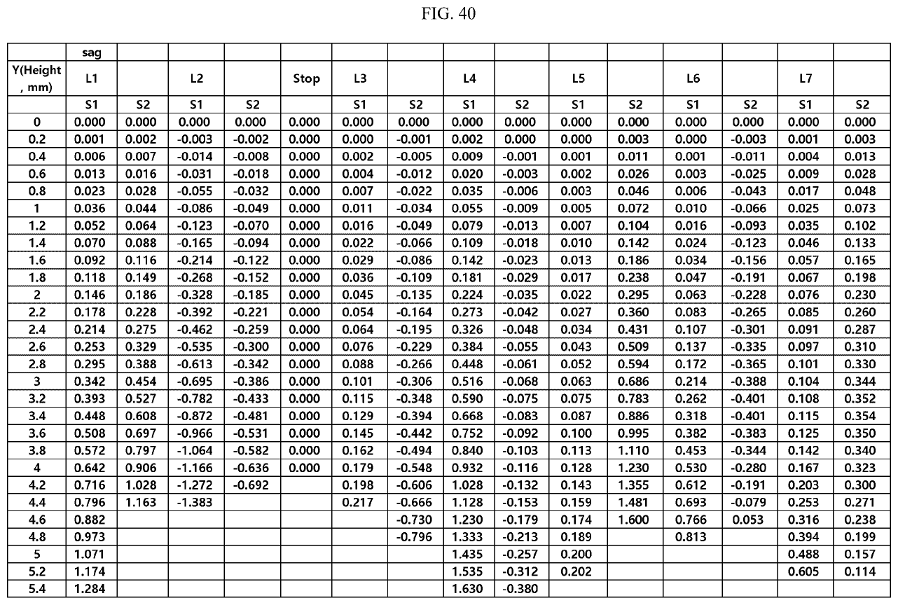

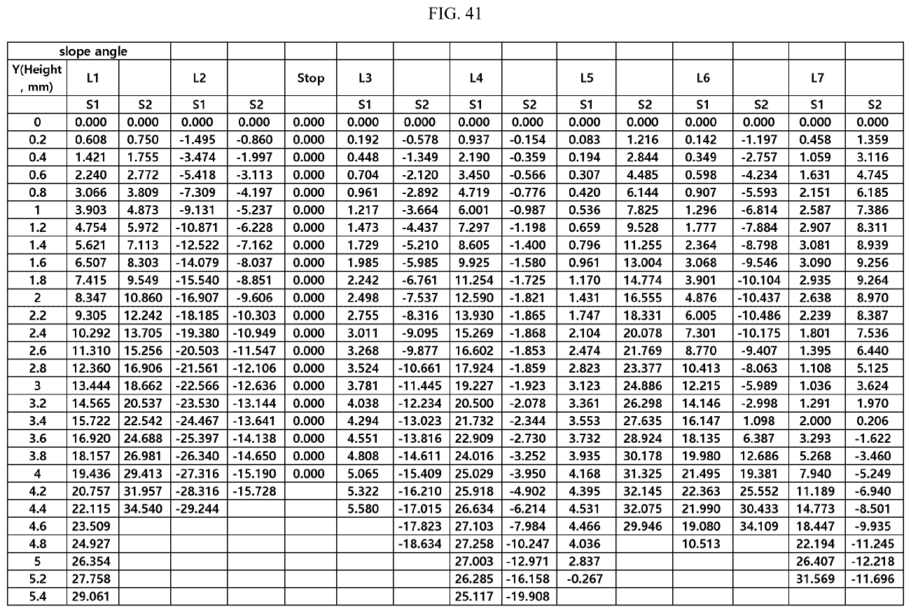

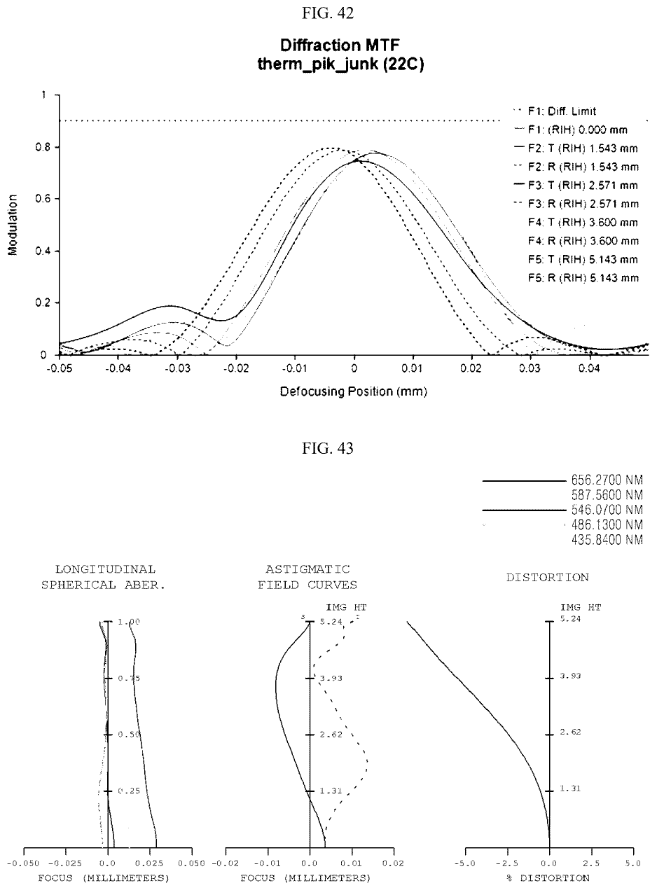

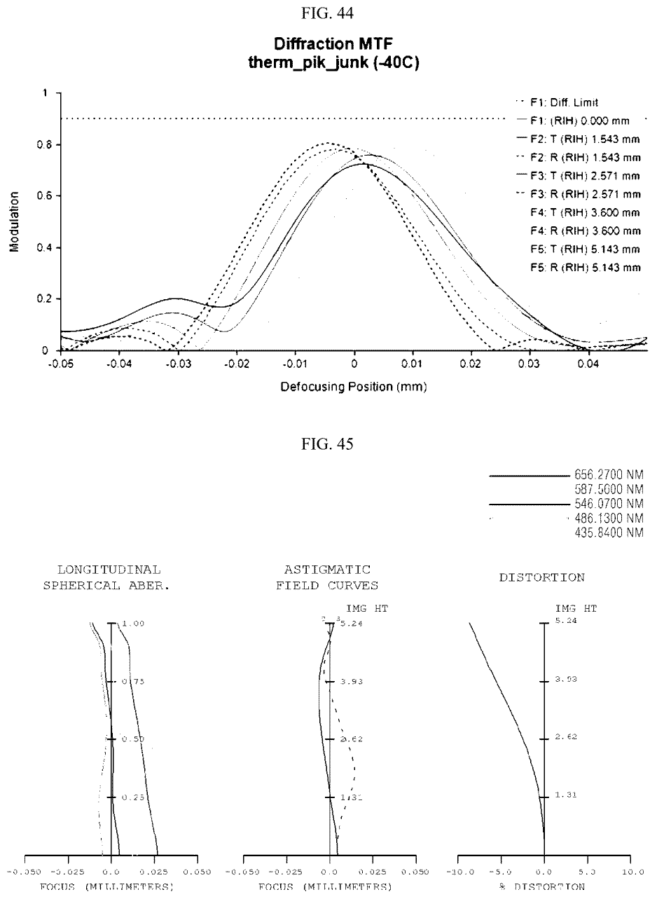

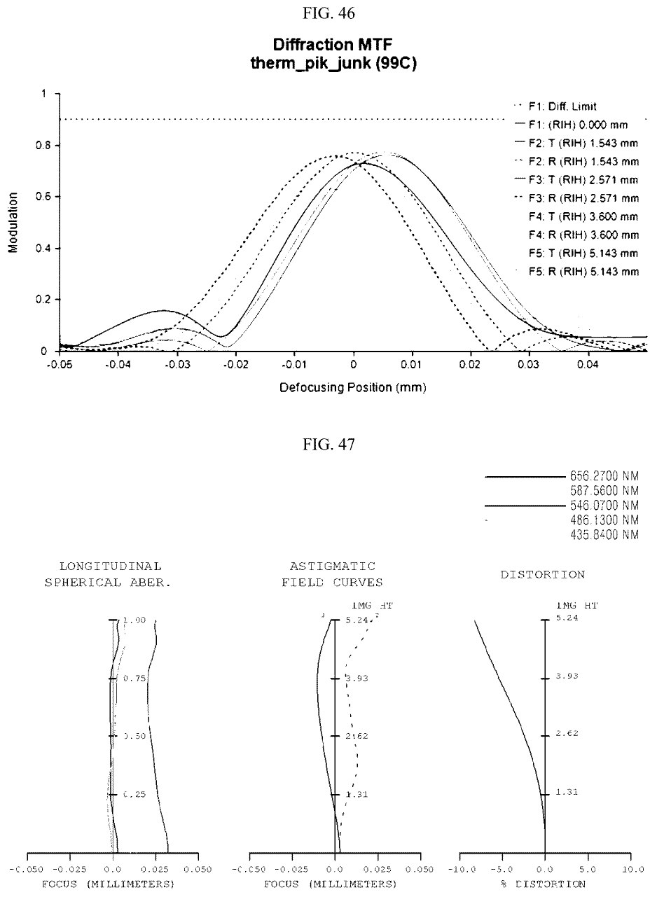

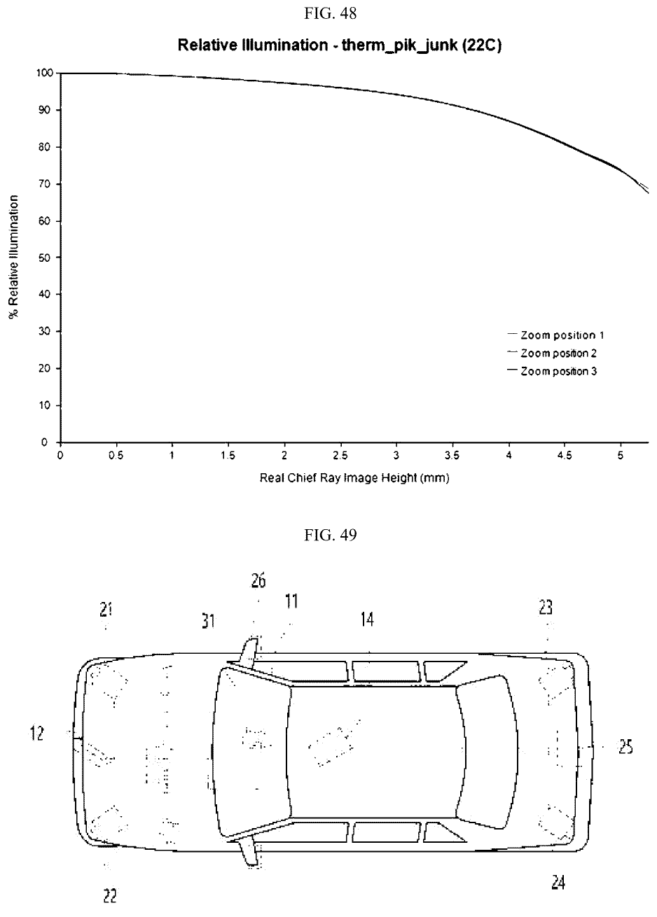

FIG. 37 is a side cross-sectional view of the optical system and a camera module including the same according to a fourth embodiment, FIG. 38 is a table showing the aspheric coefficients of the lenses in the optical system of FIG. 37, FIG. 39 is a table showing the thickness of each lens in the optical system of FIG. 37 and the gap between adjacent lenses, FIG. 40 is a table showing the Sag values of the lens surfaces of the first to seventh lenses in the optical system of FIG. 37, FIG. 41 is a table showing the slope angles of the lens surfaces of the first to seventh lenses in the optical system of FIG. 37, FIG. 42 is a graph showing data on the diffraction MTF (Modulation Transfer Function) at room temperature for the optical system shown in FIG. 37, FIG. 43 is a graph showing data on the aberration characteristics at room temperature for the optical system shown in FIG. 37, FIG. 44 is a graph showing data on the diffraction MTF at low temperatures for the optical system shown in FIG. 37, FIG. 45 is a graph showing data on the aberration characteristics of the optical system shown in FIG. 37 at low temperatures, FIG. 46 is a graph showing data on the diffraction MTF of the optical system shown in FIG. 37 at high temperatures, FIG. 47 is a graph showing data on the aberration characteristics of the optical system shown in FIG. 37 at high temperatures, and FIG. 48 is a graph showing the peripheral light intensity ratio of the optical system shown in FIG. 37.

Referring to FIG. 37, an optical system (1300) may include a lens unit, which may include a first lens (401) to a seventh lens (407). The first to seventh lenses (401 to 407) may be sequentially disposed along the optical axis (OA) of the optical system (1300). Light corresponding to the information of the object may pass through the first lens (401) to the seventh lens (407) and the filter (600) and enter the image sensor (500).

The first lens (401) may be disposed closest to the object side. The first lens (401) may be disposed farthest from the sensor side. The first lens (401) may have a negative (−) refractive power relative to the optical axis (OA). The first lens (401) may include a plastic material or a glass material, and may, for example, be made of glass. The first lens (401) made of glass may reduce changes in the center position and curvature radius due to temperature changes caused by the surrounding environment, and may protect the incident side of the optical system (1300).

Based on the optical axis, the object-side first surface (S1) of the first lens (401) may be convex, and the sensor-side second surface (S2) may be concave. The first lens (401) may have a convex meniscus shape on the object side. The first lens (401) may have a concave meniscus shape on the sensor side. The first lens (401) may be made of glass material and may have an aspherical surface. At least one or both of the first surface (S1) and the second surface (S2) may be aspherical. The asphericity coefficient of the first and second surfaces (S1, S2) may be provided as S1 and S2 of L3 in FIG. 38. At least one or both of the first surface (S1) and the second surface (S2) may be provided without a critical point from the optical axis (OA) to the end of the effective area.

Due to the refractive characteristics of the first lens (401), the second lens (402) may be spaced further apart from the first lens (401). That is, the center gap between the first and second lenses (401, 402) may be the largest within the lens unit.

The refractive index (n1) of the first lens (401) may satisfy the condition n1>1.6 or n1>1.62. When the refractive index (n1) of the first lens (401) satisfies the above condition, the curvature radius of the first and second lenses (401, 402) can increase, making lens manufacturing easier. If the refractive index (n1) of the first lens (401) is smaller than the condition, the refractive power of the first and second lenses (401, 402) must be increased by forming the lens surface sharply concave or convex, which makes lens manufacturing difficult, increases the defect rate, and may cause a decrease in yield.

The second lens (402) may be disposed second from the object side. The second lens (402) may be disposed sixth from the sensor side. The second lens (402) may be disposed between the first lens (401) and the third lens (403). The second lens (402) may have a negative (−) refractive power along the optical axis (OA). The second lens (402) may include a plastic or glass material. For example, the second lens (402) may be provided in a plastic material.

Based on the optical axis (OA), the object-side third surface (S3) of the second lens (402) may be concave, and the sensor-side fourth surface (S4) may be convex. The second lens (402) may have a convex meniscus shape toward the sensor side. The second lens (402) may have a concave meniscus shape on the object side. The second lens (402) may be made of plastic material and may be aspherical. At least one or both of the third surface (S3) and the fourth surface (S4) may be aspherical. The asphericity coefficients of the third and fourth surfaces (S3, S4) may be provided as S1 and S2 of L2 in FIG. 38. At least one or both of the third surface (S3) and the fourth surface (S4) may be provided without a critical point from the optical axis (OA) to the end of the effective area.

The aperture (Stop) may be disposed around the perimeter of a sensor side fourth surface (S4) of the second lens (402). The aperture (Stop) may be disposed around the perimeter of an object side fifth surface (S5) of the third lens (403). The aperture can reduce the TTL within the field of view and enable the miniaturization of the optical system. As a result, it is possible to inhibit a decrease in the weight-based yield (yield by weight) of the optical system and improve production efficiency. Additionally, the optical system can be miniaturized by reducing the TTL within a horizontal field of view (FOV_H) of 40 to 50 degrees.

The third lens (403) may be disposed as the third lens on the object side. The third lens (403) may be disposed as the fifth lens from the sensor side. The third lens (403) may be disposed between the second lens (402) and the fourth lens (404). The third lens (403) may have a positive (+) refractive power along the optical axis (OA). The third lens (403) may include a plastic or glass material. For example, the third lens (403) may be provided in a glass material.

Based on the optical axis, the object-side fifth surface (S5) of the third lens (403) may be convex, and the sensor-side sixth surface (S6) may be convex. The third lens (403) may have a shape where both surfaces are convex. The third lens (403) may be made of glass material and may be spherical. At least one or both of the fifth surface (S5) and the sixth surface (S6) may be provided without a critical point from the optical axis (OA) to the end of the effective area.

The fourth lens (404) may be disposed fourth from the object side. The fourth lens (404) may be disposed fourth from the sensor side. The fourth lens (404) may be disposed between the third lens (403) and the fifth lens (405). The fourth lens (404) may have a positive (+) or negative (−) refractive power on the optical axis (OA). The fourth lens (404) may have a positive (+) refractive power. The fourth lens (404) may include a plastic or glass material. For example, the fourth lens (404) may be provided in a plastic material.

Based on the optical axis, the object-side seventh surface (S7) of the fourth lens (404) may be convex, and the sensor-side eighth surface (S8) may be convex. The fourth lens (404) may have a shape where both surfaces are convex. The fourth lens (404) may be made of plastic material and may be aspherical. At least one or both of the seventh surface (S7) and the eighth surface (S8) may be aspherical. The asphericity coefficients of the seventh and eighth surfaces (S7, S8) may be provided as S1 and S2 of L4 in FIG. 38. At least one or both of the seventh surface (S7) and the eighth surface (S8) may be provided without a critical point from the optical axis (OA) to the end of the effective area.

The fifth lens (405) may be disposed as the fifth lens from the object side. The fifth lens (405) may be disposed as the third lens from the sensor side. The fifth lens (405) may be disposed between the fourth lens (404) and the sixth lens (406). The fifth lens (405) may have a positive (+) or negative (−) refractive power relative to the optical axis (OA). The fifth lens (405) may have a negative (−) refractive power. The fifth lens (405) may include a plastic or glass material. For example, the fifth lens (405) may be provided in a plastic material.

With respect to the optical axis (OA), the fifth lens (405) may have an object side convex ninth surface (S9) and a sensor side concave tenth surface (S10). The fifth lens (405) may have a convex meniscus shape on the object side. The fifth lens (405) may have a concave meniscus shape on the sensor side. The fifth lens (405) may be made of plastic material and may be aspherical. At least one or both of the ninth surface (S9) and the tenth surface (S10) may be aspherical. The asphericity coefficients of the ninth and tenth surfaces (S9, S10) may be provided as S1 and S2 of L5 in FIG. 38. At least one or both of the ninth surface (S9) and the tenth surface (S10) may be provided without a critical point from the optical axis (OA) to the end of the effective area.

The sixth lens (406) may be dispose as the sixth lens from the object side. The sixth lens (406) may be disposed as the second lens from the sensor side. The sixth lens (406) may be disposed between the fifth lens (405) and the seventh lens (407). The sixth lens (406) may have a positive (+) or negative (−) refractive power relative to the optical axis (OA). The sixth lens (406) may have a positive (+) refractive power. The sixth lens (406) may include a plastic or glass material. For example, the sixth lens (406) may be provided in a plastic material.

With respect to the optical axis (OA), the sixth lens (406) may have an object side convex 11th surface (S11) and a sensor side convex 12th surface (S12). The sixth lens (406) may have a shape with both surfaces being convex. The sixth lens (406) may be made of plastic material and may be aspherical. At least one or both of the eleventh surface (S11) and the twelfth surface (S12) may be aspherical. The asphericity coefficient of the eleventh and twelfth surfaces (S11, S12) may be provided as S1 and S2 of L6 in FIG. 38.

The 11th surface (S11) of the sixth lens (406) may be provided without a critical point from the optical axis (OA) to the end of the effective area. The 12th surface (S12) of the sixth lens (406) may include a critical point from the optical axis (OA) to the end of the effective area. When the 12th surface (S12) has a critical point, it may be located within a range of 65% to 75%, preferably 70% to 73%, of the effective radius (r62) from the optical axis (OA). The critical point of the 12th surface (S12) may be located within a range of 3 mm to 3.5 mm from the optical axis (OA), preferably within a range of 3.3 mm to 3.4 mm.

The seventh lens (407) may be disposed farthest from the object side. The seventh lens (407) may be disposed closest to the image sensor (500). The seventh lens (407) may have a positive (+) or negative (−) refractive power relative to the optical axis (OA). The seventh lens (407) may have a negative (−) refractive power. The seventh lens (407) may include a plastic or glass material. For example, the seventh lens (407) may be provided in a plastic material.

With respect to the optical axis (OA), the seventh lens (407) may have a convex shape on the object side surface (S13) and a concave shape on the sensor side surface (S14). The seventh lens (407) may have a convex meniscus shape on the object side. The seventh lens (407) may have a concave meniscus shape on the sensor side. At least one or both of the 13th surface (S13) and the 14th surface (S14) may be aspherical. The asphericity coefficients of the 13th and 14th surfaces (S13, S14) may be provided as S13 and S14 of L7 in FIG. 38.

The 13th surface (S13) of the 7th lens (407) may be provided without a critical point from the optical axis (OA) to the end of the effective area. The 14th surface (S14) of the 7th lens (407) may include a critical point from the optical axis (OA) to the end of the effective area. If the 14th surface (S14) has a critical point, it may be disposed within the range of 60% to 70% of the effective radius (r72) from the optical axis (OA), preferably within the range of 63% to 66%. The critical point of the 14th surface (S14) may be disposed within a range of 3 mm to 3.5 mm from the optical axis (OA), preferably within a range of 3.3 mm to 3.4 mm.

The seventh lens (407) may be the plastic lens closest to the image sensor (500). Additionally, by arranging two or more plastic lenses adjacent to the image sensor (500), aberrations such as spherical aberration and chromatic aberration can be improved by the lens surfaces with aspherical shapes, and the resolution can be controlled. Furthermore, by arranging a plastic lens adjacent to the image sensor (500), it is possible to be less sensitive to assembly tolerances compared to glass lenses. In other words, being less sensitive to assembly tolerances means that even if the assembly differs slightly from the design during assembly, it may not significantly affect optical performance. Furthermore, by providing the two lenses (406, 407) adjacent to the image sensor (500) in a plastic material, the optical performance can be improved through the use of aspherical lens surfaces, such as improving aberration characteristics and inhibiting resolution degradation.

TABLE 10

| | | | | | | Semi | Focal |
|---|---|---|---|---|---|---|---|
| Lens | Surface | Radius | Thickness | nd | vd | Aperture | length |
| 1 | S1 | 14.136 | 2.000 | 1.8297 | 24.0394 | 5.586 | −111.2740 |
| | S2 | 11.472 | 3.003 | | | 4.552 | |
| 2 | S3 | −5.742 | 3.861 | 1.5371 | 55.7074 | 4.412 | −36.8873 |
| | S4 | −9.984 | 0.300 | | | 4.316 | |
| STOP | — | — | 0.300 | | | 4.118 | |
| 3 | S5 | 44.737 | 3.066 | 1.6998 | 55.4589 | 4.434 | 16.2897 |
| | S6 | −14.866 | 0.300 | | | 4.970 | |
| 4 | S7 | 9.173 | 4.135 | 1.5371 | 55.7074 | 5.572 | 15.0073 |
| | S8 | −55.980 | 0.312 | | | 5.528 | |
| 5 | S9 | 103.533 | 2.000 | 1.6679 | 20.3792 | 5.260 | −11.4574 |
| | S10 | 7.071 | 1.911 | | | 4.746 | |
| 6 | S11 | 61.238 | 3.107 | 1.5371 | 55.7074 | 4.804 | 12.1193 |
| | S12 | −7.154 | 0.300 | | | 4.765 | |
| 7 | S13 | 18.713 | 2.000 | 1.5371 | 55.7074 | 5.244 | −18.7281 |
| | S14 | 6.298 | 0.654 | | | 5.296 | |
| Filter | | infinity | 0.440 | | | | |
| | | | 1.936 | | | | |
| Cover | | infinity | 0.330 | | | | |
| | | | 0.044 | | | | |
| Image | | infinity | 0.000 | | | | |

Table 10 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the fourth embodiment of the present invention. Here, the units for curvature radius and thickness or distance may be mm.

TABLE 11

| items | values | items | values |
|---|---|---|---|
| F | 10.8811 | F-number | 1.6400 |
| ET1 | 1.8827 | FOV_H | 46.00 |
| ET2 | 4.5313 | EPD | 6.6348 |
| ET3 | 2.0000 | BFL | 3.4043 |
| ET4 | 2.0000 | TD | 26.5957 |
| ET5 | 3.4695 | ImgH | 5.1450 |
| ET6 | 2.4636 | SD | 17.4316 |
| ET7 | 1.4949 | TTL | 29.9947 |
| ΣIndex | 11.3458 | GLca_Aver | 9.771 |
| ΣAbbe | 322.7071 | PLca_Aver | 9.988 |
| ΣCT | 20.1687 | CT_max | 4.1347 |
| ΣCG | 6.4270 | CT_min | 2.0000 |
| CA_max | 11.172 | CT_Aver | 2.8812 |
| CA_min | 8.235 | F_LG1 | −29.521 |
| CA_Aver | 9.814 | F_LG2 | 9.810 |

Table 11 shows the values of the items in the mathematical equations described above for the optical system (1300) of the embodiment. The optical system (1300) may include the total track length (TTL) (mm), back focal length (BFL), effective focal length (F) (mm), image height (ImgH) (mm), effective aperture (CA) (mm), thickness (mm), TTL (mm), the optical axis distance TD (mm) from the first surface (S1) to the sixteenth surface (S16), the sum of refractive indices, the sum of Abbe numbers, the sum of thicknesses (mm), the sum of intervals between adjacent lenses, the effective aperture characteristics, the sum of refractive indices of glass lenses, the sum of refractive indices of plastic materials, the field of view (FOV_H) (degrees), edge thickness (ET), F-number, etc.

The center thickness of the first to seventh lenses (401 to 407) is indicated as CT1 to CT7, the edge thickness at the end of the effective area of each lens is indicated as ET1 to ET7, the center gap between adjacent lenses is indicated as CG1 to CG6, and the edge gap between the edges of each lens is denoted as EG1 to EG6. BFL (Back focal length) is the optical axis distance from the image sensor (500) to the center of the last lens. TTL is the optical axis distance from the center of the first surface (S1) of the first lens (401) to the image surface of the image sensor (500).

As shown in FIG. 38, the lens surfaces of the first, second, fourth, fifth, sixth, and seventh lenses (401, 402, 404, 405, 406, 407) in the lens unit of the fourth embodiment may include aspherical surfaces having a 30th-order asphericity coefficient. For example, the first, second, fourth, fifth, sixth, and seventh lenses (401, 402, 404, 405, 406, 407) may include lens surfaces having a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV).

The thickness (T1-T7) of the first to seventh lenses (401-407) and the gap (G1-G6) between adjacent lenses may be set. As shown in FIG. 3, the thickness (T1-T7) of each lens in the Y-axis direction may be represented at intervals of 0.1 mm or 0.2 mm or more, and the gap (G1-G6) between each lens may be represented at intervals of 0.1 mm or 0.2 mm or more.

When comparing the absolute values of the curvature radii of each lens, the curvature radius of the ninth surface (S9) of the fifth lens (405) at the optical axis (OA) may be the largest among the lenses, and the curvature radius of the third surface (S3) of the second lens (402) may be the smallest among the lenses. The difference between the maximum and minimum curvature radii may be 15 times or more, for example, within the range of 15 to 25 times.

Among the object-side and sensor-side surfaces of the first to seventh lenses (401-407), the number of lens surfaces with a curvature radius greater than 40 may be one or more but no more than four. This allows the curvature radii of the lenses constituting the optical system (1300) to be designed mostly small, thereby satisfying the field of view, focal length, and overall length of the lenses when they are mounted in a vehicle.

Since the effective diameter of a plastic lens is smaller than that of a glass lens, the lens on the object side of a plastic lens may have a stronger refractive power to refract light through the plastic lens. Additionally, to increase the refractive power, the curvature radius of the lens surface may be smaller.

The absolute value of the curvature radius of the first surface (S1) of the first lens (401) may be larger than the absolute value of the curvature radius of the second surface (S2). The absolute value of the curvature radius of the third surface (S3) of the second lens (402) may be smaller than the absolute value of the curvature radius of the fourth surface (S4). The absolute value of the curvature radius of the fifth surface (S5) of the third lens (403) may be greater than the absolute value of the curvature radius of the sixth surface (S6). The absolute value of the curvature radius of the seventh surface (S7) of the fourth lens (404) may be smaller than the absolute value of the curvature radius of the eighth surface (S8). The absolute value of the curvature radius of the ninth surface (S9) of the fifth lens (405) may be greater than the absolute value of the curvature radius of the tenth surface (S10). The absolute value of the curvature radius of the eleventh surface (S11) of the sixth lens (406) may be greater than the absolute value of the curvature radius of the twelfth surface (S12). The absolute value of the curvature radius of the 13th surface (S13) of the 7th lens (407) may be greater than the absolute value of the curvature radius of the 14th surface (S14).

The ratio of the curvature radii of each lens may satisfy the following conditions.

$$1 < \vert L 1 R 1 / L 1 R \vert < 1.5 \qquad Condition 1$$

$$0.5 < \vert L 2 R 1 / L 2 R 2 \vert < 1 \qquad Condition 2$$

$$2.5 < \vert L 3 R 1 / L 3 R 2 \vert < 3.5 \qquad Condition 3$$

$$0.1 < \vert L 4 R 1 / L 4 R 2 \vert < 0.5 \qquad Condition 4$$

$$10 < \vert L 5 R 1 / L 5 R 2 \vert < 20 \qquad Condition 5$$

$$5 < \vert L 6 R 1 / L 6 R 2 \vert < 10 \qquad Condition 6$$

$$1 < \vert L 7 R 1 / L 7 R 2 \vert < 5 \qquad Condition 7$$

When describing the center thickness (CT) of the lenses based on the optical axis, the center thickness (CT4) of the fourth lens (404) may be the maximum among the lenses, and the center thickness (CT1, CT5, CT7) of at least one of the first lens (401), fifth lens (405) and seventh lens (407) may be the minimum among the lenses. The difference between the maximum and minimum center thicknesses of the lenses may be within the range of 2 mm or more and 2.5 mm or less.

The center thickness of each lens may satisfy any one of the following conditions.

$$CT 2 , CT 3 , CT 4 , CT 6 > CT 1 = CT 5 = CT 7 \qquad Condition 1$$

$$CT 4 > CT 2 > CT 1 , CT 3 , CT 5 , CT 6 , CT 7 \qquad Condition 2$$

$$CT 2 , CT 4 , CT 6 > CT 3 > CT 1 , CT 5 , CT 7 \qquad Condition 3$$

$$CT 4 > CT 1 , CT 2 , CT 3 , CT 5 , CT 6 , CT 7 \qquad Condition 4$$

$$CT 2 , CT 4 > CT 6 > CT 1 , CT 3 , CT 5 , CT 7 \qquad Condition 5$$

The center gap (CG) between the lenses is explained as follows: the center gap (CG1) between the first lens (401) and the second lens (402) may be the maximum, and the center gap (CG3) between the third and fourth lenses (403, 404), and the center gap (CG6) between the sixth and seventh lenses (406, 407) may be at least one of the minimum distances. The difference between the maximum center gap and the minimum center gap among the separated lens distances may be 3 mm or more, for example, within the range of 3 mm to 4 mm.

The center gap between each lens may satisfy the following conditions.

$$CG 1 > CG 2 , CG 3 , CG 4 , CG 5 , CG 6 \qquad Condition 1$$

$$CG 1 , CG 5 > CG 2 > CG 3 , CG 4 , CG 6 \qquad Condition 2$$

$$CG 1 , CG 2 , CG 4 , CG 5 > CG 3 = CG 6 \qquad Condition 3$$

$$CG 1 , CG 2 , CG 5 > CG 4 > CG 3 , CG 4 , CG 6 \qquad Condition 4$$

$$CG 1 > CG 5 > CG 2 , CG 3 , CG 4 , CG 6 \qquad Condition 5$$

Regarding the effective diameter, a lens with the maximum effective diameter may be a lens made of glass material. The lens with the maximum effective diameter may be the fourth lens (404). Here, the effective diameter is an average of the effective diameter on the object side and the effective diameter on the sensor side of each lens. The lens surface with the maximum effective diameter may be the seventh surface (S7) of the fourth lens (404). The lens with the minimum effective diameter may be the second lens (402). The lens surface with the minimum effective diameter may be the fourth surface (S4) of the second lens (402). The effective diameter of a plastic lens may be smaller than that of a glass lens. A plastic lens may be disposed adjacent to the image sensor.

The effective diameter of each lens may satisfy any one of the following conditions.

$$CA\_L4 , CA\_L7 > CA\_L1 > CA\_L2 , CA\_L3 , CA\_L5 , CA\_L6 \qquad Condition 1$$

$$CA\_L1 , CA\_L3 , CA\_L4 , CA\_L5 , CA\_L6 , CA\_L7 > CA\_L2 \qquad Condition 2$$

$$CA\_L1 , CA\_L4 , CA\_L5 , CA\_L6 , CA\_L7 > CA\_L3 > CA\_L2 \qquad Condition 3$$

$$CA\_L4 > CA\_L1 , CA\_L2 , CA\_L3 , CA\_L5 , CA\_L6 , CA\_L7 \qquad Condition 4$$

$$CA\_L1 , CA\_L4 , CA\_L7 > CA\_L5 > CA\_L2 , CA\_L3 , CA\_L6 \qquad Condition 5$$

$$CA\_L1 , CA\_L4 , CA\_L5 , CA\_L7 > CA\_L6 > CA\_L2 , CA\_L3 \qquad Condition 6$$

$$CA\_L4 > CA\_L7 > CA\_L1 , CA\_L2 , CA\_L3 , CA\_L5 , CA\_L6 \qquad Condition 7$$

The refractive index is explained as follows: the refractive index of the first lens (401) may be the highest among the lenses, exceeding 1.8, for example, 1.81 or higher. The second lens (402), the fourth lens (404), the sixth lens (406), and the seventh lens (407) may have the lowest refractive index among the lenses, either individually or collectively. For example, the refractive indices of the second lens (402), the sixth lens (406), and the seventh lens (108) may be the smallest among the lenses, less than 1.6, for example, less than 1.55. The difference between the maximum refractive index and the minimum refractive index may be 0.2 or more. By providing the lens made of glass material with the highest refractive index closest to the object, and providing the lens adjacent to the glass material lens and the lens adjacent to the image sensor (500) with a lens made of plastic material with the lowest refractive index, the incident efficiency can be increased, and the refractive force between the glass material lenses and the plastic material lenses can be controlled to guide the light to the image sensor (500).

The refractive index of each lens may satisfy any one of the following conditions.

$$n 1 > n 2 , n 3 , n 4 , n 5 , n 6 \qquad Condition 1$$

$$n 1 , n 3 , n 5 > n 2 = n 4 = n 6 = n 7 \qquad Condition 2$$

$$n 1 > n 3 > n 2 , n 4 , n 5 , n 6 \qquad Condition 3$$

$$n 1 , n 3 > n 5 > n 2 , n 4 , n 6 \qquad Condition 4$$

When comparing the Abbe numbers, at least one of the Abbe numbers of the second lens (402), fourth lens (404), sixth lens (406), and seventh lens (407) may be the largest among the lenses and may be 50 or higher. The Abbe number of the fifth lens (405) may be the smallest among the lenses and may be 25 or lower. The difference between the maximum refractive index and the minimum Abbe number may be 40 or more. By maximizing the Abbe number of the lens disposed at the central part of the optical system (1000) and minimizing the Abbe number of the fifth lens (405) with a low refractive index adjacent to the image sensor (500), the color dispersion of light passing between glass and plastic lenses can be controlled, and the color dispersion between glass and plastic lenses can be increased, enabling the light to be guided to the image sensor (500).

The Abbe number of each lens may satisfy any one of the following conditions.

$$v 2 , v 3 , v 4 , v 6 , v 7 > v 1 > v 5 \qquad Condition 1$$

$$v 2 = v 4 = v 6 = v 7 > v 1 , v 3 \qquad Condition 2$$

$$v 2 , v 4 , v 6 , v 7 > v 3 > v 1 \qquad Condition 3$$

$$v 2 , v 3 , v 4 , v 6 , v 7 > v 5 \qquad Condition 4$$

The focal lengths (F1, F2, F5, F7) of lenses 1, 2, 5, and 7 (401, 402, 405, 407) may have a negative (−) sign. Lenses 1, 2, 5, and 7 (401, 402, 405, 407) may have negative (−) refractive power. The focal lengths (F3, F4, F6) of the third, fourth, and sixth lenses (403, 404, 406) may have a positive (+) sign. The third, fourth, and sixth lenses (403, 404, 406) may have positive (+) refractive power. The sensor side of the first lens (401) and the second lens (402), which have negative (−) refractive power, may be disposed with the third lens (403), which has positive (+) refractive power. Through this, light incident from the object side moves away from the optical axis direction and then converges again toward the optical axis direction, thereby forming a stable optical path.

Additionally, the fourth lens (404) and fifth lens (405), which are disposed adjacent to each other, may satisfy the following conditions.

Condition 1: Refractive index of a lens with positive refractive power<Refractive index of a lens with negative refractive power

Condition 2: Dispersion value of a lens with positive refractive power>Dispersion value of a lens with negative refractive power

Here, among the plastic lenses, the fourth lens (404) has positive refractive power, and the fifth lens (405) has negative refractive power. According to conditions 1 and 2, the refractive index of the fourth lens (404) is smaller than that of the fifth lens (405), the dispersion value of the fourth lens (404) is greater than that of the fifth lens (405). Chromatic aberration occurring in plastic lenses can be corrected using plastic lenses. Additionally, when the fourth lens (404) and the fifth lens (405), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using plastic lenses.

Optical systems exhibit chromatic aberration, which is corrected using bonded lenses or two lenses disposed in succession. As temperature changes from low to high, lenses repeatedly contract and expand. Lenses made of the same material exhibit identical changes in lens characteristics due to temperature variations, making it effective to correct chromatic aberration between lenses of the same material even when temperature changes. Therefore, in the fourth embodiment of the present invention, the fourth lens (404) and the fifth lens (405) can be used to correct chromatic aberration occurring in plastic lenses.

From the optical axis to the effective diameter area, the maximum distance between the two lenses with the largest Abbe number difference among the two adjacent lenses may be smaller than the maximum distance between other adjacent pairs of lenses. Here, the distance may refer to the distance between the two lenses from the optical axis to the effective diameter area. The two lenses with the largest Abbe number difference among the two adjacent lenses may be the fourth lens (404) and the fifth lens (405). The maximum value of the distance from the optical axis to the effective diameter area in a direction perpendicular to the optical axis, between the sensor side surface 8th surface (S8)) of the fourth lens (404) and the object side surface 9th surface (S9)) of the fifth lens (405) may be smaller than the maximum value of the distance between any two adjacent lenses. This allows the distance between two lenses made of difficult-to-bond plastic materials to be designed to be small, maximizing the Abbe number difference, thereby achieving the effect of reducing chromatic aberration to the same level as that of bonded lenses even in an unbonded state. When comparing focal lengths as absolute values, the focal length of the first lens (401) may be the largest among the lenses and may be 100 or more and 120 or less. The focal length of the fifth lens (405) may be the smallest among the lenses, and the absolute value of the focal length of the fifth lens (405) may be 10 or more and 12 or less. Since the first lens (401) has the largest focal length and the weakest refractive power among the lenses, the difference in the Abbe number between the second lens (402) and the fourth lens (404) disposed on the sensor side of the first lens (401) does not need to be large to achieve the effect of correcting chromatic aberration.

The absolute value of the focal length of each lens may satisfy any one of the following conditions.

$$\vert f 1 \vert > \vert f 2 \vert , \vert f 3 \vert , \vert f 4 \vert , \vert f 5 \vert , \vert f 6 \vert , \vert f 7 \vert \qquad Condition 1$$

$$\vert f 1 \vert > \vert f 2 \vert > \vert f 3 \vert , \vert f 4 \vert , \vert f 5 \vert , \vert f 6 \vert , \vert f 7 \vert \qquad Condition 2$$

$$\vert f 1 \vert , \vert f 2 \vert , \vert f 7 \vert > \vert f 3 \vert > \vert f 4 \vert , \vert f 5 \vert , \vert f 6 \vert \qquad Condition 3$$

$$\vert f 1 \vert , \vert f 2 \vert , \vert f 3 \vert , \vert f 7 \vert > \vert f 4 \vert > \vert f 5 \vert , \vert f 6 \vert \qquad Condition 4$$

$$\vert f 1 \vert , \vert f2 \vert , \vert f 3 \vert , \vert f 4 \vert , \vert f 6 \vert , \vert f 7 \vert > \vert f 5 \vert \qquad Condition 5$$

$$\vert f 1 \vert , \vert f 2 \vert , \vert f 3 \vert , \vert f 4 \vert , \vert f 7 \vert > \vert f 6 \vert > \vert f 5 \vert \qquad Condition 6$$

$$\vert f 1 \vert , \vert f 2 \vert > \vert f 7 \vert > \vert f 3 \vert , \vert f 4 \vert , \vert f 5 \vert , \vert f 6 \vert \qquad Condition 7$$

The thickness (T1) of the first lens (401) may be within a range of 1.5 to 2 times the difference between the maximum thickness and the minimum thickness, with the center thickness (CT1) being the minimum and the edge thickness (ET1) being the maximum. The thickness (T2) of the second lens (402) may have a maximum thickness within the range of 1 to 1.5 times the minimum thickness. The second lens (402) may have the maximum thickness at the center (CT2) and the minimum thickness at the edge (ET2). The thickness (T3) of the third lens (403) may be minimum at the center and maximum at the edge, with the maximum thickness being within the range of 1 to 1.5 times the minimum thickness. The thickness (T4) of the fourth lens (404) may be maximum at the center and minimum at the edge, with the maximum thickness being within the range of 2 to 2.5 times the minimum thickness. The thickness (T5) of the fifth lens (405) may be minimum at the center and maximum at the edge, with the maximum thickness being within the range of 1.2 to 1.7 times the minimum thickness. The thickness (T6) of the sixth lens (406) may be maximum at the center and minimum at the edge, with the maximum thickness ranging from 1.2 to 1.7 times the minimum thickness. The thickness (T7) of the seventh lens (407) may be minimum at the center and maximum at the edge, with the maximum thickness ranging from 1.2 to 1.7 times the minimum thickness.

The thickness of each lens may satisfy any one of the following conditions.

$$0.5 < CT 1 / ET 1 < 1 , 1.5 < ET 1 / CT 1 < 2 \qquad Condition 1$$

$$1 < CT 2 / ET 2 < 1.5 , 0.5 < ET 2 / CT 2 < 1 \qquad Condition 2$$

$$0.5 < CT 3 / ET 3 < 1 , 1 < ET 3 / CT 3 < 1.5 \qquad Condition 3$$

$$2 < CT 4 / ET 4 < 2.5 , 0.1 < ET 4 / CT 4 < 0.5 \qquad Condition 4$$

$$0.5 < CT 5 / ET 5 < 1 , 1.2 < ET 5 / CT 5 < 1.7 \qquad Condition 5$$

$$1.2 < CT 6 / ET 6 < 1.7 , 0.5 < ET 6 / CT 6 < 1 \qquad Condition 6$$

$$0.5 < CT 7 / ET 7 < 1 , 1.2 < ET 7 / CT 7 < 1.7 \qquad Condition 7$$

$$1 < \sum CT / \sum ET < 1.2 , 0 \text{.5} < \sum ET / \sum CT < 1 \qquad Condition 8$$

Among the gaps (G1-G7) between the lenses, the first gap (G1) between the first and second lenses (401, 402) may have a maximum at the center and a minimum at the edge. The second gap (G2) between the second and third lenses (402, 403) may have a minimum at the center and a maximum at the edge. The third gap (G3) between the third and fourth lenses (403, 404) may have the maximum value at the edge and the minimum value at the center. The fourth gap (G4) between the fourth and fifth lenses (404, 405) may have the minimum value at the center and the maximum value at the edge. The fifth gap (G5) between the fifth and sixth lenses (405, 406) may have the center portion at its maximum and the edge portion at its minimum. The sixth gap (G6) between the sixth and seventh lenses (406, 407) may have the center portion at its minimum and the edge portion at its maximum.

FIGS. 42, 44, and 46 are graphs showing the diffraction MTF (modulation transfer function) at room temperature, low temperature, and high temperature in the optical system of FIG. 37, respectively. These graphs represent the modulation (luminance ratio) as a function of spatial frequency.

As shown in FIGS. 42, 44, and 46, the deviation of the MTF between room temperature and low or high temperatures in the fourth embodiment of the invention may be less than 10%, i.e., 7% or less. FIGS. 43, 45, and 47 are graphs showing the aberration characteristics at room temperature, low temperature, and high temperature in the optical system of FIG. 37.

The aberration graphs in FIGS. 43, 45, and 47 show the measured values of spherical aberration (Longitudinal Spherical Aberration), astigmatic field curves (Astigmatic Field Curves), and distortion (Distortion) from left to right.

In FIGS. 43, 45, and 47, the X-axis may represent the focal length (mm) and distortion (%) and the Y-axis may represent the height of the image. Additionally, the graphs for spherical aberration correspond to light in the wavelength bands of approximately 435 nm, approximately 486 nm, approximately 546 nm, approximately 587 nm, and approximately 656 nm, while the graphs for coma aberration and distortion aberration correspond to light in the wavelength band of approximately 546 nm. In the aberration diagrams of FIGS. 43, 45, and 47, the closer the curves at room temperature, low temperature, and high temperature are to the Y-axis, the better the aberration correction function is interpreted to be. The optical system (1300) according to the fourth embodiment shows that the measured values are adjacent to the Y-axis in almost all regions. Thus, the optical system (1300) according to the fourth embodiment has improved resolution and can achieve good optical performance not only in the central part of the field of view (FOV) but also in the peripheral regions. Here, low temperature may refer to −20° C. or below, for example, −20° C. to −40° C., room temperature may refer to 22° C.±5° C. or 18° C. to 27° C., and high temperature may refer to 85° C. or above, for example, 85° C. to 405° C. As a result, as shown in FIGS. 43, 45, and 47, it can be seen that the reduction in brightness modulation from low temperature to high temperature is less than 10%, for example, 5% or less, or remains almost unchanged.

Table 12 compares the changes in optical characteristics such as EFL, BFL, F-number (F #), TTL, and field of view (FOV_H) at room temperature, low temperature, and high temperature in the optical system according to the fourth embodiment. It can be seen that the change rate of optical characteristics at low temperature is 5% or less, for example, 3% or less, based on room temperature. It can be observed that the change rate of optical characteristics at low temperatures relative to room temperature is 5% or less, for example, 3% or less.

TABLE 12

| | | | | low | high |
|---|---|---|---|---|---|
| | | | | temper- | temper- |
| | | | | ature/ | ature/ |
| | Room | low | high | Room | Room |
| | temper- | temper- | temper- | temper- | temper- |
| | ature | ature | ature | ature | ature |
| EFL(F) | 10.88 | 10.81 | 10.97 | 99.35% | 100.82% |
| BFL | 3.40 | 3.40 | 3.41 | 100.00% | 100.29% |
| F# | 1.64 | 1.63 | 1.65 | 99.39% | 100.60% |
| TTL | 30.00 | 29.93 | 30.09 | 99.76% | 100.30% |
| FOV_D | 54.51 | 54.90 | 54.03 | 100.71% | 99.11% |

Therefore, as shown in Table 12, the changes in optical characteristics due to temperature changes from low to high temperatures, such as the change rate of the effective focal length (EFL), TTL, BFL, F number, and field of view (FOV_D), are 10% or less, i.e., 5% or less, for example, within the range of 0 to 5%. This design allows for temperature compensation of the plastic lens, even when using one or more plastic lenses, thereby inhibiting a decrease in the reliability of optical characteristics.

The optical system of the fourth embodiment disclosed above can effectively control aberration characteristics such as chromatic aberration and distortion aberration, and can achieve good optical performance not only in the center but also in the peripheral areas of the field of view (FOV).

The optical systems (1000, 1100, 1200, 1300) according to the first to fourth embodiments described above may satisfy at least one or more of the mathematical equations described below. Accordingly, the optical systems (1000, 1100, 1200, 1300) according to the first to fourth embodiments may have improved optical characteristics. For example, when the optical system (1000, 1100, 1200, 1300) satisfies at least one mathematical equation, the optical system (1000, 1100, 1200, 1300) can effectively control aberration characteristics such as chromatic aberration and distortion aberration, and can have good optical performance not only in the central part but also in the peripheral part of the field of view (FOV). Additionally, the optical system (1000, 1100, 1200, 1300) can achieve improved resolution. Furthermore, the thickness of the lenses at their optical axes (OA) and the gap between adjacent lenses at their optical axes (OA) as specified in the mathematical equations can be referenced in the first to fourth embodiments described above.

$$30 < \vert f 1 \vert < 120 \qquad [ Mathematical Equation 1 ]$$

In Mathematical Equation 1, f1 represents the focal length of the first lens (101, 201, 301, 401). It can be set to have a short effective focal length compared to TTL in order to improve the performance of the optical system. If Mathematical Equation 1 is satisfied, the light entering the first lens (101, 201, 301, 401) from the object side can be guided in the direction where it converges on the optical axis. Additionally, if the refractive power of the first lens (101, 201, 301, 401) closest to the object side is weak, the lenses on the sensor side can correct chromatic aberration even if their Abbe numbers differ significantly. Additionally, the entire optical system can have a stable structure that both spreads and converges light. In the first to fourth embodiments, Mathematical Equation 1 may preferably satisfy the condition of 50<|f1|<115.

$$10 < \vert F\_LG1 \vert < 30 \qquad [ Mathematical Equation 2 ]$$

In Mathematical Equation 2, |F_LG1| denotes the focal length of the first lens group (LG1). The first lens group (LG1) refers to the lens group disposed on the object side relative to the aperture (STOP). When the focal length of the first lens group (LG1) satisfies Mathematical Equation 2, the optical system can achieve good optical performance at the set field of view. In the first to fourth embodiments, it is preferable that 15<|F_LG1|<30 is satisfied.

$$20 < v 1 < 60 \qquad [ Mathematical Equation 3 ]$$

In Mathematical Equation 3, v1 is the Abbe number of the first lens (101, 201, 301, 401). In the optical system (1000, 1100, 1200, 1300), the total focal length of the first lens group (LG1) has a negative (−) sign, and by setting the Abbe number of the first lens (101, 201, 301, 401) included in the first lens group (LG1) with a negative (−) focal length to a large value, the effect of reducing chromatic aberration of the lens can be achieved. In the first to third embodiments, Mathematical Equation 3 may preferably satisfy 50<v1<60, and in the fourth embodiment, Mathematical Equation 3 may preferably satisfy 20<v1<30.

$$45 < v 2 < 60 \qquad [ Mathematical Equation 4 ]$$

In Mathematical Equation 4, v2 is the Abbe number of the second lens (102, 202, 302, 402). In the optical system (1000, 1100, 1200, 1300), the total focal length of the first lens group (LG1) has a negative (−) sign, setting the Abbe number of the second lens (102, 202, 302, 402) included in the first lens group (LG1) with a negative (−) focal length to a large value can reduce chromatic aberration of the lens. In the first to fourth embodiments, Mathematical Equation 4 may preferably satisfy 50<v2<58.

$$15 < v 5 < 25 \qquad [ Mathematical Equation 5 ]$$

In Mathematical Equation 5, v5 is the Abbe number of the fifth lens (105, 205, 305, 405). In the optical system (1000, 1100, 1200, 1300), the total focal length of the second lens group (LG2) has a positive (+) sign, and by setting the Abbe number of the fifth lens (105, 205, 305, 405) adjacent to the object side within the second lens group (LG2) and having a positive (+) focal length to be low, it is possible to reduce the chromatic aberration of the lens disposed on the sensor side of the fifth lens (105, 205, 305, 405). In the first to fourth embodiments, the Mathematical Equation 5 may preferably satisfy the condition 18<v5<22.

$$0.1 < CG 1 / \sum CG < 0.5 \qquad [ Mathematical Equation 6 ]$$

In Mathematical Equation 6, CG1 is the center gap between the first lens (101, 201, 301, 401) and the second lens (102, 202, 302, 402), and XCG is the sum of the gaps between adjacent lenses. When Mathematical Equation 6 is satisfied, the light emitted from the first lens (101, 201, 301, 401), which has a significant influence on the entire optical system, sets the light path entering the remaining lenses, and the optical system can achieve good optical performance at the set field of view and focal length. In the first to fourth embodiments, Mathematical Equation 6 may preferably satisfy 0.3<CG1/ΣCG<0.5.

$$0.1 < CG 1 / \sum CT < 0.3 \qquad [ Mathematical Equation 7 ]$$

In Mathematical Equation 7, CG1 is the center gap between the first lens (101, 201, 301, 401) and the second lens (102, 202, 302, 402), and ECT is the sum of the center thicknesses of the lenses. When Mathematical Equation 7 is satisfied, the light emitted from the first lens (101, 201, 301, 401), which has a significant influence on the entire optical system, sets the light path for the light entering the remaining lenses, and the optical system can achieve good optical performance at the set field of view and focal length. In the first to fourth embodiments, Mathematical Equation 7 may preferably satisfy 0.1<ΣCT/ΣCG<0.2.

$$0.01 < CG 1 / TTL < 0.2 \qquad [ Mathematical Equation 8 ]$$

In Mathematical Equation 8, CG1 is a center gap between the first lens (101, 201, 301, 401) and the second lens (102, 202, 302, 402), the distance (mm) along the optical axis (OA) from the center of the first surface (S1) of the first lens (101, 201, 301, 401) to an image surface of the image sensor (500), which is the TTL, can be established. When Mathematical Equation 8 is satisfied, the light emitted from the first lens (101, 201, 301, 401), which has a significant influence on the entire optical system, is directed to the remaining lenses, and the optical system can achieve good optical performance at the set field of view and focal length. In the first to fourth embodiments, Mathematical Equation 8 may preferably satisfy 0.1<CG1/TTL<0.15.

$$0.3 < \sum CT / TTL < 0.8 \qquad [ Mathematical Equation 9 ]$$

Mathematical Equation 9 may establish the relationship between the sum of the center thicknesses (ΣCT) of the first to seventh lenses (101-107, 201-207, 301-307, 401-407) and the distance (mm) from the center of the first surface (S1) of the first lenses (101, 201, 301, 401) to an image surface of the image sensor (500) on the optical axis (OA). To reduce TTL, more light refraction is required. To increase light refraction, the power of the lenses must be increased, and to increase power, the lenses must be made thicker. If the lower limit of Mathematical Equation 9 is not met, the sum of lens thickness decreases, resulting in weaker refractive power. If the upper limit of Mathematical Equation 9 is exceeded, the sum of lens thicknesses increases excessively, leading to an increase in TTL. In the first to fourth embodiments, Mathematical Equation 9 may preferably satisfy 0.5<ΣCT/TTL<0.8.

$$0.1 < \sum CG / TTL < 0.5 \qquad [ Mathematical Equation 10 ]$$

Mathematical Equation 10 may establish the relationship between the sum (ECG) of gaps of adjacent lenses among first to seventh lenses (101-107, 201-207, 301-307, 401-407) and TTL which is a distance (mm) from a center of first surface (S1) to an image surface of image sensor (500) on the optical axis (OA). To reduce TTL, more light refraction is required. To increase light refraction, the power of the lenses must be increased, and to increase power, the lenses must be made thicker. If the value is below the lower limit of Mathematical Equation 10, the total thickness of the lenses decreases, resulting in weaker refractive power than the desired power. If the upper limit of Mathematical Equation 10 is exceeded, the total thickness of the lenses increases excessively, causing the TTL to increase. In the first to fourth embodiments, Mathematical Equation 10 may preferably satisfy 0.1<ΣCG/TTL<0.3.

$$3 < \sum CG / \sum CG < 4 \qquad [ Mathematical Equation 11 ]$$

In Mathematical Equation 11, ICT is the sum of the center thicknesses of the lenses, and ΣCG is the sum of the gaps between adjacent lenses. When Mathematical Equation 11 is satisfied, the optical system can achieve good optical performance at the specified field of view and focal length, and the TTL can be reduced. In the first to fourth embodiments, Mathematical Equation 11 may preferably satisfy 3<ΣCT/ΣCG<3.5.

$$25 < \sum Abb / \sum Index < 35 \qquad [ Mathematical Equation 12 ]$$

In Mathematical Equation 12, ΣAbb denotes the sum of the Abbe numbers of each lens, and ΣIndex denotes the sum of the refractive indices at the d-line of each lens. When Mathematical Equation 12 is satisfied, the optical system (1000, 1100, 1200, 1300) can achieve improved aberration characteristics and resolution. By setting the sum of the Abbe numbers and the sum of the refractive indices of the lenses according to Mathematical Equation 12, the optical characteristics can be controlled. In the first to fourth embodiments, it is preferable that Mathematical Equation 12 satisfies 28<ΣAbb/ΣIndex<33.

$$1 < \sum CT / \sum ET < 2 \qquad [ Mathematical Equation 13 ]$$

In Mathematical Equation 13, ICT is the sum of the center thicknesses of the lenses, and ΣET is the sum of the edge thicknesses, i.e., the ends of the effective areas of the lenses. When Mathematical Equation 13 is satisfied, the optical system can achieve good optical performance at the specified field of view and focal length, and the TTL can be reduced. In the first to fourth embodiments, it is preferable that Mathematical Equation 13 satisfies 1<ΣCT/ΣET<1.3.

$$0.5 < CT 1 / ET 1 < 1.5 \qquad [ Mathematical Equation 14 ]$$

In Mathematical Equation 14, CT1 is the center thickness of the first lens (101, 201, 301, 401), and ET1 is the edge thickness of the first lens (101, 201, 301, 401). This allows you to set the elements that affect the field of view of the optical system and the elements that affect the effective focal length (EFL). Mathematical Equation 14 may preferably satisfy 0.7<CT1/ET1<1.2 in the first to fourth embodiments.

$$0.5 < GLCa\_AVER / PLCa\_AVER < 1.5 \qquad [ Mathematical Equation 15 ]$$

In Mathematical Equation 15, GLCa_AVER represents the average effective diameter of glass lenses, and PLCa_AVER represents the average effective diameter of plastic lenses. The lens barrel in which the lens unit is disposed has at least one inner barrel inside the lens barrel, and at least some of the plastic lenses included in the lens unit may be disposed in the inner barrel. For plastic lenses, the expansion at high temperatures is significant, requiring a larger space within the lens barrel. By setting the size of effective diameter of the glass lens and the size of effective diameter of the plastic lens in Mathematical Equation 15, it is possible to suppress the degradation of optical characteristics due to temperature changes, and the optical system (1000, 1100, 1200, 1300) can control the incident light and set elements that affect aberrations. In the first to fourth embodiments, Mathematical Equation 15 may preferably satisfy the condition 0.5<GLCa_AVER/PLCa_AVER<1.2.

$$1 < CA\_LIS1 / CA\_LIS2 < 2 \qquad [ Mathematical Equation 16 ]$$

In Mathematical Equation 16, CA_L1S1 denotes the effective diameter of the first surface (S1) of the first lens (101, 201, 301, 401), and CA_L2 denotes the effective diameter of the second surface (S2) of the first lens (101, 201, 301, 401). When Mathematical Equation 16 is satisfied, degradation of optical characteristics due to temperature changes can be suppressed, and the optical system (1000, 1100, 1200, 1300) can control incident light and set elements that affect aberrations. In the first to fourth embodiments, Mathematical Equation 16 may preferably satisfy 1<CA_L1S1/CA_L1S2<1.5.

$$0.5 < CA\_L1 / CA\_L7 < 1.5 \qquad [ Mathematical Equation 17 ]$$

In Mathematical Equation 17, CA_L1 denotes the effective diameter of the first lens (101, 201, 301, 401), and CA_L7 denotes the effective diameter of the seventh lens (107, 207, 307, 407). The lens barrel in which the lens unit is mounted includes at least one inner barrel, and at least some of the plastic lenses included in the lens unit may be mounted in the inner barrel. Plastic lenses require more space inside the lens barrel due to their high expansion at high temperatures. Therefore, when Mathematical Equation 17, which defines the relationship between the effective diameter of the first lens (101, 201, 301, 401) made of glass material and the effective diameter of the seventh lens (107, 207, 307) made of plastic material, is satisfied, the degradation of optical characteristics due to temperature changes can be suppressed, the optical system (1000, 1100, 1200, 1300) can control the incident light and set elements that affect aberrations. In the first to fourth embodiments, Mathematical Equation 17 may preferably satisfy 0.8<CA_L1/CA_L7<1.2.

$$1 < CA\_L1 / ImgH < 2.5 \qquad [ Mathematical Equation 18 ]$$

Mathematical Equation 18 may establish the relationship between the effective diameter (CA_L1) of the first lens (101, 201, 301, 401) and ImgH, which is the maximum diagonal length of the image sensor. When Mathematical Equation 18 is satisfied, the TTL is suitable for automotive optical systems and the set field of view can be achieved. If the value is below the lower limit of Mathematical Equation 18, the effective diameter of the lens in the optical system (1000, 1100, 1200, 1300) becomes the largest, resulting in an excessively long TTL. If the upper limit of Mathematical Equation 18 is exceeded, the field of view becomes excessively large compared to the field of view satisfied by the optical system (1000, 1100, 1200, 1300). In the first to fourth embodiments, Mathematical Equation 18 may preferably satisfy 1.8<CA_L1/ImgH<2.2.

$$1 < CT\_Max / CG\_Max < 2 \qquad [ Mathematical Equation 19 ]$$

In Mathematical Equation 19, CT_Max is the maximum center thickness among the lenses, and CG Max is the maximum gap between adjacent lenses. When Mathematical Equation 19 is satisfied, the optical system can achieve good optical performance at the set field of view and focal length, and the TTL can be reduced. In the first to fourth embodiments, it is preferable that Mathematical Equation 19 satisfies the condition 1.2<CT_Max/CG_Max<2.

$$1 < CA\_max / CA\_min < 2 \qquad [ Mathematical Equation 20 ]$$

In Mathematical Equation 20, CA_max represents the maximum effective diameter among the object side surfaces and sensor side surfaces of the lenses, and CA_Min represents the minimum effective diameter among the object side surfaces and sensor side surfaces of the lenses. When Mathematical Equation 20 is satisfied, the optical system can maintain optical performance while setting the size for a slim and compact structure. In the first to fourth embodiments, Mathematical Equation 20 may preferably satisfy the condition 1.2<CA_max/CA_min<1.5.

$$1 < CA\_max / CA\_Aver < 2 \qquad [ Mathematical Equation 21 ]$$

In Mathematical Equation 21, CA_max represents the maximum effective diameter of the object side surfaces and sensor side surfaces of the lenses, and CA_Aver represents the average effective diameter of the object side surfaces and sensor side surfaces of the lenses. When Mathematical Equation 21 is satisfied, the optical system can maintain optical performance and set the size for a slim and compact structure. In the first to fourth embodiments, Mathematical Equation 21 may preferably satisfy the condition 1<CA_max/CA_Aver<1.5.

$$0.5 < CA\_min / CA\_min < 1 \qquad [ Mathematical Equation 20 ]$$

In Mathematical Equation 22, CA_Min represents the minimum effective diameter between the object side surfaces and sensor side surfaces of the lenses, and CA_Aver represents the average effective diameter between the object side surfaces and sensor side surfaces of the lenses. When Mathematical Equation 22 is satisfied, the optical system can maintain optical performance while setting the size for a slim and compact structure. In the first to fourth embodiments, Mathematical Equation 22 may preferably satisfy the condition 0.7<CA_min/CA_Aver<0.9.

$$2 < CA\_max / ImgH < 3 \qquad [ Mathematical Equation 23 ]$$

Mathematical Equation 23 shows that CA_max represents the maximum effective diameter among the object side surfaces and sensor side surfaces of the lenses, and Imgh denotes half of the maximum diagonal length of the image sensor (500). When Mathematical Equation 23 is satisfied, the optical system can maintain good optical performance and set the size for a slim and compact structure. In the first to fourth embodiments, Mathematical Equation 23 may preferably satisfy 2<CA_max/ImgH<2.5.

$$25 < TTL < 32 \qquad [ Mathematical Equation 24 ]$$

In Mathematical Equation 24, TTL (Total track length) denotes the distance (mm) along the optical axis (OA) from the center of the first surface (S1) of the first lens (101, 201, 301, 401) to the image surface of the image sensor (500). When Mathematical Equation 24 is satisfied, a suitable vehicle optical system can be provided. In the first to fourth embodiments, Mathematical Equation 24 may preferably satisfy 28<TTL<31.

$$5 < ImgH < 6 \qquad [ Mathematical Equation 25 ]$$

In Mathematical Equation 25, ImgH denotes ½ of the maximum diagonal length of the image sensor (500). Mathematical Equation 25 can set the diagonal size (ImgH) of the image sensor (500) and provide an optical system with a vehicle-specific sensor size. In the first to fourth embodiments, Mathematical Equation 25 may preferably satisfy the condition 5<ImgH<5.5.

$$3 < BFL < 4 \qquad [ Mathematical Equation 26 ]$$

In Mathematical Equation 26, BFL is the optical axis distance from the image sensor (500) to the center of the sensor side surface of the last lens. When Mathematical Equation 26 is satisfied, the installation space for the filter (600) and cover glass can be secured, and the assembly of components can be improved through the gap between the image sensor (500) and the last lens, thereby enhancing the reliability of the connection. In the first to fourth embodiments, Mathematical Equation 26 may preferably satisfy 3<BFL<3.5. If BFL is below the range of Mathematical Equation 26, some light proceeding toward the image sensor may not be transmitted to the image sensor, which can cause a decrease in resolution. If BFL exceeds the range of Mathematical Equation 26, stray light may enter, leading to deterioration in the optical system's aberration characteristics.

$$9 < F < 12 \qquad [ Mathematical Equation 27 ]$$

Mathematical Equation 27 may allow the total focal length (F) to be set to suit the vehicle optical system. In the first to fourth embodiments, Mathematical Equation 27 may satisfy 10<F<11.

$$40 < FOV\_H < 60 \qquad [ Mathematical Equation 28 ]$$

In Mathematical Equation 28, FOV_H denotes the horizontal field of view (degrees) of the optical system (1000, 1100, 1200, 1300) and can provide a field of view suitable for an automotive optical system. Preferably, in the first to fourth embodiments, 45<FOV_H<50 may be satisfied.

$$2 < TTL / CA\_max < 3 \qquad [ Mathematical Equation 29 ]$$

In Mathematical Equation 29, CA_max refers to the largest effective diameter (mm) among the object side surfaces and sensor side surfaces of multiple lenses, TTL (Total track length) denotes the distance (mm) along the optical axis (OA) from the vertex of the first surface (S1) of the first lens (101, 201, 301, 401) to the image surface of the image sensor (500). Mathematical Equation 29 may establish the relationship between the total optical axis length of the optical system and the maximum effective diameter, enabling the provision of an improved vehicle optical system. In the first to fourth embodiments, Mathematical Equation 29 may preferably satisfy the condition 2.5<TTL/CA_max<2.7.

$$5 < TTL / ImgH < 7 \qquad [ Mathematical Equation 30 ]$$

Mathematical Equation 30 defines TTL (Total track length) as the distance (mm) along the optical axis (OA) from the vertex of the first surface (S1) of the first lens to the image surface of the image sensor (500), and ImgH as half of the maximum diagonal length of the image sensor (500). When Mathematical Equation 30 is satisfied, the optical system (1000, 1100, 1200, 1300) can have a TTL suitable for application to a vehicle-mounted image sensor (500), thereby providing improved image quality. In the first to fourth embodiments, Mathematical Equation 30 may preferably satisfy the condition 5<TTL/ImgH<6.

$$0.5 < BFL / ImgH < 1 \qquad [ Mathematical Equation 31 ]$$

Mathematical Equation 31 defines BFL as the optical axis distance from the image sensor (500) to the center of the sensor side surface of the last lens, and ImgH as half of the maximum diagonal length of the image sensor (500). When Mathematical Equation 31 is satisfied, the optical system (1000, 1100, 1200, 1300) can secure the BFL (back focal length) required to accommodate the size of the vehicle image sensor (500), set the gap between the last lens and the image sensor (500), and achieve good optical characteristics in both the central and peripheral regions of the field of view (FOV). In the first to fourth embodiments, Mathematical Equation 31 may preferably satisfy 0.5<BFL/ImgH<0.7.

$$7 < TTL / BFL < 10 \qquad [ Mathematical Equation 32 ]$$

In Mathematical Equation 32, TTL (Total track length) refers to the distance (mm) along the optical axis (OA) from the vertex of the first surface (S1) of the first lens (101, 201, 301, 401) to the image surface of the image sensor (500). BFL denotes the optical axis distance from the image sensor (500) to the center of the sensor side surface of the last lens. If Mathematical Equation 32 is satisfied, the optical system (1000, 1100, 1200, 1300) can secure BFL. In the first to fourth embodiments, Mathematical Equation 32 may preferably satisfy 7<TTL/BFL<9.

$$2 < TTL / F < 3 \qquad [ Mathematical Equation 33 ]$$

Mathematical Equation 33 defines TTL (Total track length) as the distance (mm) along the optical axis (OA) from the vertex of the first surface (S1) of the first lens to the image surface of the image sensor (500). F represents the effective focal length of the optical system. Accordingly, an optical system for a driver assistance system can be provided. When the optical system (1000, 1100, 1200, 1300) according to the embodiment satisfies Mathematical Equation 33, the optical system (1000, 1100, 1200, 1300) can have an appropriate focal length within the set TTL range and maintain an appropriate focal length even when the temperature changes from low to high, thereby providing an optical system capable of forming an image. If the value is below the lower limit of Mathematical Equation 33, it is necessary to increase the refractive power of the lenses, which makes it difficult to correct spherical aberration or distortion aberration. If the value exceeds the upper limit of Mathematical Equation 33, the lenses may become longer in effective diameter or TTL, leading to the problem of the imaging lens system becoming larger. In the first to fourth embodiments, Mathematical Equation 33 may preferably satisfy the condition 2.5<TTL/F<3.

$$3 < F / BFL < 4 \qquad [ Mathematical Equation 34 ]$$

In Mathematical Equation 34, F is the effective focal length of the optical system and BFL is the optical axis distance from the image sensor (500) to the center of the sensor side surface of the last lens. When Mathematical Equation 34 is satisfied, the optical system (1000, 1100, 1200, 1300) has the set field of view and appropriate focal length, and can be provided as a vehicle optical system. Additionally, the optical system (1000, 1100, 1200, 1300) can minimize the gap between the last lens and the image sensor (500), thereby achieving good optical characteristics in the peripheral areas of the field of view (FOV). In the first to fourth embodiments, Mathematical Equation 34 may preferably satisfy the condition 3<F/BFL<3.5.

$$2 < F / ImgH < 3 \qquad [ Mathematical Equation 35 ]$$

In Mathematical Equation 35, F is the effective focal length of the optical system, and ImgH is ½ of the maximum diagonal length of the image sensor (500). Such an optical system (1000, 1100, 1200, 1300) can have improved aberration characteristics in the size of a vehicle image sensor (500). In the first to fourth embodiments, Mathematical Equation 35 may preferably satisfy 2<F/ImgH<2.5.

$$z = \frac{c {Y}^{2}}{1 + \sqrt{1 - ( 1 + K ) {c}^{2} {Y}^{2}}} + A {Y}^{4} + B {Y}^{5} + C {Y}^{4} + D {Y}^{5} + E {Y}^{4} + … \qquad [ Mathematical Equation 36 ]$$

In Mathematical Equation 36, Z may represent the distance in the direction of the optical axis from an arbitrary position on the aspherical surface to the vertex of the aspherical surface. Y may represent the distance perpendicular to the optical axis from an arbitrary point on the aspherical surface to the optical axis. c may represent the curvature of the lens, and K may represent the conic constant. Additionally, A, B, C, D, E, and F can represent aspheric constants.

The optical system (1000, 1100, 1200, 1300) according to the first to fourth embodiments may satisfy at least one or more of Mathematical Equations 1 to 36. In this case, the optical system (1000, 1100, 1200, 1300) may have improved optical characteristics. In detail, when the optical system (1000, 1100, 1200, 1300) satisfies at least one or more of the Mathematical Equations 1 to 36, the optical system (1000, 1100, 1200, 1300) has improved resolution and can improve aberration and distortion characteristics. Additionally, the optical system (1000, 1100, 1200, 1300) can secure the back focal length (BFL) required for applying a vehicle-mounted image sensor (500), compensate for optical performance degradation caused by temperature changes, and minimize the gap between the last lens and the image sensor (500), thereby achieving good optical performance in both the central and peripheral areas of the field of view (FOV).

Table 13 shows the results of the Mathematical Equations 1 to 35 described above for the optical system (1000, 1100, 1200, 1300) of the embodiment. Referring to Table 13, it can be seen that the optical system (1000, 1100, 1200, 1300) satisfies at least one, two or more, or three or more of the Mathematical Equations 1 to 35. In detail, the optical system (1000, 1100, 1200, 1300) according to the embodiment satisfies all of Mathematical Equations 1 to 35. Accordingly, the optical system (1000, 1100, 1200, 1300) can have good optical performance in both the central and peripheral regions of the field of view (FOV) and excellent optical characteristics.

TABLE 13

| | | First | second | third | fourth |
|---|---|---|---|---|---|
| | | embodi- | embodi- | embodi- | embodi- |
| Mathematical Equations | | ment | ment | ment | ment |
| 1 | 30 < \|f1\| < 120 | 51.151 | 52.963 | 73.639 | 111.274 |
| 2 | 10 < \|F_LG1\| < 30 | 17.904 | 21.283 | 22.077 | 29.521 |
| 3 | 20 < v1 < 60 | 55.179 | 55.179 | 55.179 | 24.039 |
| 4 | 45 < v2 < 60 | 55.707 | 55.707 | 55.707 | 55.707 |
| 5 | 15 < v5 < 25 | 21.213 | 21.213 | 21.213 | 20.379 |
| 6 | 0.1 < CG1/ΣCG < 0.5 | 0.417 | 0.392 | 0.388 | 0.467 |
| 7 | 0.1 < CG1/ΣCT < 0.3 | 0.120 | 0.105 | 0.127 | 0.149 |
| 8 | 0.01 < CG1/TTL < 0.2 | 0.083 | 0.074 | 0.085 | 0.100 |
| 9 | 0.3 < ΣCT/TTL < 0.8 | 0.688 | 0.700 | 0.665 | 0.672 |
| 10 | 0.1 < ΣCG/TTL < 0.5 | 0.199 | 0.188 | 0.218 | 0.214 |
| 11 | 3 < ΣCT/ΣCG < 4 | 3.463 | 3.726 | 3.045 | 3.138 |
| 12 | 25 < ΣAbb/ΣIndex < 35 | 32.783 | 32.783 | 32.783 | 28.443 |
| 13 | 1 < ΣCT/ΣET < 2 | 1.133 | 1.107 | 1.122 | 1.130 |
| 14 | 0.5 < CT1/ET1 < 1.5 | 0.843 | 0.812 | 0.889 | 1.062 |
| 15 | 0.5 < GLCa_AVER/ | 0.986 | 1.053 | 0.994 | 0.978 |
| | PLCa_AVER < 1.5 | | | | |
| 16 | 1 < CA_L1S1/CA_L1S2 < 2 | 1.197 | 1.185 | 1.200 | 1.227 |
| 17 | 0.5 < CA_L1/CA_L7 < 1.5 | 0.935 | 1.079 | 0.987 | 0.962 |
| 18 | 1 < CA_L1/ImgH < 2.5 | 1.907 | 2.001 | 1.976 | 1.970 |
| 19 | 1 < CT_Max/CG_Max < 2 | 1.918 | 1.812 | 1.675 | 1.377 |
| 20 | 1 < CA_max/CA_min < 2 | 1.404 | 1.358 | 1.389 | 1.357 |
| 21 | 1 < CA_max/CA_Aver < 2 | 1.183 | 1.185 | 1.153 | 1.138 |
| 22 | 0.5 < CA_min/CA_Aver < 1 | 0.842 | 0.872 | 0.830 | 0.839 |
| 23 | 2 < CA_max/ImgH < 3 | 2.292 | 2.279 | 2.227 | 2.171 |
| 24 | 25 < TTL < 32 | 29.995 | 30.000 | 30.000 | 29.995 |
| 25 | 5 < ImgH < 6 | 5.145 | 5.145 | 5.145 | 5.145 |
| 26 | 3 < BFL < 4 | 3.416 | 3.375 | 3.495 | 3.404 |
| 27 | 9 < F < 12 | 10.878 | 10.863 | 10.884 | 10.881 |
| 28 | 40 < FOV_H < 60 | 46.00 | 46.00 | 46.00 | 46.00 |
| 29 | 2 < TTL/CA_max < 3 | 2.543 | 2.558 | 2.618 | 2.685 |
| 30 | 5 < TTL/ImgH < 7 | 5.830 | 5.831 | 5.831 | 5.830 |
| 31 | 0.5 < BFL/ImgH < 1 | 0.664 | 0.656 | 0.679 | 0.662 |
| 32 | 7 < TTL/BFL < 10 | 8.781 | 8.888 | 8.585 | 8.811 |
| 33 | 2 < TTL/F < 3 | 2.757 | 2.762 | 2.756 | 2.757 |
| 34 | 3 < F/BFL < 4 | 3.184 | 3.219 | 3.115 | 3.196 |
| 35 | 2 < F/ImgH < 3 | 2.114 | 2.111 | 2.115 | 2.115 |

FIG. 49 is an example of a plan view of a vehicle to which a camera module or optical system according to an embodiment of the invention is applied. Referring to FIG. 49, the vehicle camera system according to an embodiment of the invention includes an image generation unit (11), a first information generation unit (12), a second information generation unit (21, 22, 23, 24, 25, 26), and a control unit (14). The image generation unit (11) may include at least one camera module (31) disposed on her or his vehicle, and may capture the front of the vehicle and/or the driver to generate a front view image of the her or his vehicle or an interior view image of the her or his vehicle. The video generation unit (11) can capture not only the front of the her or his vehicle but also the surroundings of the her or his vehicle in one or more directions using the camera module (31) to generate a video of the her or his vehicle's surroundings. Here, the front view and surrounding views may be digital images and may include color images, black-and-white images, and infrared images. Additionally, the front view and surrounding views may include still images and videos. The image generation unit (11) provides the driver image, front view, and surrounding views to the control unit (14). Next, the first information generation unit (12) may include at least one radar and/or camera disposed on the her or his vehicle, and detects the front of the her or his vehicle to generate first detection information. Specifically, the first information generation unit (12) is placed on the her or his vehicle and detects the positions and speeds of vehicles located in front of the her or his vehicle, the presence and positions of pedestrians, etc., to generate first detection information.

The first information generation unit (12) can control the vehicle to maintain a constant distance between the her or his vehicle and the vehicle in front using the first detection information generated by the first information generation unit (12), and can enhance the stability of vehicle operation in specific cases such as when the driver wishes to change the driving lane of the her or his vehicle or when reversing for parking. The first information generation unit (12) provides the first detection information to the control unit (14). The second information generation unit (21, 22, 23, 24, 25, 26) generates second detection information by detecting each side of the her or his vehicle based on the front video generated by the video generation unit (11) and the first detection information generated by the first information generation unit (12). Specifically, the second information generation unit (21, 22, 23, 24, 25, 26) may include at least one radar and/or camera disposed on the her or his vehicle, and may detect the positions and speeds of vehicles located on the sides of the her or his vehicle or capture images. Here, the second information generation unit (21, 22, 23, 24, 25, 26) may be disposed at the front corners, side mirrors, and rear center and rear corners of the her or his vehicle.

Among these vehicle camera systems, at least one information generation unit may be equipped with an optical system and a camera module having the same described in the above-mentioned embodiment, and may provide or process information obtained through the front, rear, each side, or corner areas of the her or his vehicle to the user to protect the vehicle and objects from automatic driving or surrounding safety.

The optical system of the camera module according to the embodiments of the invention may be installed in multiple units within a vehicle to meet safety regulations, enhance autonomous driving functions, and increase convenience. Additionally, the optical system of the camera module is applied within a vehicle as a component for controlling systems such as the Lane Keeping Assistance System (LKAS), Lane Departure Warning System (LDWS), and Driver Monitoring System (DMS). Such vehicle camera modules can provide stable optical performance even under varying ambient temperatures and offer cost-competitive modules, thereby ensuring the reliability of vehicle components.

The features, structures, and effects described in the above embodiments are included in at least one embodiment of the present invention and are not necessarily limited to a single embodiment. Furthermore, the features, structures, and effects illustrated in each embodiment may be combined or modified by those skilled in the art to the field to which the embodiments belong to form other embodiments. Therefore, the contents related to such combinations and modifications should be interpreted as falling within the scope of the present invention.

Additionally, although the above description has focused on the embodiments, these are merely examples and do not limit the present invention. Those skilled in the art will understand that various modifications and applications not explicitly described herein are possible within the scope of the present invention, provided that they do not depart from the essential characteristics of the embodiments. For example, each component specifically shown in the embodiments may be modified. Any differences related to such modifications and applications should be interpreted as falling within the scope of the present invention as defined in the appended claims.

1. An optical system comprising first to seventh lenses arranged along an optical axis, each lens having an object side surface and a sensor side surface; wherein: the first lens has negative (−) refractive power; the second lens has negative (−) refractive power; the third lens has positive (+) refractive power; the fourth lens has positive (+) refractive power; the fifth lens has negative (−) refractive power; the sixth lens has positive (+) refractive power; and the seventh lens has negative (−) refractive power, wherein an aperture is disposed between the second lens and the third lens, and
wherein among thicknesses of the first to seventh lenses, the third lens has the largest thickness on the optical axis.

2. The optical system of claim 1, wherein at least one of the first lens and the third lens is made of glass, and at least one of the second lens and the fourth to seventh lenses is made of plastic.

3. The optical system of claim 1, wherein, on the optical axis, the sixth lens has a convex shape on both the object side and sensor side surfaces, and on the optical axis, the seventh lens has a meniscus shape that is convex toward an object side.

4. The optical system of claim 1, wherein an absolute value of a focal length of the first lens is the largest among focal lengths of the first to seventh lenses.

5. The optical system of claim 1, wherein a maximum value of distance between two lenses with a largest difference in Abbe number among adjacently disposed lenses from the optical axis to an effective diameter area is smaller than a maximum value of distance between another two adjacent lenses.

6. The optical system of claim 1, wherein the fourth lens and the fifth lens have a largest difference in Abbe number among adjacent lenses.

7. The optical system of claim 1, satisfying the following condition:
$$< Condition > 40 < FOV\_H < 60$$
(In the condition, FOV_H refers to a horizontal field of view (Horizontal Degree) of the optical system).

8. The optical system of claim 1, satisfying the following condition:
$$< Condition > 0.31 < CG 1 / \sum CG < 0.5$$
(In the condition, CG1 is a distance between the first lens and the second lens on the optical axis, and ΣCG is a sum of gaps between adjacent lenses on the optical axis).

9. The optical system of claim 1, satisfying the following condition:
$$< Condition > 5 < TTL / ImgH < 7$$
(In the condition, TTL is a distance along the optical axis from a vertex of the object side surface of the first lens to an image surface of an image sensor, and ImgH is ½ of a maximum diagonal length of the image sensor).

10. An optical system comprising first to seventh lenses disposed along an optical axis from an object side to a sensor side, wherein: a second lens has negative (−) refractive power; a third lens has positive (+) refractive power; a fourth lens has positive (+) refractive power; a fifth lens has negative (−) refractive power; a sixth lens has positive (+) refractive power; and a seventh lens has negative (−) refractive power, wherein an effective diameter of the second lens is the smallest among effective diameters of the first to seventh lenses, and
wherein the effective diameter of the fourth lens is the largest among effective diameters of the first to seventh lenses.

11. The optical system of claim 10, wherein a distance between the first lens and the second lens is the greatest among distances between adjacent lenses on the optical axis.

12. The optical system of claim 10, comprising:
an aperture disposed between the second lens and the third lens,
wherein the optical system comprises a first lens group disposed on the object side with respect to the aperture and a second lens group disposed on the sensor side with respect to the aperture, and
wherein a sign of a composite focal length of the first lens group is different from a sign of a composite focal length of the second lens group.

13. The optical system of claim 10, wherein at least one of the lenses disposed on the object side and on the sensor side of the aperture is made of glass material.

14. The optical system of claim 10, wherein an absolute value of a focal length of the first lens is the largest among focal lengths of the first to seventh lenses.

15. The optical system of claim 10, satisfying the following condition:
$$< Condition > 3 < \sum CT / \sum CG < 4$$
(In the condition, ΣCT means a sum of center thicknesses of the first to seventh lenses on the optical axis, and ΣCG means a sum of gaps between adjacent lenses on the optical axis).

16. An optical system comprising first to seventh lenses arranged along an optical axis, wherein: the first lens has negative (−) refractive power; the second lens has negative (−) refractive power; the third lens has positive (+) refractive power; the fourth lens has positive (+) refractive power; the fifth lens has negative (−) refractive power; the sixth lens has positive (+) refractive power; and the seventh lens has negative (−) refractive power,
wherein an effective diameter of the fourth lens is the largest among effective diameters of the first to seventh lenses.

17. The optical system of claim 16, wherein an absolute value of the focal length of the first lens is the largest among focal lengths of the first to seventh lenses.

18. The optical system of claim 16, wherein a maximum value of distance between two lenses with a largest difference in Abbe number among adjacently disposed lenses from the optical axis to an effective diameter area is smaller than a maximum value of distance between another two adjacent lenses.

19. The optical system of claim 16, wherein the fourth lens and the fifth lens have a largest difference in Abbe number among adjacent lenses.

20. The optical system of claim 16, comprising:
an aperture disposed between the second lens and the third lens,
wherein the optical system comprises a first lens group disposed on an object side with respect to the aperture and a second lens group disposed on a sensor side with respect to the aperture, and
wherein a sign of a composite focal length of the first lens group is different from a sign of a composite focal length of the second lens group.
